(19) United States
(12) Patent Application Publication
(10) Pub. No.: US 2017/0268192 A1
(43) Pub. Date: Sep. 21, 2017

(54) SYSTEM FOR HARVESTING SEAWEED AND GENERATING ETHANOL THEREFROM

(71) Applicant: Jonathan Karl Wayne BILEY, Surrey (CA)

(72) Inventors: JONATHAN KARL WAYNE BILEY, EDMONTON (CA); SEAN CAREIS FARRELL, MANASSAS, VA (US)

(21) Appl. No.: 15/321,656

(22) PCT Filed: Jun. 23, 2014
(86) PCT No.: PCT/CA2014/000515

§ 371 Date: Dec. 22, 2016

(51) Int. Cl. E02B 15/10; B63B 35/32; B63G 8/00; A01G 33/00

(52) U.S. Cl. CPC E02B 15/106; A01G 33/00; E02B 15/104; B63B 35/32; B63G 8/001; B63G 2008/004

(57) ABSTRACT

A floatable-material harvester is disclosed, including vacuum source, transport hose, and a floatable-material receiver. In one embodiment, the transport hose has at least one air inductor/intake along its length, which allows air to enter the transport hose to accelerate its contents, by negative pressure air induction. In another embodiment, a transport hose has at least one floatable-material thruster along its length, comprised of at least one nozzle, which provides pressurized fluid (e.g., air or water) in the direction of the flow of the harvested floatable material by positive pressure induction. A method is disclosed whereby the floatable material harvester is used to harvest an absorbent material (e.g., wood chips, straw, perlite, zeolite, polypropylene mesh, titanate nanofibres) that has absorbed a pollutant (e.g., oil, solvent, radioactive isotopes) from a beach or in water.

### TECHNICAL FIELD

This invention relates generally to harvesting floatable material (e.g., in the form of seaweed and algae; or in the form of a floating, chemical/radioactive absorbent material such as wood chips, mesh polypropylene, straw, vermiculite, zeolite, composite titanate nanofibres). Particularly, in one instance, the system of the invention is used for harvesting beached seaweed and detached seaweed floating in the surf and, in another instance, for harvesting spent pollutant absorbent material floating on a body of water or on the beach after having been used to aid the cleanup of a chemical spill on that body of water or beach. In another instance, for harvesting titanate nanofibre material that has been used to absorb radiation, heavy metals, and isotopes from a nuclear disaster. Furthermore, an efficient disposal method of incinerating the chemical spill within the apparatus is disclosed, or, in the instance of seaweed, the organic matter is processed within the apparatus for preservation. And in yet another example, alginates are fermented onboard the water vessel, and the resulting mash distilled into zero carbon footprint ethanol, for direct distribution to local fuel stations.

### BACKGROUND ART

Eutrophication is the unnatural nutrient enrichment of our oceans, rivers, and lakes, causing a linear increase in algae and seaweed growth. This measurable scientific phenomenon is occurring globally through sewer, aquaculture, and farm run-off pollution, and as a result there is a large accumulation of seaweed on beaches, in particular after storm activity that tears the seaweed from the ocean floor. The amounts are sometimes staggering, leading to mass rotting and often the generation of hydrogen sulphide gas, which has been known to kill both humans and animals, as well as the direct release of methane into the atmosphere through anaerobic decomposition, where methane is commonly known to have 72 times the Global Warming Potential (GWP) over 20 years than carbon dioxide. Furthermore, although some of the seaweed provides beneficial decomposing matter as food for insects and worms that feed other species, the amounts of seaweed often far outweighs the benefit of the ecosystem, as it amounts to incredible masses of rotting vegetation similar to a massive landfill. There appears to be a direct correlation between the global jellyfish epidemic and eutrophication. Eutrophication is also for certain leading to the starvation and destruction of coral reef systems that are overwhelmed and suffocated by algae. In fresh water environments, eutrophication is starving fish of oxygen and ultimately destroying their natural habitat by overwhelming the habitat with biomass.

While overgrown or invasive, aquatic plants can be a nuisance as well as a hazard to the environment, those plants at the same time can present commercial opportunity. For example Irish Moss, also known as Chondrus crispus, Mastocarpus stellatus, or Mazaella japonica, is a type of storm-cast seaweed often found on beaches in certain areas. Alginates from Laminaria and Macrocystis also present commercial opportunity. The large amounts of seaweed can be a nuisance when it washes up on shore and begins to decay, causing a stench, releasing methane and hydrogen sulfide gases, and leaving the beach looking filthy. However, some seaweeds are high in carrageenan and alginates, which have significant commercial value in the food and cosmetic industry. It would therefore be beneficial to harvest this seaweed for its commercial value, while at the same time providing an effective removal service for the washed up seaweed on the beach.

Conventional methods of harvesting beached seaweed and other aquatic plants cast on or near shores of bodies of water include use of equipment such as all terrain vehicles and trailers on the shore. However, conventional methods do not address the difficulty of harvesting seaweed from shores where land access is unavailable. Furthermore, in sensitive beach environments, they can disturb the ground, causing the sea grass to die and the beach to erode, as well as promoting the destruction of clams and fish eggs by the use of tracked vehicles to access such beach areas.

Other methods of harvesting beached seaweed include accessing a shore with a large barge or landing craft. However, the waters near many shores have shallow areas where access would not be possible during low tide, as the barge would contact the ground and possibly damage clam beds and other sea life or ecology.

Another situation in which floatable material may need to be removed from the surface of a body of water or the beach is when floatable fibrous material are introduced to the surface of the water or beach, to aid in the clean up of a chemical such as petroleum. Many different apparatus that suction oil are known in the prior art. Currently, oil companies mainly use dispersants, which only cause the oil to break up, but do not remove the pollution, but rather hide it. Also, there is strong evidence that the use of a dispersant can make the oil itself many times more toxic to the environment, even if the dispersant itself is non-toxic. All oil removing machines have a limitation of rate and speed of pick up. Petroleum spills cause more damage to the environment the longer the oil spill is present. A situation in which non-organics may be used near a body of water is to aid in the clean up after a nuclear disaster near/within water, such as the use of titanate nanofibres or zeolite material to absorb radiation and radioactive isotopes.

Therefore, there remains a need for an efficient and environmentally sound system for harvesting seaweed from the shore and intertidal zone of a body of water and a need for a system for collecting floating fibrous material used in absorbing chemicals or radioactive isotopes spilled on a given body of water.

### SUMMARY OF THE EMBODIMENTS

In brief, a floatable material (e.g., seaweed; fibrous material used in oil-spill clean up or a nuclear disaster) harvester is disclosed, including a vacuum source, a transport hose, and a floatable-material receiver. In one embodiment, the transport hose has at least one air inductor/intake along its length, which allows air to enter the transport hose to accelerate its contents, by negative pressure air induction. The air inductor may have a valve controlled by an air flow meter. In another embodiment, a plurality of air inductors is shown. In some embodiments, a plurality of valves is shown. In another embodiment, a transport hose has at least one floatable-material thruster along its length, comprised of at least one nozzle, which provides pressurized fluid (e.g., air or water) in the direction of the flow of the harvested floatable material by positive pressure induction. In some embodiments, a plurality of floatable-material thrusters is shown. In some embodiments, the directed flow of fluid may also produce a strong Venturi effect, which draws product in through the floatable-material input of the thruster. A method is disclosed whereby the floatable-material harvester is used to harvest a chemically absorbent material (e.g., wood chips, straw, perlite, vermiculite, polypropylene mesh, zeolite) that has absorbed chemicals (e.g., oil or solvent) spilled in water. In another example, the apparatus is used to remove chemicals from a beach by use of sorbent material that is picked up by a vehicle configured to pick up floatable material. In some embodiments, the absorbent material may be floatable titanate nanofibres material and radioactive heavy metals/chemicals may be absorbed by this material. Zeolite and in particular some synthetic zeolites, are also suitable for absorbing radioactive material or isotopes. For the purpose of describing this invention, chemicals and radioactive material/isotopes may be referred to simply as pollutants.

Zeolite is any of a large group of minerals consisting of hydrated aluminosilicates of sodium, potassium, calcium, and barium. They can be readily dehydrated and rehydrated, and are used as cation exchangers and molecular sieves.

Disclosed is a floatable-material harvester, including a vacuum source having an input, a transport hose having an input at one end and an output connected to the vacuum source input, and having at least one air inductor/intake, and a floatable-material receiver, connected to the input of the transport hose. Also disclosed is a process, for when the floatable material is specifically seaweed, for treating and preserving the seaweed by washing, sterilizing, refrigerating, and oxygenating the seaweed.

In a related embodiment and improvement to the vacuum system, the at least one air inductor is replaced with at least one floatable-material thruster, which is a device designed to provide pressurized fluid in the direction of the flow of seaweed or other floatable material (whether natural or synthetic) to be collected, through at least one nozzle pointed in the relative direction of flow of the floatable material. The fluid, namely air or water, in some embodiments is provided by a pump connected to a high pressure hose that runs at least partially parallel to the transport hose and connects to the at least one floatable-material thruster. In some embodiments, at least one pump is connected to the at least one floatable-material thruster.

In a related embodiment, the floatable-material harvester further includes a trommel washer connected to the collection area. The trommel washer has a refrigeration unit to lower the temperature of the wash water to lower the temperature of the seaweed for preservation. In another embodiment, refrigeration is provided by circulating refrigerated air through the seaweed as it enters the storage container. In another embodiment, refrigeration is provided inside the storage container. The trommel washer also has an ozonator or other sterilizer such as bromine or chlorine, where ozone both sterilizes and oxygenates the seaweed. An ozonator is preferred because it does not require the storage of chemicals and ozone may be generated by means of passing air over an Ultraviolet-C light or by using a corona discharge apparatus. In another embodiment, the seaweed is passed by a UV-C (i.e., an Ultraviolet-C) light to sterilize the seaweed. In another embodiment, radiation is used to sterilize the seaweed.

In an additional embodiment, at least one air inductor has at least one air control valve regulating the flow of air through the at least one air inductor. An air inductor is an air intake that allows a controlled amount of air to enter the transport hose by negative pressure. In some embodiments, a plurality of air inductors is shown. In still another embodiment, the floatable-material harvester includes a microprocessor coupled to the at least one air control valve and configured to control the at least one air control valve. The at least one air inductor may further include an airflow meter, in another embodiment. A plurality of air inductors may assist material in traveling a greater distance than a single air inductor.

In yet another embodiment, the least one air inductor includes a snorkel to help ensure that air and not water is intaken by placing the level of the air intake a distance above the normal water level, while being high enough of a distance to minimize take on water from waves. Another embodiment of the floatable-material harvester includes an airtight hose section filled with air, through which the transport hose passes, with the airtight hose section interior being connected to the interior of the transport hose by the at least one air inductor.

In another embodiment, the at least one air inductor is replaced with or possibly supplemented by at least one floatable-material thruster connected to a pump. A floatable-material thruster is a device designed to inject high pressure fluid into the transport hose from a fluid input and through at least one nozzle. In some embodiments, the floatable-material thruster operates in the same manner as a conventional air conveyor, comprised of a fluid input that connects to an outer plenum that is pressurized with fluid, connected to a ring of nozzles that injects the fluid into the direction of the flow of the floatable material through the inner passage. Air conveyors also may have a slightly smaller passage diameter than the connecting hose, causing a Venturi effect to occur on the inlet and thrust on the outlet of the floatable-material thruster. In some embodiments, the floatable-material thruster is provided fluid through at least one flow control valve. In other embodiments, the flow control valve is controlled by a microprocessor. In some embodiments, at least one flow meter is connected in series with the at least one flow control valve and controls the at least one flow valve. In some embodiments, at least one pressure sensor provides pressure information from inside the transport hose to a microprocessor, which for the purposes of the present disclosure could, by way of example only, be part of a personal computer or a computer network or may be a stand-alone programmable logic circuit (PLC). In some embodiments, the microprocessor also receives information from the at least one flow meter. In another embodiment, the pressure sensor controls at least one of the flow valve, pressure regulator, and the speed or thrust of the pumps by an analog electrical connection. In another embodiment, the at least one pressure sensor is located on the high pressure hose and/or the high pressure tank. In another embodiment, an air inductor may operate in the opposite flow direction to function as a gas escape mechanism, where it is positioned in such a manner as to relieve gas pressure produced in the transport hose by the floatable-material thruster. A filter screen may be placed over the air output, as to prevent the solid contents of the transport hose from plugging the gas escape mechanism.

In yet other embodiments, the microprocessor uses the information from the at least one pressure sensor and the at least one flow meter to control the at least one flow valve and the speed of the high pressure pump. In another embodiment, the microprocessor also controls the speed of the vacuum source or of a centrifugal or other type of water pump. The water pump and vacuum source each may have its speed and/or power controlled, for example, by the rpm (i.e., revolutions per minute) of an engine, by pulsation, or by otherwise providing continuous flow or bursts of energy by combustion, electrical, or waste steam from an incinerator connected to the apparatus.

According to another embodiment, the floatable-material receiver further includes a hopper having an outlet coupled to the input of the transport hose. In an additional embodiment, the hopper also includes an agitator, which vibrates to assist in the flow of floatable material. In another embodiment of a feeder mechanism, the floatable-material receiver includes a paddle wheel placed within the floatable-material receiver so as to stir its contents into the transport hose. In still another embodiment, the floatable-material receiver includes a nozzle placed within the floatable-material receiver, so as to propel the floatable-material receiver's contents with a water jet into the transport hose. The nozzle is connected to a water pump that receives water from a water source and drives the water into the nozzle to produce the water jet. The water jet may propel the floatable material into a funneling element and into the transport hose, or the water jet may propel the floatable material directly into the transport hose. In some embodiments, a water jet or nozzle is submerged into the floatable material within the beach or surf, propels the material onto a mechanic device that picks up floatable material, such as a conveyor belt. In another embodiment, the nozzle simply propels material in the surf or on the beach into the floatable-material receiver. In another embodiment, the nozzle is fluidly connected to an air compressor and instead provides an air jet.

Another embodiment of the floatable-material harvester includes a flotation device supporting the floatable-material receiver in order to keep the floatable-material receiver approximately near the level of the water in which it is operating. In a related embodiment, the flotation device further includes buoyancy control to allow the floatable-material receiver to be lowered into the water. In another embodiment, the flotation device additionally includes a propulsion system. In another embodiment, the transport hose has at least one flotation device to promote the buoyancy thereof. In yet another embodiment, the flotation device has a rudder. The flotation device further includes an anchoring system, in another embodiment. In a related embodiment, the anchoring system is automated.

A method is also included for harvesting beached and/or near-shore floatable material. The method involves dispersing sorbent material designed or suitable for absorbing petroleum or other chemicals and radiation/radioactive material while repelling water. The method may involve dispersing the material with an apparatus comprised of a storage area, feeder mechanism, floatable material receiver, and a transport hose comprised of at least on floatable material thruster. The method involves providing a floatable-material harvester as described above, activating the vacuum source or high pressure pump, supplying floatable material to the floatable-material receiver, and emptying harvested floatable material from the collection area. In the case of petroleum, the method further includes incinerating at least some of the collected floatable-material within the harvesting apparatus. The method then includes using the waste heat from the incinerator to provide power for the harvest apparatus. That power may be provided by way of steam to turbine and/or impeller. The same method includes using an air inductor along the length of the transport tube and a vacuum source, that both may replace or supplement the floatable-material thruster and high pressure pump.

In some embodiments, the seaweed is farmed either on a bottom substrate or a suspended structure. Further in this document, seaweed is cultivated and converted to high purity ethanol upon the vessel that harvests the seaweed.

In some embodiments, collected seaweed is metered into and through a mesh belt dryer, which is a well known apparatus for drying seaweed. This dryer provides air flow through a layer of seaweed that is several inches deep on a conveyor belt. The seaweed is often stirrated or flipped over as it moves down the conveyor belt to cause even distribution of air and drying. In some embodiments, instead of drying, the mesh belt dryer has an air intake that is fitted with a refrigeration unit, so that cold air is circulated through the seaweed, lowering its temperature to around −2 degrees Celsius as it moves down the conveyor belt. In some embodiments, an apparatus that cools the seaweed by cold air is used instead of the refrigeration unit in the seaweed washer. In some embodiments, a rotary dryer is used in place of a mesh belt dryer or any device suited for circulating cold air around solid material. The exhaust and intake of the mesh belt dryer may be directly connected by a circulation fan, so that the evaporator coils or other cooling mechanism of the refrigeration unit are in the path of the airflow. Cooling the seaweed from ambient temperature has the effect of dramatically lowering its rate of decomposition.

In other embodiments, the collected seaweed is processed through a seaweed washer. In some embodiments, the seaweed washer is comprised of a refrigeration unit to lower the temperature of the wash water, which in turn lowers the temperature of the seaweed. In other embodiments, the wash water is injected with a sterilizing agent such as ozone, bromine, or chlorine. In another embodiment, the seaweed is sterilized by ultraviolet-C (e.g. UV-C) or electromagnetic radiation suitable for killing, e.g., bacteria, nematodes, protozoans, and fungi, thereby suitably sterilizing the seaweed. Sterilizing the seaweed also aids in slowing the rate of decomposition.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a schematic diagram of an overhead view of an embodiment of a mechanized floatable-material harvester;

FIG. 1B is a schematic diagram of a side view of an embodiment of the transport hose and a rear facing direct view of an embodiment of an amphibious vehicle;

FIG. 2 is a schematic diagram of an overhead view of an embodiment of a floatable-material harvester;

FIG. 3 is a schematic diagram of an overhead view of an embodiment of a floatable-material receiver;

FIG. 4 is a schematic diagram of a side view of an embodiment of a floatable-material receiver;

FIG. 5 is a schematic diagram of an overhead view of an embodiment of a floatable-material receiver;

FIG. 6 is a schematic diagram of a side view of an embodiment of a floatable-material receiver;

FIG. 7 is a schematic diagram of an overhead or top view of an embodiment of a floatable-material receiver;

FIG. 8 is a schematic diagram of a side view of an embodiment of a floatable-material receiver;

FIG. 9 is a schematic diagram of a side view of an embodiment of a floatable-material receiver;

FIG. 10 is a schematic diagram of an overhead view of an embodiment of a floatable-material receiver;

FIG. 11A is a schematic diagram of a direct view of an embodiment of a gas escape mechanism;

FIG. 11B is a schematic diagram of an overhead view of an embodiment of a gas escape mechanism;

FIG. 12 is a schematic diagram of an overhead view of an embodiment of a floatable-material receiver;

FIG. 13 is a schematic diagram of a side view of an embodiment of a floatable-material receiver;

FIG. 14 is a schematic diagram of an overhead view of an embodiment of a floatable-material receiver;

FIG. 15 is a schematic diagram of a side view of an embodiment of a floatable-material receiver;

FIG. 16 is schematic diagram of an overhead view of an embodiment of a floatable-material thruster;

FIG. 17 is a schematic diagram of an overhead view of an embodiment of a floatable-material thruster;

FIG. 18A is a schematic diagram of an overhead view of an embodiment of a floatable-material thruster;

FIG. 18B is a schematic diagram of an overhead view of an embodiment of a floatable-material thruster;

FIG. 19 is a schematic diagram of a direct view of an embodiment of a floatable-material thruster;

FIG. 20 is a schematic diagram of a direct view of an embodiment of a floatable-material thruster connected to a water pump and floatation device;

FIG. 21 is a schematic diagram of an embodiment of a trommel washer, sterilizer, and refrigeration unit that can be used with the floatable-material harvester;

FIG. 22 is a schematic diagram of an embodiment of an overhead view of a floatable-material harvester;

FIG. 23 is a schematic diagram of a side view of an embodiment of a floatable-material receiver and an entrance of air for at lease one air inductor;

FIG. 24 is a schematic diagram of an embodiment of an overhead view of an air induction floatable-material harvester;

FIG. 25 is a schematic diagram of a side view of an embodiment of a floating air inductor through a snorkel;

FIG. 26 is a schematic diagram of a direct view of an embodiment of a floating air inductor;

FIG. 27A is a schematic diagram of an embodiment of an overhead view of a plug designed to bleed air;

FIG. 27B is a schematic diagram of an embodiment of a side view of a plug designed to bleed air.

FIG. 28A is a schematic diagram of a direct view of an embodiment of an air induction system with an air tight outer hose;

FIG. 28B is a schematic diagram of a side view of an embodiment of an air induction system with an air tight outer hose.

FIG. 28C is a schematic diagram of an overhead view of an embodiment of an air induction system with an air tight outer hose;

FIG. 29 is a schematic diagram of an overhead view of an embodiment of a floating air inductor;

FIG. 30 is a schematic diagram of a direct view of an embodiment of a floating air inductor with a counterweight;

FIG. 31 is a schematic diagram of an embodiment of a side view of a floatable-material receiver;

FIG. 32A is a schematic diagram of an overhead view of an embodiment of an elongated pickup mechanism;

FIG. 32B is a schematic diagram of a side view of an embodiment of an elongated pickup mechanism;

FIG. 33A is a schematic diagram of an overhead view of an embodiment of a swivel conveyor apparatus;

FIG. 33B is a schematic diagram of a side view of an embodiment of a swivel conveyor apparatus;

FIG. 34 is a schematic diagram of an overhead view of an embodiment of a sorbent material disbursement apparatus;

FIG. 35 is a schematic diagram of a side view of an embodiment of a mechanical pick-up device;

FIG. 36A is a schematic diagram of a side view of an embodiment of a filter which exits water and collects floatable material;

FIG. 36B is a schematic diagram of a side view of an embodiment of an instrument that measures water speed and direction;

FIG. 37 is a schematic diagram of an embodiment of communication and/or control connections between various devices to a microprocessor;

FIG. 38 is a schematic diagram of an embodiment of communication and/or control connections between various devices to a microprocessor;

FIG. 39 is a schematic diagram of an embodiment of a rear view of a bendable conveyor mechanism that picks up floatable material;

FIG. 40 is a schematic diagram of an embodiment of a side view of a double jointed bendable conveyor connection;

FIG. 41 is a schematic diagram of an embodiment of an overhead view of an ethanol fuel barge and incinerator;

### DETAILED DESCRIPTION OF SPECIFIC EMBODIMENTS

Embodiments of the disclosed floatable-material harvester, when used particularly to harvest seaweed or chemically absorbent material, enable workers on a shore of adjacent body of water to clean up seaweed or other floatable material more efficiently, with less environmental impact. The improved transport hose has the effect of accelerating the speed of material as the air speed increases over each air inductor, allowing a significant increase in both travel/conveyance distance, even while possibly using a smaller hose diameter. The improved suction also permits the harvester to collect seaweed or other floatable material more rapidly. Even more mass may be moved and/or an even larger conveyance distance may be achieved in some embodiments which depict at least one floatable-material thruster comprised of at least one nozzle pointed in the general direction of flow of the seaweed or floatable material, where the floatable-material thruster provides pressurized fluid from at least one pump through a high pressure hose. Even more mass may be transported a longer distance with the use of a plurality of floatable-material thrusters and a plurality of flow control valves.

Some embodiments disclosed herein are designed to harvest seaweed, particularly loose seaweed on the surface or shore of any body of water. “Seaweed” for the purposes used in this document includes oceanic seaweed, kelp, and other algal “plants,” as well as any aquatic plant or plant-like organisms in fresh, brackish, or salt water. Embodiments of the disclosed floatable-material harvester may function on the surface or shore of any body of water, including oceans, seas, bays, fjords, lagoons, lakes, rivers, streams, ponds, estuaries, marshes, salt marshes, and swamps. The “shore” or “beach” of a body of water is the area of land immediately adjacent to that body of water.

It is noted that, for simplicity sake and ease of description, the floatable-material harvester is being described primarily in the context of harvesting seaweed but, as previously noted, the system can be used in a similar manner to harvest/retrieve other types of floating or beached sorbents, also known as a chemically absorbent material (e.g., wood chips, vermiculite, straw, clay, mesh polypropylene, zeolite, titanate nanofibres), such as those employed to aid clean up of a chemical or pollutant spill (e.g. absorbent material capable of floating in water) and providing that such material could be harvested either while floating or once beached on a shore. It is to be understood that, for the purposes of cleaning up non-organic beach/floating sorbents (e.g., clay, perlite, titanate nanofibres), the system described herein for use with floating organics can also be used to clean up of such non-organic beached/floating sorbents, given that the principles of operation are basically the same for such materials. Also, natural and synthetic zeolite minerals have a unique ability to absorb radiation and harmful substances from the environment. They are used even in food supplements for people employed in industries where there is a risk of exposure. Products such as zeolite which may not be easily pierced and picked up by a tine may be blended with a Styrofoam, fabric, or other material that is easily picked up by a tine or hook. In some embodiments, the absorbent material may be configured into loops. In some embodiments, zeolite or nanofibres may be embedded in natural material such as cotton. In some embodiments, zeolite or nanofibres may be embedded in a synthetic material such as but not limited to polypropylene mesh. In some embodiments, the sorbent may be comprised of magnetic material, so that it may be easier for a mechanical device to pick up.

A beach cleaner is a vehicle or pull-behind unit that operates on the beach and is designed to remove seaweed and refuse while leaving sand, either from the beach or near-shore waters. Beach cleaners may be comprised of a mechanical pick up device, or pick up material that can be pierced or grabbed by the tines. Beach cleaners come in many different forms and have been in active use for decades. The beach cleaner's largest limitation is that it has a collection area which becomes full, which requires the beach cleaner to travel to a separate vehicle to transfer the load, or a vehicle needs to meet the beach cleaner. This is fuel inefficient and an inefficient process in general. Beach cleaners may also only use one pick up mechanism, which makes the rate of pick up too slow for a mass removal from a single apparatus. Beach cleaners also have no means of elevating themselves over large obstructions. Also, once the load is transferred to truck, it is well known and published that barging can be roughly 6.2 times more fuel efficient than trucking a material an equal weight and distance. In some embodiments, the beach cleaner may be replaced with an amphibious vehicle. In some embodiments, the vehicle may be a hovercraft. In some embodiments, a vehicle that floats may be configured to pick up floatable material from the beach or within a body of water.

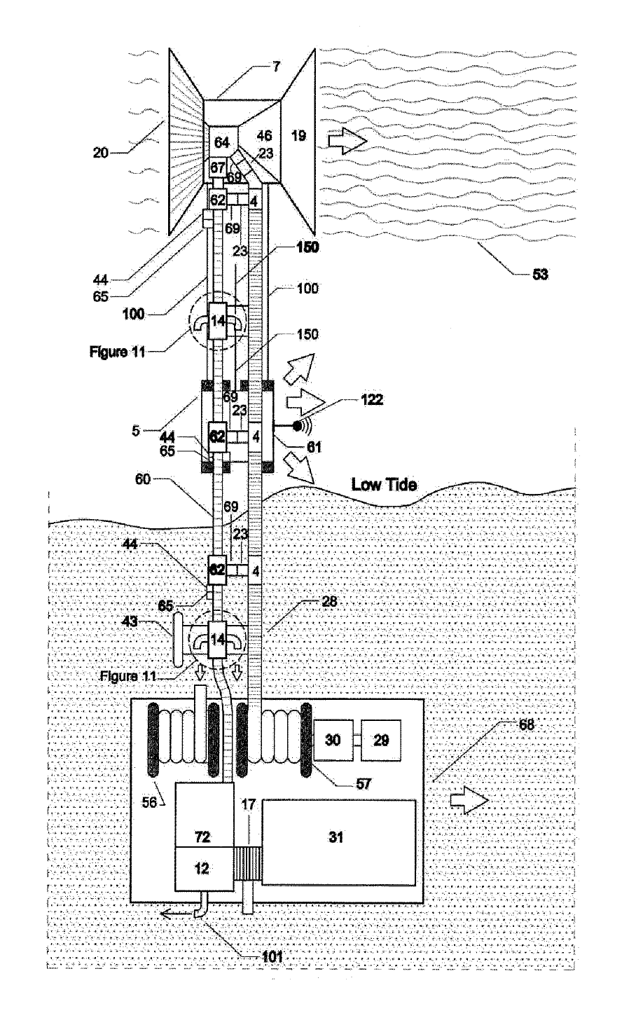

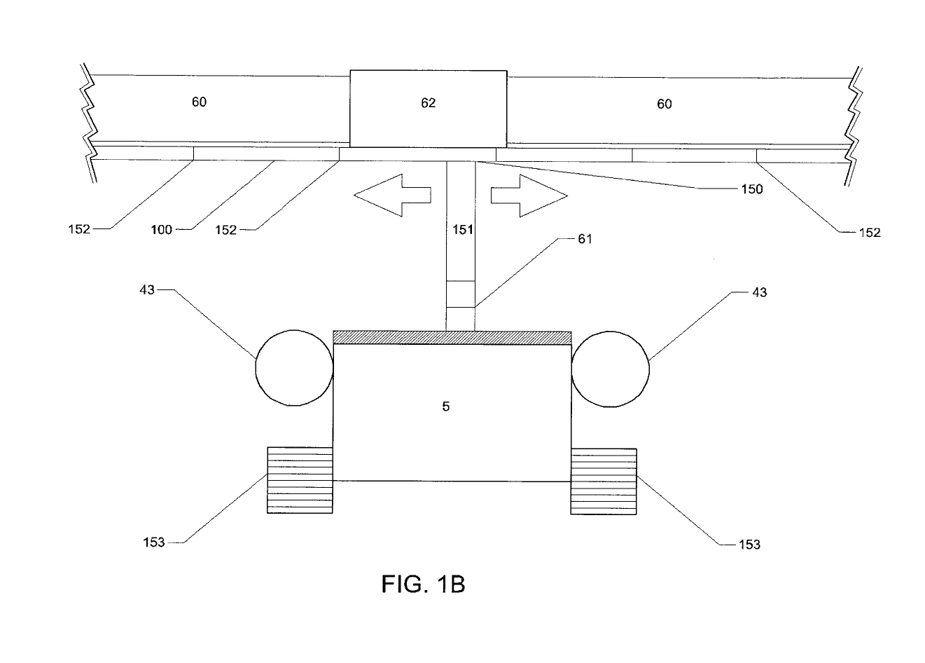

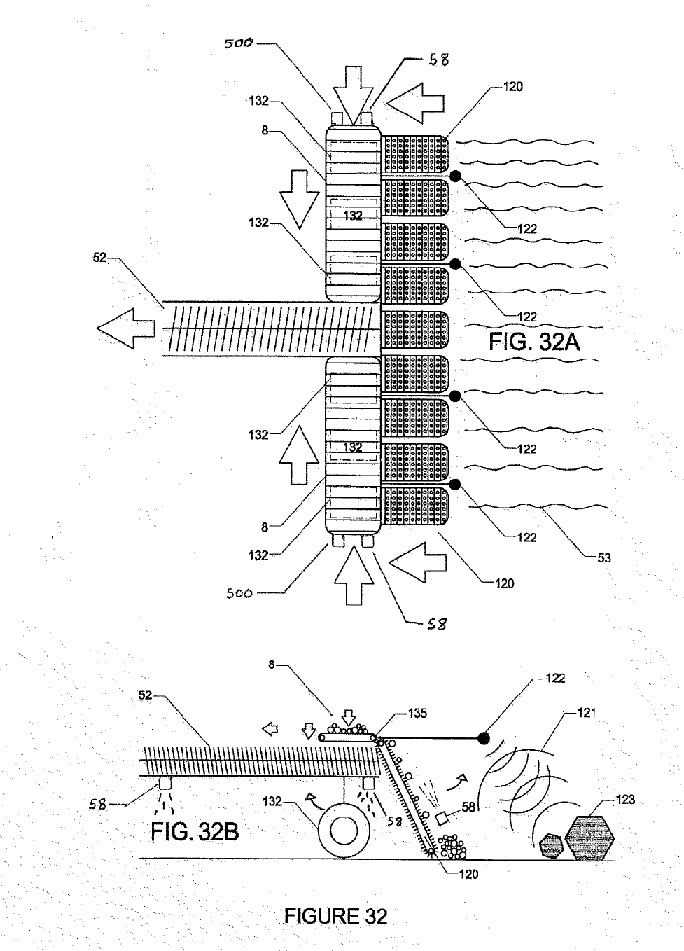

FIG. 1 and FIG. 1B is the embodiment of the inventive components of a completely mechanized apparatus, where beach cleaner 7 would have arrived by land or by amphibious means. The beach cleaner 7 generally includes a mechanical pick-up device 120, depicted in FIG. 32. This device may be a rake and a rotating cylinder with numerous small tines that pick up material from the sand, leaving most of the sand behind. In one embodiment, the device may also pick up seaweed/floatable material in a manner similar to a farm combine with a rotating cylinder and flat blades. In another embodiment, sand and waste are collected via the pick-up blade of the vehicle onto a vibrating screening belt, which leaves the sand behind while retaining the floatable material. Beach cleaners generally operate and move themselves on wheels or tracks. Beach cleaners transfer the collected material to a collection area. These collection areas generally have means of transferring their load to another vehicle, either by dumping or conveying.

In some embodiments, an elongated pick up 19 depicted in FIG. 1 is comprised of a side-by-side row of conveyor belts which are mechanical pick up device 120 depicted in FIG. 32, which are further comprised of many tines, the conveyor belts which are mechanical pick up device 120 as depicted in FIG. 32. In some embodiments, the same mechanism may pick up floating material from a body of water. In some embodiments, the conveyor belts which are mechanical pick up device 120 may have cutters on the bottom, which sever algae weeds from the bottom of the body of water. The row of conveyor belts that are mechanical pick up device 120 transfers the collected material to two transverse conveyor belts 8, which both operate in opposite directions to one another, so that the flow of collected floatable matter flows from the outside of the elongated pickup into the center of the apparatus. The floatable material in one embodiment is then transferred to reducing and metered conveyor belt 46 shown in FIG. 1. In reference to FIG. 32 and in another embodiment, the floatable material is transferred to a screw conveyor 52. The terms screw conveyor and screw auger are used interchangeably in this document, but both are conveyors.

In one of the embodiments and in relation to FIG. 1, the vessel 68 arrives in a position and depth that is calculated to be safe, controlled by an operator where the vessel may be self propelled or pulled by tugboat. The spool 57 deploys high pressure hose 28, and transport hose 60 is deployed from spool 56. A floatable-material thruster 62 is lined up with a water tight connector 4, a flow valve 69 and flow meter 23, which are threaded or otherwise connected to floatable-material thruster 62 and water tight connector 4. In some embodiments, the flow valve 69 may be replaced with a pressure regulator valve. In some embodiments, the flow valve 69 may be replaced with any device designed to control the flow of fluid through the floatable-material thruster 62. As the hose is deployed from the two spools, this may be repeated perhaps dozens of times if a long hose length is required to reach the beach. Several amphibious vehicles 5 may, as needed, position themselves between the beach cleaner 7 and the low tide line. The amphibious vehicles 5 attach the floatable-material thruster 62 assembly by swivel plate 61, separated by an undercarriage 100. The undercarriage may have a series of horizontally flexible joints 152 as depicted in FIG. 1B, so that the entire apparatus can bend, as well as wrap itself assembled around a large spool. The swivel plate may be further connected to a slider/prismatic joint 150, so that the amphibious vehicle 5 may turn and move lateral underneath the undercarriage 100 by the swivel 61 and the slider joint 150. The ends of the hoses are attached to beach cleaner 7. Floating transport hose 60, in its operative state, is disconnected from spool 56 and connected, directly or indirectly, to water pump 72 (e.g., a centrifugal water pump in the illustrated example). The hoses are suspended between the beach cleaner 7 and from each amphibious vehicle 5 by an undercarriage 100. The swivel 61 connected to the amphibious vehicle may assist the apparatus in turning and moving up and down the undercarriage 100 by the slider joint 150. In some embodiments, the swivel 61 may be comprised of a ball joint, so that it may rotate in all directions. In some embodiments, the amphibious vehicle 5 is a hovercraft. In some embodiments such as in FIG. 1B, the amphibious vehicle 5 is supported and moved by treads 153. In some embodiments such as depicted in FIG. 32, the amphibious vehicle is equipped with a radar/sonar system 122, which is further disclosed in this document, so that the amphibious vehicle 5 may avoid obstructions while still suspending the transport hose 60 above the ground. The amphibious vehicle 5 may be further comprised of a vertical jack 151 such as in FIG. 1B, so that the microprocessor 11 may raise or lower the apparatus over obstructions. Jacks employ a screw thread or hydraulic cylinder to apply very high linear forces. The jack 151 may be a scissor jack. Before the apparatus is deployed, an aircraft, satellite, vessel, or vehicle may survey the terrain in advance with radar, sonar, infrared, laser, or photographic imagery and provide such data to the microprocessor 11, so that the microprocessor may best determine the best route for the harvesting apparatus to undertaken, and the microprocessor shall determine if certain obstructions may present difficulty or should be avoided. In some embodiments, the underwater terrain is surveyed by an Autonomous Underwater Vehicle (AUV) or a manned submarine.

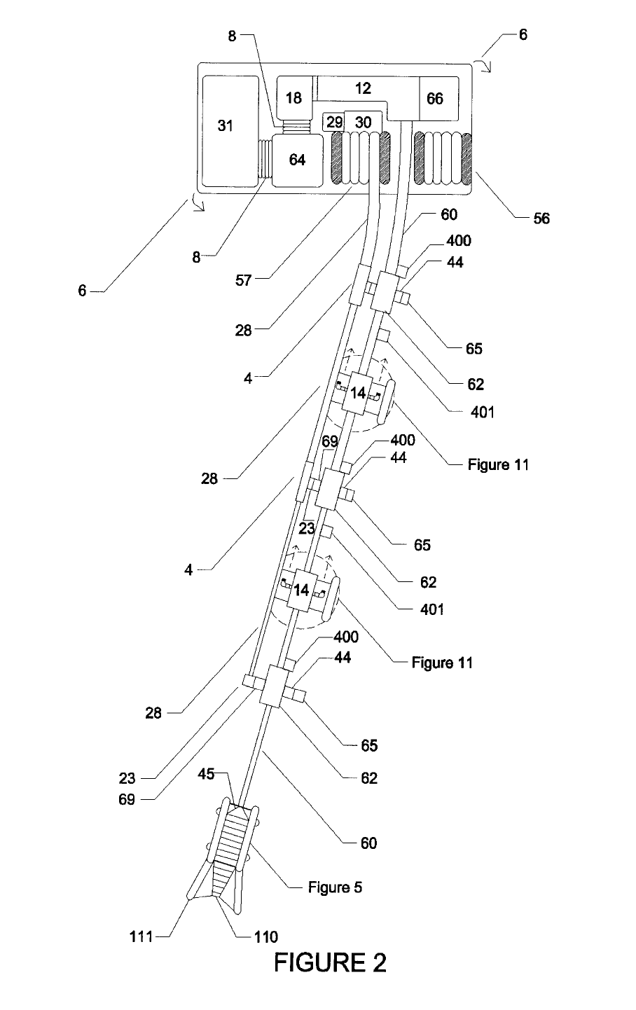

For simplicity of naming conventions, hoses that transport floatable material are often referred to herein as “suction hoses” and vise-versa, given that a vacuum source is often employed to move material toward the collection area 12 in FIG. 1 and FIG. 2. However, these hoses may be more generically considered to be “transport hoses”. The generic term applies because such hoses are indeed being used to transport floatable materials such as seaweed, but the means to move the floatable material may involve vacuum and/or thrust forces. That is, vacuum or suction forces drawing the material flow toward the hose 60 output, or thrust forces, pushing the material flow toward the hose output, can be used, and illustrations of both mechanisms are indeed shown.

Returning to FIG. 1, beach cleaner 7 has an elongated pick up 19 designed to transport seaweed from the beach into a collection area on the beach cleaner unit 7. The pick up 19 is adjustable in height to leave a layer of seaweed in place on the beach if desired, often to ensure that a proper and natural level of nutrients are returned to the sea. An elongated pick up 19 is well known on farm combines and other types of similar harvesting machinery. In some embodiments, the elongated pick up 19 may be a rotating cylinder with horizontal blades that picks up the seaweed/floatable material and places it on a reducing/channelling metered conveyor belt 46. In some embodiments, several hooks may be positioned on the mechanical pick up device 120. The hooks or tines may each pass through a flat surface with a narrow opening for each tine to pass through, so that the attached material is severed and remains on top of the flat surface. The tine may return down the device to obtain more material from the sand or surf, while the severed material now flows by force of gravity or any other means of propulsion (such as one of those described in this document), towards the floatable material receiver. In some embodiments, the tines or hooks may be configured in such a manner as to retract from the surface, which may cause the material picked up to drop. The tines may then emerge to the surface of the conveyor to pick up more material. The beach cleaner vehicle may be equipped with means of flotation. The beach cleaner in some embodiments may be an amphibious vehicle that can also collect material from the surf. In some embodiments, the beach cleaner 7 may be substituted with a small vessel, so that only a harvest from shallow water may take place.

In some embodiments, the pick up 19 is a rotating conveyor belts that are mechanical pick up device 120 containing a large amount of tines or hooks that combs through the sand and removes surface and buried debris while leaving the sand on the beach. In some embodiments, the conveyor belts that are mechanical pick up device 120 transfer their load to a transverse conveyor 8 (see FIGS. 32 a-b) oriented crosswise thereto. In some embodiments, that transverse conveyor 8 may be a screw conveyor. In some embodiments, the transverse conveyor 8 may be curved and follow a transverse curve in relation to the mechanical pick up device. In other embodiments, the transverse conveyor 8 may be particularly perpendicular to a given mechanical pick up device. The collection area of the beach cleaner 7, in the illustrated embodiment, has been removed or bypassed, so that the flow of the seaweed on the elongated pickup 19 is fed into a reducing/channelling and metered conveyor belt 46. This funnelling element 46 is comprised of two tapered walls that rest on top of the conveyor belt, so that forward motion of the conveyor belt causes the seaweed on top of the belt to pile up along an increasingly narrower path.

FIG. 32 indicates an embodiment of a conveyor system designed to pick up and remove floatable material from the beach or the surf. FIG. 32A illustrates an overhead view of the conveyor apparatus, while FIG. 32B represents a side view thereof. In some embodiments, the conveyor apparatus may include one or more conveyor belts provided with tines, which thereby serves as a mechanical pick up device 120. The tine-carrying conveyor belts are used to pick up and transfer material from the beach.

In some embodiments, an upward facing nozzle 58 fluidly connected to a pump is extended into the material to be harvested. Further, the upward facing nozzle 58 may provide pressurized fluid in the direction of flow onto the mechanical pick up device 120 to assist in picking up that floatable material. In some embodiments, the nozzle 58 may replace or assist the mechanical pick up device 120. In some embodiments, the nozzle 58 may be raised or lowered into the floatable material by, for example, a swivel or elevator.

In some embodiments the mechanical pick up device 120 may have a magnetic surface, and the floatable material may be magnetic, so the floatable material is picked up. In another embodiment, the apparatus of FIG. 32 is equipped with a means of flotation, such as pontoons 43, so that the floatable material can be harvested from the surf. In a similar embodiment, downward projecting nozzles 58 may provide pressurized fluid in a downward direction and may respectively be positioned at various intervals (e.g., in a patterned layout) across the bottom of the apparatus for balance, in a manner so as to provide lift and stability of the apparatus in the surf. Each nozzle 58 may be fluidly connected to at least one of a flow valve and a pump (not specifically shown in this FIG. 32 embodiment). As such, the downward projecting nozzles 58 may effectively serve as a means of flotation.

In a related embodiment, a wave sensor 500 may provide information to microprocessor 11. A wave sensor 500 may be a float switch. A wave sensor 500 may be a mercury tilt switch. In some embodiments, a wave sensor 500 may be a radar or sonar system configured in such a manner as to provide distance information from the water to microprocessor 11. A wave sensor 500 may also be an acoustic sensor. A wave sensor 500 may also be comprised of accelerometers. A wave sensor 500 may be a gyroscope.

Information from the wave sensor 500 may be used for a variety of purposes. For one, the feedback may be used to control flow valves (not specifically shown in FIG. 32) to open behind the downward facing nozzles 58. A wave sensor 500 indicating a downward wave may result in the microprocessor 11 to cause the opening of one or more flow valves in order to provide a counter thrust of energy through the downward facing nozzles 58. Providing counter thrusts to descending waves may provide more stability of the apparatus in rough weather. A thrust may become greater in intensity as a wave moves away from the downward facing nozzle 58, and lower in intensity as the wave approaches. The information from the wave sensor 500 could be used for other purposes, as well, such as for generating an alert for workers of changing weather/tidal conditions.

In some embodiments, the apparatus shown in FIG. 32 may operate underwater and remove floatable material, such as growing algae and seaweed from the floor of the body of water. When working along the floor of the body of water, flotation thereof is clearly not desired, and, in some instances, the flow direction within the downward projecting nozzles 58 may be reversed (compared to that discussed above), so as to help force (e.g., in the form of a vacuum and/or of downward thrust) the apparatus toward the floor of the body of water.

In some embodiments, the reverse and forward propulsion of the floatable-material receiver and the apparatus of FIG. 32, may be provided by additional nozzles (not shown) respectively pointed one of forward and reverse. This set of forward/reverse propulsion nozzles may be oriented parallel or co-planar to the main plane of the floatable-material receiver or at an angle relative thereto (if the latter, those nozzles could be used to influence both the vertical and horizontal position of the floatable-material receiver. The set of forward/reverse nozzles may be fluidly connected to at least one pump and/or flow valve and, together, may provide better results than a propeller driven thruster and/or may allow the floatable-material receiver to operate in very shallow water.

In some embodiments, the mechanical pick up device 120 and/or the conveyors 8 are equipped with covers, so that floatable material does not float away if submerged in water. In the same or similar embodiment, a water pump can be used exclusively without a thruster apparatus, where a water pump moves floatable material from the bottom of a body of water to the surface and through the water pump.

In the same or similar embodiment, the output of the transport hose may be projected against a screen which allows water to pass through, while collecting the floatable material within the screen. In some embodiments, the screen is sloped so that the bottom of the screen is farther away from the transport hose output than the top of the screen. This may cause floatable material to be forced downward onto a transverse conveyor. The motion of the transverse conveyor may provide continuous removal of floatable material from the water stream.

In some embodiments, projecting the water stream in an upwards direction may be used to dissipate energy. In some embodiments, conveyors 8 may particularly be tined conveyors, synchronized such that the respective tines thereof would not to collide with the tines of the mechanical pick up device 120. In some embodiments, the mechanical pick up device 120 may have at least one swivel joint, so that the device may bend like a finger as it picks up floatable material.

In some embodiments, the conveyor system of FIG. 32 may be mounted on an amphibious vehicle or a beach cleaner. In one embodiment, the conveyor system may be floated by a boat or a series of floatation devices. In some embodiments, the apparatus of FIG. 32 may have buoyancy control by selectively flooding and/or evacuating ballast tanks or hollow spaces. In some embodiments, neutral and negative buoyancy is maintained by a downward thrust of at least one of a propulsion device and a floatation device connected to the apparatus. It is also contemplated, in one variation, that the apparatus be provided with at least one “full-time” and/or naturally buoyant element, so that if the power fails, the apparatus will float to the surface of a body of water even without power, as the apparatus maintains natural buoyancy and is simply held to the floor by downward thrust due to the weight of the system (i.e., gravitational thrust).

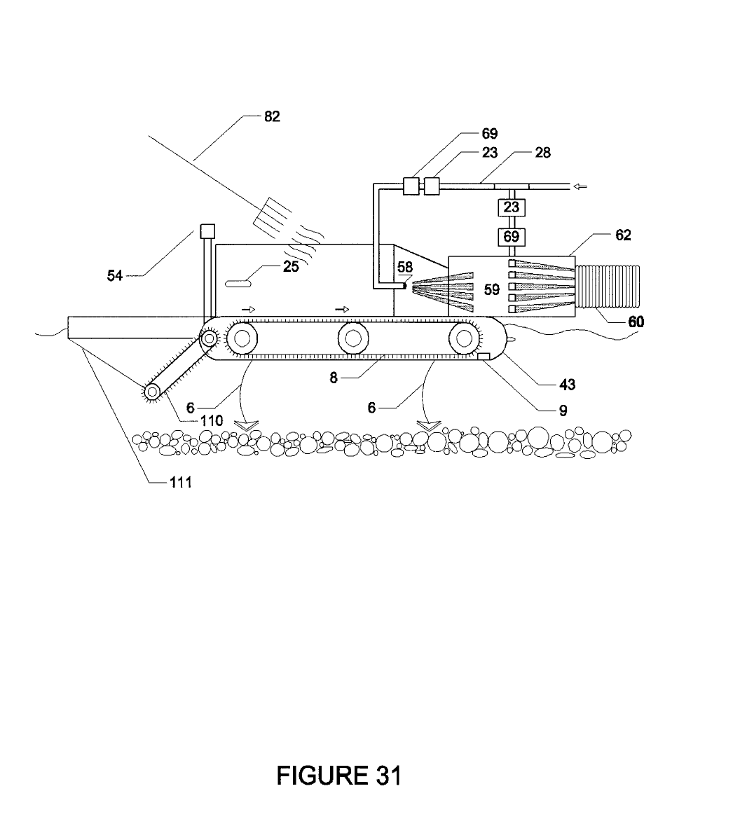

In another embodiment, cylinders with tines are used to pick up material from the beach or surf, as commonly employed in a beach cleaner vehicle or pull behind. As depicted, floatable material flows from the mechanical pick up device 120 and is transferred to two transverse conveyor belts 8. In some embodiments, the conveyor belts 8 are replaced with screw augers, which may also be known and/or referred to in this document as screw conveyors 52. Both conveyors move in an inward direction towards a central screw conveyor 52 that is configured to receive material from the two conveyor belts 8. In some embodiments, the central screw auger 52 may be replaced by a conveyor belt 8. The screw auger 52, which for the scope of this document may be referred to as a conveyor or conveying device, moves floatable material directly into the floatable-material receiver, which in some embodiments is equipped with a funneling element 45. The floatable material may then be fed directly into the transport hose 60. In other embodiments, such as depicted in FIG. 31, the floatable material may pass by a floatable-material thruster 62 before entering the transport hose 60. In some embodiments, a nozzle 58 is positioned in the direction of the flow between the conveyor and the entrance of the transport hose 60, as to provide pressurized fluid to assist with entry of floatable material into the transport hose 60 by an expanding, directed fluid stream 59, as depicted in FIG. 31.

In some embodiments, the entire conveyor apparatus of FIG. 32 is a pull behind unit. When used as a pull behind unit, the floatable material first flows under the apparatus and is picked up after the apparatus has passed over the floatable material. In some embodiments, such as depicted in FIG. 1, the elongated pick up apparatus 19, which may be the pick up apparatus of FIG. 32, is positioned in front of the vehicle or vessel that transports the apparatus, so that very little floatable material passes under the apparatus.

In some embodiments, each mechanical pick up device 120 may be connected with a powered swivel 135 connected to the apparatus, in such a manner that each mechanical pick up device may each individually be adjustable in height/vertical position by means of a controller (e.g., on-board PLC, wireless remote, etc.). Such a mechanism assists in passing over beach or surf that is uneven in height or where obstructions such as rocks are present. In one embodiment, one conveyor is positioned perpendicular or at least generally transverse to all of the mechanical pick up device, and the end of the conveyor belt is curved so that the material flows directly to the floatable-material receiver. In some embodiments, one conveyor is curved in a semi-circle to receive floatable material from a multitude of mechanical pick up device. In the same embodiment, each mechanical pick up device is positioned in a transverse curve to the at least one receiving conveyor, which then conveys its load into the floatable material receiver. In some embodiments, the height of the mechanical pick-up device 120 is moved by a gear motor connected to a given swivel 135.

In another embodiment, a hydraulic device is used to raise and lower the mechanical pick-up device 120. In another embodiment (not illustrated), the mechanical pick-up device 120 is raised and lowered by cables connected to a winch, pivoting on the swivel 135 earlier described. In some embodiments, the mechanical pick-up devices are connected to elevators (not shown) that raise and lower the devices. In another embodiment, a conveyor belt that picks up floatable-material may be retractable and extendable in overall length. This may be accomplished by, e.g., sliding joints between the rows of tines. In the same embodiment, the slider joints may, for example, be controlled by hydraulic pressure. In some embodiments, the slider joints may by extended and compressed by springs.

The mechanical pick-up devise may also incorporate a plurality of pressure sensors, which may control the retraction or expansion of the mechanical picks up device 120, directly or through the decision of a microprocessor. It should be noted that material that does not float may still be picked up by this invention, including but not limited to rocks and sand. However, the intention of this invention is to efficiently pick up relatively light material, and ideally but not necessarily material that can be pierced or grabbed by tines or hooks.

A series of retractable wheels 132 or treads may be positioned on the floatable-material receiver or the conveyors 8 depicted in FIG. 32. Retractable wheels are well known on aircraft. These wheels or treads, which may be referred to as devices that turn on an axle to provide motion, may be retractable to overcome objects and to provide clearance when the apparatus is floating in the water. In some embodiments, the wheels, tracks, or treads may have means of propulsion such as an electric, hydraulic, or internal combustion engine. In other embodiments, the devices that turn on an axle to provide motion 132 may only provide means of mobile support of the apparatus and may be without power to move the apparatus. In some embodiments, there may be a plurality of retractable wheels or tracks, so that it may be easier for the apparatus to navigate over obstructions during transport/movement of the apparatus. A retractable wheel is a known configuration on aircraft. The retractable wheel 132 may retract straight up, or it may pivot up and to the back of the conveyor 8, so that it may allow obstructions 123 to pass under the apparatus.

Continuing with FIG. 32, a radar system coupled to a microprocessor 11 is a common device in modern automobiles, often in the form of collision avoidance systems and/or active cruise control. A forward looking or backward looking electronic object-detection system/device 122, such as a radar, sonar, or optical system, may provide information to a microprocessor 11, where the microprocessor 11 uses information provided by the object-detection system 122 to raise or lower the height of each mechanical pick-up device 120. In some embodiments, the retractable devices that turn on an axle to provide motion 135 may be raised or lowered based on input/feedback from the object-detection system 122. In some embodiments, the nozzle 58 that is positioned to assist or replace the mechanical pick-up device 120 is also raised or lowered based on info provided by the radar/sonar object-detection system 122. This capability could, for example, allow the apparatus to avoid solid objects during the course of forward motion of the floatable-material receiver and surrounding apparatus. In some embodiments, the object-detection system 122 may be a sonar system, which may allow the use of the collision avoidance system underwater. Sound generally travels better in water than high frequency radio waves. In other embodiments, a laser-based optical sensing system may be used instead of sonar or radar. In some embodiments, each collision avoidance system could operate on a different frequency, to avoid interference from any other collision avoidance system on the apparatus and/or another nearby apparatus. The apparatus may have several collision avoidance system transponders located at various positions thereon (e.g., at regular intervals and/or at key positions).

In some embodiments, one or more cameras connected to a microprocessor 11 may be used to provide information so the microprocessor 11 may lift the mechanical pick-up device 120 over obstructions by an interpretation from the microprocessor 11 of the image provided by the cameras. In some embodiments, the camera system may use infrared such as a forward-looking infrared system (FLIR). The infrared system may further be configured to detect infrared signatures of pollutants and absorbent material, instead of or in addition to sensing the presence of obstacles such as rocks. In some embodiments, a Geiger counter or a device configured to receive and interpret particle radiation may be implemented. The object-detection system 122 may use passive energy such as daylight/radiation or may emit, e.g., active radar, sonar, or laser, with such emission of energy 121 reflecting back off of a given solid obstruction 123.

All of these devices are non-limiting examples of an electronic device that receives and interprets energy from an object. In some embodiments, the object-detection system 122 is mounted on a horizontal pole positioned between mechanical pick-up device 120, so that the object-detection system 122 is positioned slightly ahead of the mechanical pick-up device 120, as this may ensure a more accurate reflection without interference. An electronic device that receives and interprets energy from an object may have a transmitter as well as a receiver to transmit a signal, for example, in the form of sonar, radar, or laser, and also receive such a signal. This object-detection system 122 could, of course, be designed to emit/receive more than one such signal type.

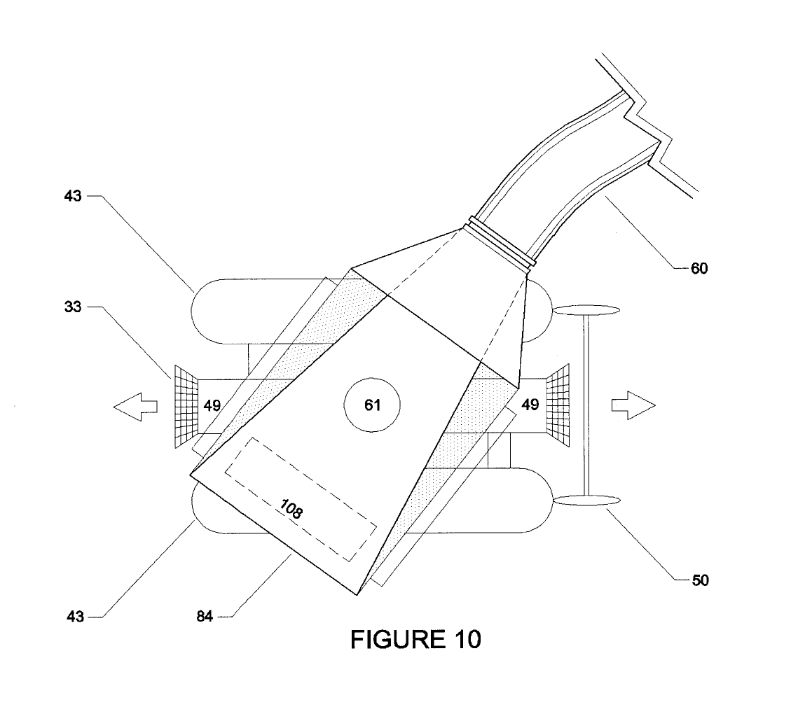

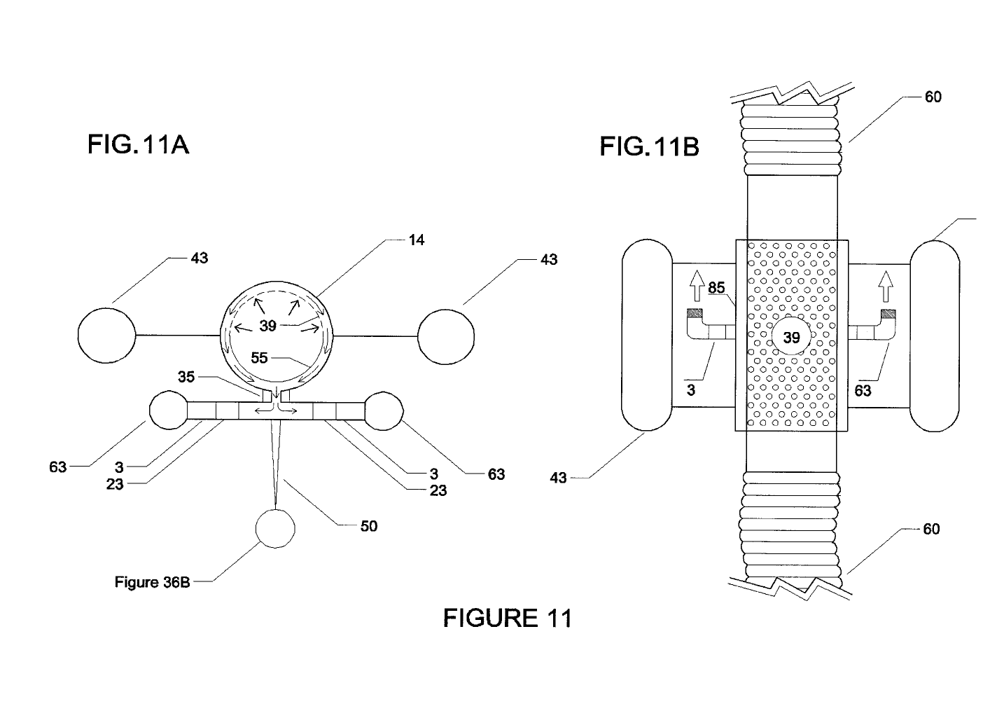

The object-detection system 122 may control the height of at least one nozzle 58 that is positioned in the flow of the floatable material, as depicted in FIG. 32B. The microprocessor 11 may use information provided from the object-detection system 122 that receives and interprets energy to control the propulsion and direction of the floatable-material receiver, the beach cleaner 7, the amphibious vehicles 5, the vessel 68, and/or the directional propulsion thruster of FIG. 11. The microprocessor 11 in general terms can be used to control any or all of the movement of the floatable-material harvester.

In some embodiments, a rope culture system may be suspended in the ocean to allow seaweed to be cultivated in deep water. In some embodiments, the rope may be replaced or supplemented with a solid structure. The conveyor apparatus and transport hose 60 may need to be suspended above the rope or structure, so that the tines do not become tangled. The object-detection system 122 may, in some instances, have difficulty seeing/sensing the rope or structure, and therefore a material that allows better sight may be imbedded in the rope or structure. Such material may be comprised of upward-pointing, right-angled elements, to provide better reflection of sonar and radar. Other energy reflecting shapes may be used as well. Such material may be metal, ceramic, or any material known to be reflective of energy. Alternatively, light reflective material on the rope system or structure may be used with a lighting and camera system. Alternatively again, radioactive isotopes may be imbedded in the rope or structure. In some embodiments, transponders or energy emitting electronic devices may be attached to the rope. In some embodiments, a laser device may send and receive energy reflected from tiny mirrors imbedded in the rope or structure.

In some embodiments, a plurality of object-detection systems 122 are positioned along the transport hose 60. These devices may communicate information to the microprocessor 11, which may control propulsion thrusters along the transport hose. These thrusters are described within this document in several embodiments from fluid released from the transport hose 60, high pressure hose 28, or conventional bow thrusters which may operate electrically. As well, the microprocessor 11 may control valves that are fluidly connected to a pump. Nozzles pointed upwards, downwards, forward, reverse, and at angles may provide propulsion in a desired direction to steady and/or propel the mechanical pick-up device 120 and/or the conveyor apparatus. The microprocessor 11 may make these decisions, e.g., based on information received from one or more object-detection systems 122.

An AUV is an acronym for an Autonomous Underwater Vehicle and is well known in the art. AUV's are generally powered by an electric power plant, but may use other forms of energy as propulsion including diesel, gas, nuclear, or solar. In some embodiments, the AUV is comprised of cutting blades. In the same embodiment, the AUV may operate near the bottom of the body of water, severing macro algae growing on the bottom. This may cause the algae to float to the surface of the body of water, where the algae may be harvested by the floatable-material harvester. For efficiency of the operation, several AUV's may be deployed simultaneously. In some embodiments, the underwater vehicle may have an operator. In some embodiments, the AUV is instead controlled remotely. In some embodiments, an AUV may be configured to deploy seaweed spores/seedlings/cuttings along a rope, structure, or bottom of a body of water.

Returning to FIG. 1, this arrangement allows the seaweed to flow from the reducing/channelled conveyor 46 into a trommel washer 64, where an appropriate amount of water flows through flow valve 69 and flow meter 23 and then into the trommel washer 64. A device that dissipates or reduces the water pressure to the trommel washer may be used. The amount of water is adjusted in each case to have an efficient means of returning sand to the beach and not so much water as to cause beach erosion. Water and sand dissipate back onto the beach with an elongated water displacement apparatus 20. In some embodiments, the elongated water displacement apparatus 20 may be a series of pipes angled to distribute the water evenly back on the beach. In other embodiments, the elongated water displacement apparatus 20 may be a flat board with a number of vertical dividers, to distribute water and sand evenly to the beach. In some embodiments, the water displacement apparatus may be replaced or supplemented by an oscillating water cannon that projects the water upwards in an oscillating pattern.

High pressure water pump 29 draws water from the ocean or body of water and pressurizes high pressure water tank 30, then the water flows into high pressure hose 28 through spool 57. The high pressure hose may be pressurized to several thousand psi, as to provide a long hydraulic parallel to the transport hose 60, which may be an efficient means of transferring energy into a system. In some embodiments, the speed of the high pressure pump 29 may be controlled by pulsation or a wave of energy. In other embodiments, the high pressure pump 29 may be controlled by bursts of energy. The energy may be electrical, combustion, mechanical, chemical, or the expansion of a fluid such as steam into a turbine. In a variation of the fluid compression system, high pressure water pump 29 is replaced or supplemented by air compressor and motor, and the high pressure water tank 30 is replaced or supplemented by high pressure air tank.

Returning to FIG. 1, the washed seaweed flows from the trommel washer 64 to vegetation shredder 67 via a slopped angle of the trommel washer 64. In some embodiments, the vegetation shredder 67 may be a wood chipper or another cutting, grinding, or size-reduction mechanism. In other embodiments the vegetation shredder 67 may be a leaf shredder. The vegetation shredder 67 feeds the flow of seaweed into transport hose 60, where the seaweed is then sucked off by force of vacuum into transport hose 60 and/or forced by a positive fluid flow by an floatable-material thruster 62 or a spray nozzle 58 (not specifically shown in this context). In some embodiments, the speed of the vegetation shredder 67 and trommel washer 64 are controlled by a microprocessor 11. The seaweed passes by floatable-material thruster 62, where flow valve 69 provides a metered flow of high pressure water in the direction of the flow of seaweed. In some embodiments, pressure meter 44 and flow meter 23 relay information back to a central microprocessor 11, which controls the speed of water pump 72 and high pressure pump 29, as well as flow valves 69. Microprocessor 11 may also control the speed of reducing conveyor 46, elongated pick up 19, and the speed of vegetation shredder 67.

The implementation of a series of floatable-material thrusters 62 along the length of the transport hose 60 has a distinct advantages of transporting floatable material a greater overall distance and more efficiently than a single floatable-material thruster, with less wear on the transport hose 60, extending time between hose replacement. Wear may be especially excessive on the hose near the output of the floatable-material thruster 62. The release of high pressure fluid into a lower pressure environment may cause expansion and acceleration of the overall volume of the fluid or the space that it occupies, which in turn may cause acceleration of the material travelling through the hose and potential damage to that material.

The velocity of the material and wear of components due to frictional contact with that same material have a relationship that is often nearly exponential. That is, an increase in velocity has an often near exponential increase in wear due to friction and loss of energy as heat. Furthermore, hydraulics can offer an enormous transfer of energy that has the potential to cut through hose if that localized release of energy is too great, as well as damaging the product being transported thereby. Therefore, it is advantageous and more energy efficient to spread the overall release of energy over the entire distance of the transport hose 60, by using as many floatable-material thrusters 62 connected in series as possible and regulating the flow of fluid into each floatable-material thruster 62. Often the fluid is provided from a high pressure hose 28 that is deployed parallel to the transport hose 60. In some embodiments, the high pressure hose 28 may be flexible in composition and may float. It may be advantageous to use flexible hose to transport fluid through high pressure hose 28 to the floatable-material thruster 62, and as well the use of flexible hose for both the suction hose and the transport hose 60. In some embodiments, the transport hose 60 may be a rigid tube. In some embodiments, the high pressure hose 28 may be a rigid tube.

In one embodiment of the apparatus, the flexible hose is wound around the outer perimeter of the apparatus, so that the apparatus becomes, in essence, one very large spool. This allows for a gradual pending of the flexible hose, where the hose may be of a composition that makes it difficult to bend on a smaller conventional spool. Winding the hose on the outer perimeter also allows the vessel or apparatus to carry a relatively long length of hose and to deploy the apparatus rapidly without assembly.

Based on the pressure information from the pressure sensor 44, entrained air may be released out of the system through the mechanism of FIG. 11 and the escaping air used as a form of propulsion of the hose floating in the water, to move and/or straighten the hose apparatus against the current and waves. The beach cleaner 7 moves over seaweed windrow 53, while the amphibious vehicles 5 and ocean vessel 68 all move in relatively the same direction as a single apparatus. The beach cleaner may be a vehicle which is configured to pick up floatable material. As the tide comes in and out, amphibious vehicles 5 may use spinning deep groove wheels or other means of propulsion such as propellers while immersed in water. In some embodiments, the amphibious vehicle 5 may be an Argo. In some embodiments, the amphibious vehicle may have an inboard or outboard motor connected to a propeller. During times of lower tide, amphibious vehicles 5 may further be configured to keep the hose elevated above the ground, to prevent the hoses from dragging and snagging on rocks and sand. Additionally, those amphibious vehicles 5 that are out of the water may drive at the same speed and direction as the rest of the apparatus remaining in the water to reduce the opportunity, for example, kinking of the hoses and working loose of any of the various connections due to stresses created by mismatched travel speeds.

Undercarriage 100 suspends the hoses between each amphibious vehicle 5 and the beach cleaner 7. The undercarriage 100 may be comprised of many horizontally positioned solid plates overlapping one another, so that the undercarriage 100 is horizontally flexible. They may be referred to as horizontally flexible joints 152. As seaweed reaches the vessel through transport hose 60, the seaweed is deposited into the collection area 2 through the large cavities of centrifugal pump 72. The seaweed then flows perpendicular down draining conveyor belt 17, so that extra water in the system is removed efficiently. Most of the water passes through small holes in the back of the collection area 12, and the water is directed to pass through a directional propulsion thruster 101. Directing the water in such a fashion provides thrust for the vessel in any direction the operator chooses, while dissipating the immense energy of the vacuum system. In some embodiments, the collection area may be a large net that collects material and allows water to project into the air.

At a reasonable distance down the hose (e.g., nearing the end thereof), most or all of the entrained gas is evacuated through the series gun silencer system shown in FIG. 11. This may allow the use of a centrifugal water pump instead of a vacuum pump, which is more energy efficient. Additionally, the centrifugal pump may be able to hydraulically pull a significant vacuum compared to a vacuum possible using a pneumatic pump. Additionally, a pneumatic pump can lose a significant amount of energy as heat. (That said, in certain circumstances, there could be instances in which one could choose any of a variety of pumps (e.g., based on cost, availability, etc.), including a pneumatic or another type of vacuum pump, could be employed for the water pump, and such choices are considered to be with in the scope of the present system.) The centrifugal pump may contain a continuous air bleed as well, to ensure complete or ideal evacuation of the air in the system and minimize cavitation. The floatable material is drawn through and expelled through the impeller of the pump, thereby allowing for continuous operation. A pump may also provide fluid by continuous flow or by bursts or pulsations of energy.

Sorbents or absorbent material are insoluble materials or mixtures of materials used for the recovery of a fluid. In broadest terms, the sorbent or absorbent material needs to have an attraction for the fluid that is being used to recover and should have the ability to float on or near the surface of the body of water upon which it is employed. To be particularly useful in combatting petroleum and solvent spills, sorbents should, to at least some degree, be both oleophilic (oil attracting) and hydrophobic (water repelling). Suitable materials can be divided into three basic categories: natural organic, natural inorganic, and synthetic. Natural organics include peat moss, straw, hay, sawdust, and feathers. Natural inorganics include clay, perlite, vermiculite, glass wool, zeolite, and sand. Synthetics include plastics such as polyurethane, polyethylene, and polypropylene. For the purpose of this invention, the terms sorbent and absorbent material are used interchangeably.

Clay, perlite, zeolite, and vermiculite are also used to absorb radioactive material and heavy metals. They have the disadvantage of sometimes releasing the absorbed radioactive material if they are exposed to water. Nanofibres on the other hand have the benefit of permanently absorbing radiation and radioactive material such as heavy metals (e.g. cesium and cadmium), which may make their use in and near water ideal. In some embodiments, the nanofibres may be made from sodium titanate. In other embodiments, other titanate salts may be used. Radioactive iodine is also effectively absorbed by nanofibres. For the purpose of the invention, nanofibres may be mixed with and/or comprised of floatable material, pelletized, cubed, shredded, comprise of loops, or provided in such a manner that the nanofibre is easy to collect by the apparatus, where the absorbent material is composed or configured in such a manner that a tine can pick up the material easily.

In reference to FIG. 1, a method of cleaning chemical spills/radioactive material is accomplished by using sorbent or absorbent material that is laid down on the beach or in the adjoining body of water, in the same manner the seaweed windrow 53 is depicted. The apparatus that lays down the material may be comprised of a vessel with a storage area full of absorbent material, where the sorbent material is conveyed into a floatable-material receiver and through a transport hose, where the transport hose is connected to at least on floatable-material thruster connected to a high pressure pump, where a small vessel may control the direction of the output of the hose, so that absorbent material is spread evenly along the beach and adjacent body of water. The apparatus of FIG. 1 then operates in the same manner as it would harvesting seaweed, although the trommel washer 64, water displacement apparatus 20 and vegetation 67 may be omitted. The use of the device in organic solvent, petroleum, and other organic chemicals may require a process involving the disposal of the material.

As seaweed is a sensitive and live organic that needs to be preserved, seaweed requires a chemical and physical treatment to ensure its preservation, often so that the seaweed has time to reach a drying facility. However, the pick up of waste solvents presents another process distinct from the processing of seaweed or radioactive material, where there is a desire, if at all possible, to simply combust the product to ensure its immediate disposal and to reduce or possibly eliminate the amount that might otherwise need to be land-filled or stored. Furthermore, some of the collected pollutant (e.g. petroleum, crude oil) may be recycled by pressing the absorbent material, centrifuging the material, or otherwise mechanically separating the pollutant from the absorbent material. The apparatus can serve as an ideal location to process the waste absorbent material since nominally little or no additional time or effort is used to dispose of the contamination. Further, the waste energy generated by combusting the waste material instead could be used directly to power the vessel or apparatus or otherwise stored or delivered to a local energy grid (depending, in part, on the amount of energy generated). Also it presents the safety of having contained the spreading of a fire, which is a concern when performing the combustion task within a body of water.

In the method, the absorbent material is ideally, although not necessarily, combustible as well, so materials such as wood chips or straw becomes more suitable for absorbing petroleum. The wet organic solvent and absorbent material is metered under the rate of feed decided by the central microprocessor 11 into an incinerator of sufficient size as to incinerate at a rate that is consistent with the rate of feed. This may in fact be a very large incinerator. The incinerator may have all of the emission controls that are relevant and known to the prior art, including but not limited to catalytic conversion, air intakes, sensors to monitor plume gas concentrations, and temperature control. In some embodiments, the collected floatable material is metered into the incinerator by an operator. In some embodiments, the collected organic material is metered into the incinerator by a variable speed controller and a conveyor.

The incinerator produces a great deal of waste heat, which also produces steam from the wet organic material. Water from the body of water may be added to the exhaust of the incinerator to create more steam, or a heat exchanger may be used in some embodiments. The steam can be used to power a turbine or any similar device that converts steam into mechanical energy. The mechanical energy can used to power the apparatus through direct drive of the hydraulic or vacuum pumps and/or to turn generators for electrical power, electrical power which could be used onsite or delivered to a power grid. Organic material for the purpose of this document may include material which is inorganic or synthetic that has absorbed organic material, since the chemical it absorbs is sometimes organic in nature.

During the vacuuming process, there may be times oil may separate back into the body of water. It is, of course, desirable to separate the oil and water and to not allow petroleum or solvent to return to the body of water from which it was drawn. This may be done by passing the fluid draining as part of the vacuum process through more wood chips or other sorbent material. If need be, the oil may be separated by allowing it to float on the surface of the water and skimming the oil from the water. All that said, the present process is designed to limit the amount of oil or other solvents that might return to the water, given the capabilities of the sorbents being employed. Such additional processing steps are provided simply to increase the percentage of oil/solvent that is to be captured. The use of nanofibres in the cleanup of radioactive material has the benefit of retaining the material and radiation, so that the radioactive material/isotopes has the benefit of not separating back into water. Zeolite is also a useful material for absorbing and purifying both salt and fresh water from radiation and other chemicals.

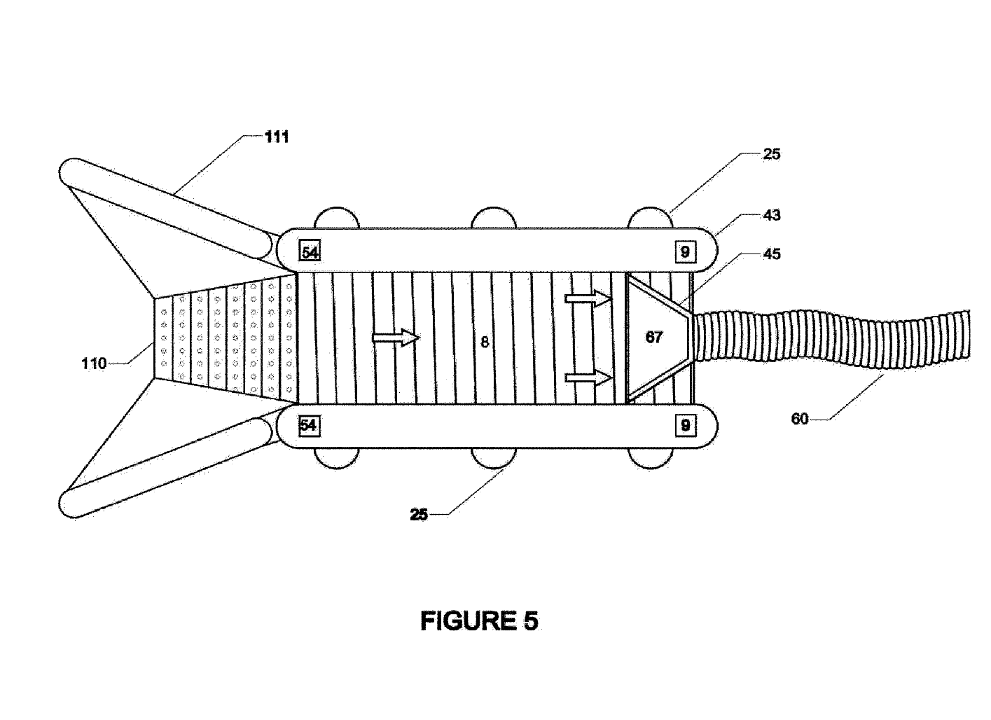

FIG. 2 illustrates an additional benefit can be gained by staging or increasing the inside diameter of the suction and high pressure hose between the floatable-material thrusters 62 and the water tight connectors 4. Staging the hose allows volume compensation for the displacement of the fluid from the high pressure pump 29 as the volume of fluid flows to the vacuum source 66 or centrifugal pump 72. This will minimize compression of entrained gases in the transport hose 60 and will have a tendency to minimize the acceleration of the material flow, which would both cause loss of energy as heat. It also has the benefit of operating a smaller diameter hose near the beach and workers, which is easier to move. Also, more hose will fit on a spool overall. The staging configuration may allow the component shown in FIG. 11 to be omitted from the apparatus. In reference to FIG. 2, both the high pressure hose 28 and transport hose 60 are shown with decreasing interior diameter as they become closer to the floating conveyor belt apparatus, as depicted in FIG. 5.

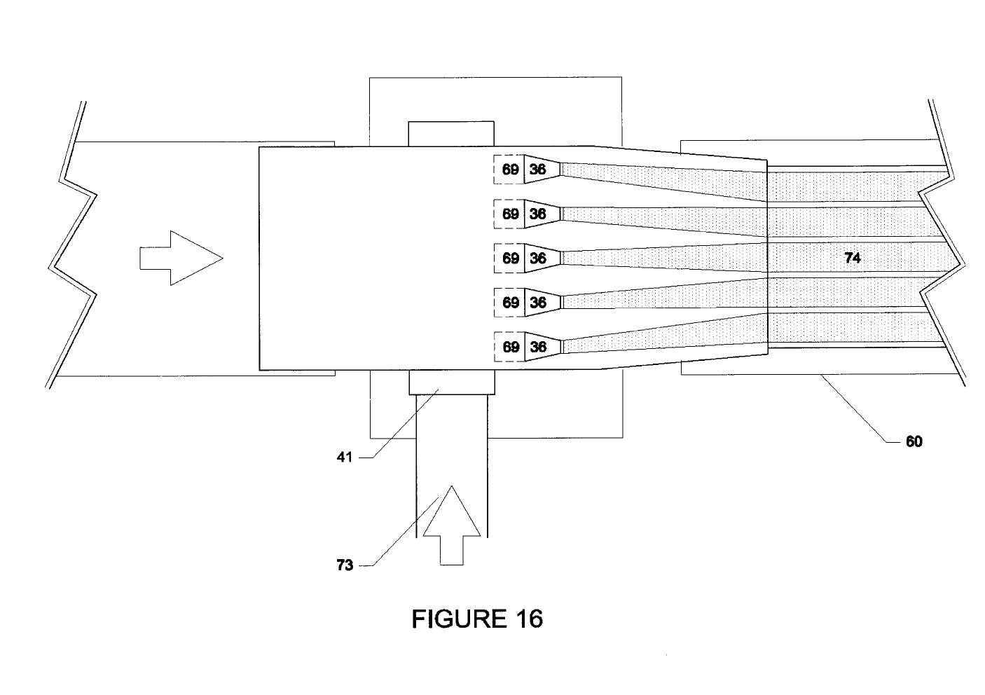

FIG. 2 is of an embodiment of a completely deployed floatable-material harvester apparatus, where the floating conveyor belt apparatus of FIG. 5 is feeding floatable material in a forward motion towards the vacuum source, as the floatable material is provided by workers surrounding the deployed seaweed harvest apparatus. In one embodiment, small conveyor 110, a mechanical pick-up device, is lowered into the water at an appropriate angle by a locking swivel joint and floating funnelling element 111 assists in providing greater capture of detached seaweed/floatable material in the surf, directing the seaweed to the small conveyor 110, which is a mechanical pick-up device. Small conveyor 110 unloads its contents by the forward motion generated thereby onto a horizontal conveyor belt 8, which is a feeder mechanism that provides floatable material to the transport hose 60. The vacuum is provided by vacuum unit 66, and water is drawn through a filter to the high pressure water pump 29, which pressurizes the high pressure water tank 30 with water, and water flows down the high pressure hose 28 on spool 57. Subsequently, the water flows down high pressure hose 28 to a set of parallel flow meters 23, and then the metered water flows through parallel flow valves 69 and into the fluid input of floatable-material thrusters 62 of either FIGS. 16,17,18,19. Seaweed flows from the moving belt conveyor 8 and is directed by funnelling element 45 into the front of the transport hose 60, where the force of the vacuum carries the floatable material down the transport hose. As depicted in FIG. 31, entry of floatable material into the transport hose 60 may be assisted by a spray nozzle 58 which provides pressurized fluid in the direction of flow of the floatable material.

FIG. 2 also depicts a number of cavitation detectors 400. Cavitation is the formation of vapour cavities in a liquid, which usually occurs when a liquid is subjected to rapid changes of pressure that cause the formation of cavities or pockets where the pressure is relatively low. Cavitation may be a seriously detrimental problem around the output of a floatable-material thruster and/or the floatable material thruster 62, where cavitation may cause damage to the transport hose 60 and/or the floatable-material thruster. Therefore, a cavitation detector 400 may be positioned at the output of nozzles and/or the floatable-material thruster 62 itself, or be otherwise structurally associated with a floatable-material thruster 62.

The cavitation detector 400 may transmit such information to microprocessor 11, so that the flow of water through the floatable-material thruster may be reduced by controlling flow valve 69 or the speed/thrust of the high pressure pump 29. A cavitation detector 400 may be positioned anywhere along the transport hose 60. A cavitation detector 400 may be passive or active. A cavitation detector may signal an indicator light, so that an operator may vary the speed or thrust of the pump, or adjust the flow of a valve to lessen or correct the cavitation. A cavitation detector 400 may be a hydrophone (or another device capable of receiving acoustics) configured to receive the harmonics of a cavitation, which identifies cavitation events by sensing acoustic emissions generated by the collapse of bubbles. A cavitation detector may be an electronic camera that visually detects a cavitation from a nozzle 58. A pressure sensor or a high speed pressure transducer may also be used to detect a cavitation. An accelerometer may be used to detect a cavitation. Vibration monitoring may detect a cavitation. Using electrodes as known in the prior art may detect a cavitation. The pressure sensor 44 may also be configured to detect a cavitation.

The seaweed flows through the center of floatable-material thrusters 62 or conventional air conveyors, where additional forward moving energy is released into the system by expansion of high pressure fluid. That additional forward moving energy pushes the material in the direction of flow at a higher velocity and minimizes the resistance on vacuum unit 66, where the effect may allow vacuum unit 66 to run at higher velocity. This high velocity is achieved through, e.g., a higher gear ratio from motor-to-fan and/or a larger fan size-to-motor size ratio. Microprocessor control 11 (not shown in this context) receives flow and pressure information from ultrasonic/radio 2-way transmitter 65, calculates ideal conditions from a set table, and relays commands back to flow valves 69, vacuum unit 66, high pressure water pump 29, and the belt conveyor 8, and buoyancy control through bilge pumps 9 located on the floating conveyor belt apparatus of FIG. 5. In some embodiments, the entire transport hose 60 may be comprised of buoyancy control, so that the entire apparatus may lower itself into the water in which it floats. This may assist in the hose wrapping itself around the entire perimeter of vessel 68.

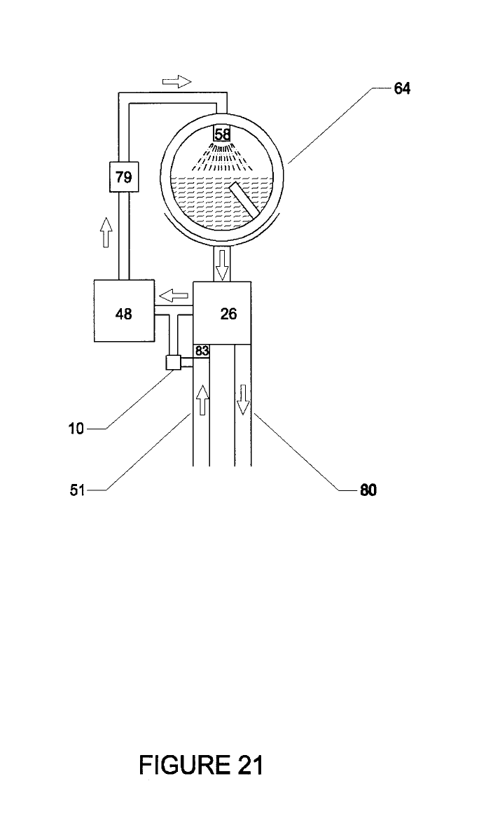

When seaweed and water fills the collection area 12 of vacuum unit 66, the vacuum unit shuts off, and the collection area 12 is opened. The floatable material is dumped into dump box 18, which is equipped with adequate draining, where seaweed is then metered into trommel washer 64 by a conveyor belt 8. The trommel washer 64 is equipped with a refrigeration unit 48 and sterilizer injector 79, as depicted in FIG. 21. The refrigeration unit 48 cools the wash water to −2 C or any other temperature found to be ideal for preservation. The sterilizer injector 79 provides ozone, bromine, chlorine, or any other suitable sterilizer to clean the seaweed and kill bacteria and fungi. Ozone has the benefit of being generated from ambient oxygen and the additional benefit of decomposing rapidly to oxygen after sterilizing, which further oxygenates the seaweed and prolongs preservation. The use of ozone also negates the need for storage of a chemical, and is very cost effective, requiring only electricity. Collection area 12 is again sealed, and vacuum unit 66 is turned on again to resume operations. This is a common cyclic operation of a conventional Hydrovac unit. The seaweed is then metered by a belt conveyor 8 into refrigerated storage container 31, where the container 31 may be craned to a different vessel, once filled, and an empty container moved into its place. In some embodiments, the storage container 31 has a ventilation system which removes gases of decomposition from the seaweed such as carbon dioxide, while providing outside air and oxygen. The ventilation system may use fans and ducting to circulate outside air. In some embodiments, the storage container 31 may have a perforated floor to allow a relatively even flow of gases through the seaweed. In some embodiments, the ventilation system may circulate air cooled by a refrigeration unit. In some embodiments, low level ozone may be circulated through the container to further minimize the growth of bacteria/fungi during transport.

Transport hose spool 56 was bypassed after deployment of the hose, so that transport hose 60 could guide the floatable material directly into the collection area 12 as straight as possible. Such a substantially straight alignment limits the centripetal force and resistance that would have occurred by having such a large mass coil around at a high speed inside the spool, which may cause energy loss and add resistance to the system. Also, the propulsion thrusters 63 of FIG. 11 provides exit gas which can resist currents and waves to keep the hose apparatus as straight as possible during operation. The mechanism of FIG. 11 is later described in detail.

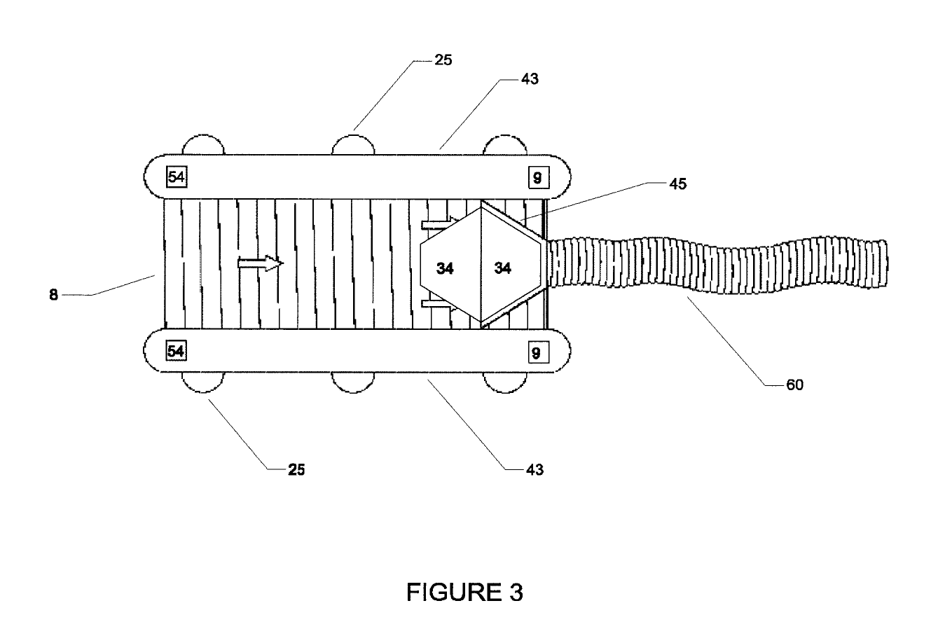

FIG. 3,4,5,6 illustrate a floating belt conveyor 8 based apparatus that works on both the beach and in the surf. The motor speed of the belt conveyor 8 is controlled by central microprocessor control 11 and speed information is transmitted by ultrasonic/radio 2-way transmitter 65. The conveyor belt 8 is a feeder mechanism that provides floatable material to the transport hose 60. The microprocessor 11 is not shown. Anchors 6 can be used for stability. The unit floats or rests on pontoons 43, where the bottom of the pontoons and vessel may be flat for lower footprint on the beach. Unit may be lowered or raised by positive or negative buoyancy through reversible bilge pumps 9 and snorkels 54 by pumping water or air into the hollow portion of floatation device 43. The conveyor moves in a forward motion towards funnelling element 45 and into removable vegetation shredder 67, where contents of the belt conveyor 8 are pushed into the mouth of removable vegetation shredder 67 and then into transport hose 60. The vegetation shredder is also a feeder mechanism that provides floatable material to the transport hose 60. The vegetation shredder 67 may be omitted and the conveyor belt 8 may act as the feeder mechanism that provides material to the funnelling element 45.

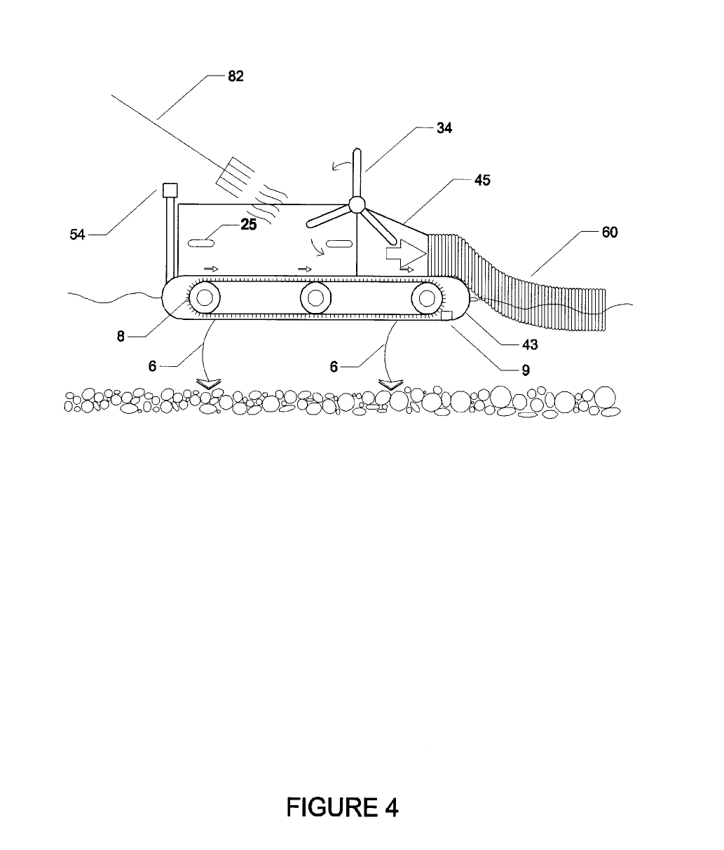

FIG. 3 and FIG. 4 show a variation of the conveyor where a motorized paddle wheel 34 spins in a forward motion pushing the floatable material into the hose in conjunction with the conveyor belt 8 and with no vegetation shredder 67 being used. In some embodiments, the speed of motorized paddle wheel 34 is controlled by a microprocessor, which may be microprocessor 11. In some embodiments, the paddle wheel may be a feeder mechanism that provides floatable material to the transport hose 60. The paddle wheel may be powered by air, steam, electricity, petrol or biodiesel engine. Negative buoyancy is achieved by flooding the air compartment/conduit of the pontoons 43 with water through the reversible bilge pumps 9, where air is either drawn from or evacuated through snorkel 54. Stability of the apparatus is achieved through automatically deployed anchors 6. Handles 25 can be used by the operators and workers to move the apparatus. In some embodiments, the apparatus has a propulsion system. The propulsion system 49, the reversible bilge pumps 9, and the automatic anchoring system 6 may be controlled by microprocessor 11.

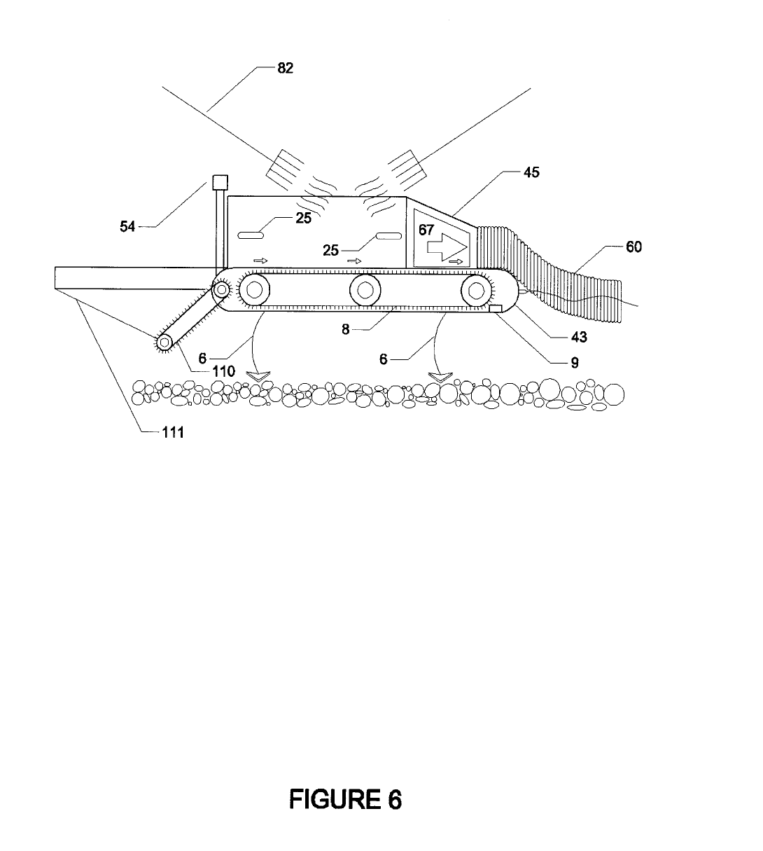

FIG. 5 and FIG. 6 depict a variation of the conveyor belt apparatus where a removable vegetation shredder 67 is inserted inside funnelling element 45 so that larger algae such as kelp may be processed through the machine. Also depicted is a smaller conveyor belt 110, which is submerged into the body of water on which the floatable-material receiver floats. In some embodiments, the smaller conveyor belt 110 may have a locking swivel joint, which allows it to be moved to a vertical position for transport or adjusted to the depth of the water. In some embodiments, the smaller conveyor belt 110 may have spikes or tines designed to pick up seaweed or floatable material out of the water easier and transfer the material onto conveyor belt 8. Also available is a floating funnelling element 111, the top of which is comprised of two flotation devices, and where the walls are angled to connect directly to the side of the smaller conveyor belt 110. In some embodiments, the floatable-material receiver has propulsion and steering. In some embodiments, the propulsion and steering are controlled by microprocessor 11. In some embodiments, the floatable-material receiver and conveyor belts have means of draining water, such as by the use of a mesh belt, so that only solid material is left on the conveyor belt.

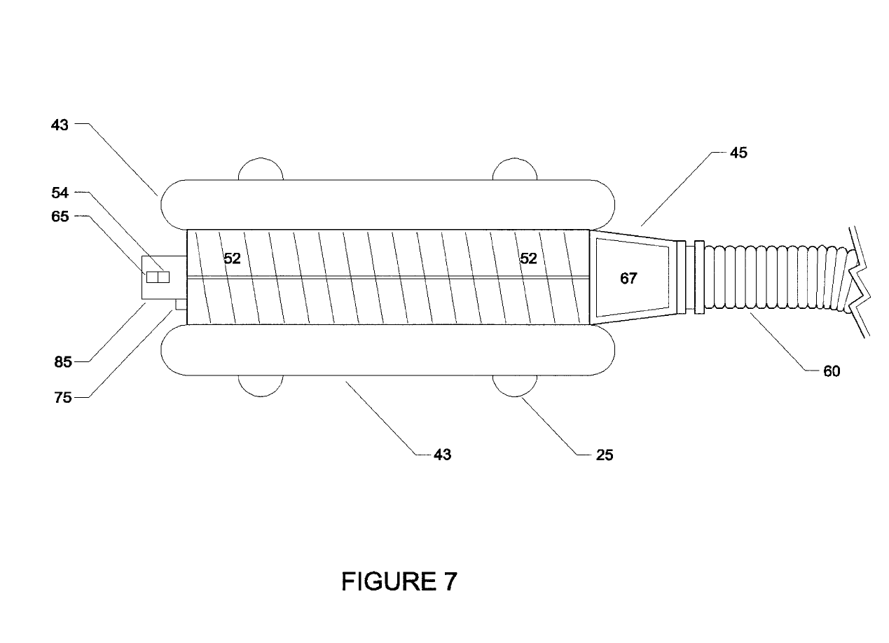

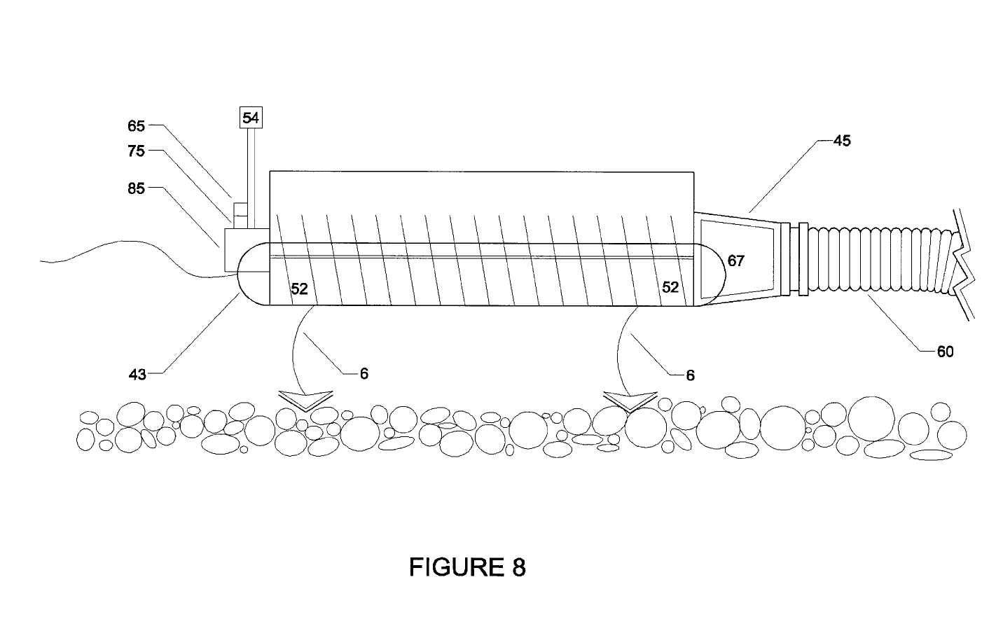

FIG. 7 and FIG. 8 illustrate a system that is comprised of and operates in the same manner as that shown in FIG. 3 and FIG. 4, with a variation and replacement of the belt conveyor 8, where a screw conveyor 52 is used in place of the belt conveyor to feed the seaweed into removable vegetation shredder 67, where the seaweed is then sucked into transport hose 60 by way of vacuum. Seaweed is deposited in the top of the apparatus by workers similar to the belt conveyor unit 8. Motor 85 turns the screw conveyor 52. The speed of the motor is controlled by variable speed controller 75, which in turn receives speed information from microprocessor 11 through the 2-way wireless transmitter 65. Snorkel 54 provides air for the internal combustion engine of motor 85.

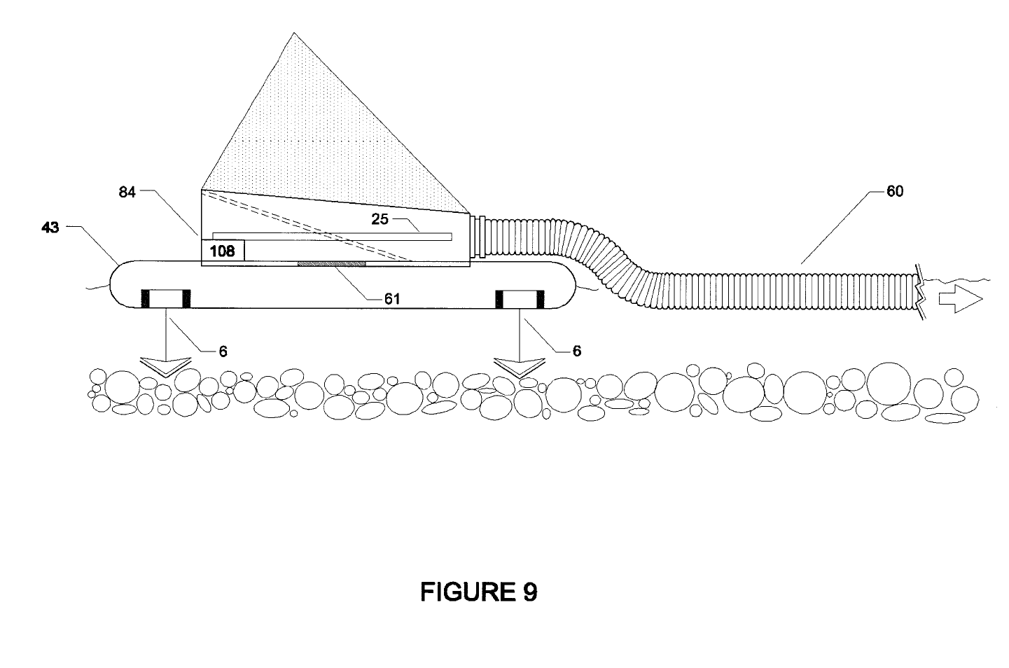

FIG. 9 and FIG. 10 depicts a floatable-material receiver comprised of a hopper 84, mounted to the same flotation device by swivel 61. The floatable-material receiver is detachable from the floatation apparatus. An anchoring system 6 is depicted holding the floatable material receiver in place in the surf. Rudders 50 provide steering of the unit in the surf while the reversible propulsion system 49 provides movement of the apparatus. An agitator 108 connected to the hopper 84 further assists the flow of seaweed/floatable material down the hopper and into the transport hose 60. In some embodiments, an agitator 108 is used to assist with the flow of seaweed into the mouth of the transport tube. The speed of agitator 108, the direction and speed of reversible propulsion system 49, and rudders 50 may be controlled by microprocessor 11.

FIG. 11B shows an overhead view of a gun silencer type apparatus that allows gas to exit from the transport hose 60 during transport of the floatable material through the apparatus of FIG. 11. FIG. 11A depicts a direct view of the same apparatus. The exiting gases can be further utilized as means of directed propulsion in the body of water in which the transport hose 60 floats. The apparatus uses the physical principal of a gun silencer to allow the escape of gas through the perforated opening 39. In some embodiments, the escape route is provided by the top half of the entire cylinder, while solid tube 55 comprises the other lower half of the cylinder in some embodiments. The function of the tube is to allow a tendency for air to escape above while water flowing through the system will have a tendency to pass through below due to water's mass and gravity. Pressurized air from transport hose 60 flows through perforated openings 39 and travels down between the outer cylinder 14 and the solid tube 55, the flow of such gas is regulated by air flow valves 3. The escaping gases flow down the center of motorized swivel 35 and to which gas flow is regulated by then flowing through flow meter 23, which in turn controls variable air flow valve 3 via central microprocessor 11. The air flow valves allow pressurized air to exit through propulsion thrusters 63, providing thrust in the direction the propulsion thruster 63 is facing. In some embodiments, the propulsion thruster 63 may rotate on a sealed swivel to provide upward and downward propulsion. Flow rate through variable air valves 3 are determined by a central microprocessor 11 (not shown in this context). The propulsion thrusters 63 may individually vary output by air flow control valves 3, as to assist in turning/aligning (as needed) with motorized swivel joint 35. Steering stability may be accomplished with rudder 50. In some embodiments, air flow control valves 3 and motorized swivel 35 are controlled by microprocessor 11. In some embodiments, pressure relief valves are used in place of air flow control valves 3. In some embodiments, the apparatus may discharge water instead of air. In some embodiments, a plurality of the apparatus of FIG. 11 along the length of the transport hose 60 or high pressure hose 28 may pulsate in a synchronized or consecutive manner, all controlled by the microprocessor 11. In some embodiments, a plurality of the apparatus depicted in FIG. 11 are located along the length of high pressure hose 28 and the apparatuses provides thrust directly from the fluid of the high pressure hose 28, as to operate in a similar manner to provide directed thrust.

An anemometer is a device used for measuring wind speed and is a common weather station instrument. An anemometer may also be coupled with a wind vane, and such a combination is often referred to as an aerovane. An aerovane may operate within a body of water with proper seals and protection from leakage. Anemometers may operate on the measurement of pressure and/or velocity of the surrounding air, and such detection apparatuses may employ wind-catching cups mounted about a pivot (likely most common anemometer), a windmill or propeller that may generate a pulse rate, a hot-wire system (relying on rate of heat transfer to determine wind speed), sonar (using two ultrasonic transducers to measure time of flight to determine air velocity), Doppler Laser (Using a transmitter and receiver to detect a Doppler shift based on air velocity), ping-pong ball tied to a string to measure velocity by lift, a flat plate that is moved by air velocity, and/or pressure-tube (using wind-generated pressure to determine air speed) arrangement. In some embodiments, an aerovane may operate on the apparatus to determine wind speed and direction.

For this invention, an anemometer analog with a vane configured to operate in water may be referred to as a hydrovane, given that such a device is structured and arranged to measure water speed and direction. This instrument named a hydrovane should not be confused with a hydrovane compressor, as it is rather the water measuring equivalent of an aerovane. In some embodiments, a hydrovane 401 may be encased in a filter shaped as a globe, so as to allow laminar water flow and minimize interference by solids in the water, by preventing the solids from contacting the hydrovane 401. In some embodiments, a hydrovane may also be configured to measure vertical angle of water flow, as well as horizontal direction of flow.

In some embodiments, hydrovanes 401 may be attached to a given transport hose 60, as depicted in FIG. 2. In some embodiments, the hydrovane may be connected directly to the fluid exit mechanism depicted in FIG. 11. Water current speed and direction information from the hydrovane 401 may be transmitted to the microprocessor 11. The microprocessor may then control the direction and thrust of the apparatus depicted in FIG. 11, to navigate ocean currents based on information received from at least one hydrovane 401 or apply an equal and opposite force to maintain the hose position. The apparatus of FIG. 11 may provide a direct counter-current, to maintain stability of the transport hose 60 in rough weather.

In some embodiments, a hydrovane 401 may be positioned in a vertical position to provide vertical water currents in addition to horizontal. The hydrovane 401 may be coupled directly to the flow valves 3, flow meters 23, and the motorized swivel 35, which are all depicted in FIG. 11. The hydrovane 401 may communicate to these components through a microprocessor 11, where a microprocessor may make more intelligent and precise decisions than a directly coupled actuator or analog circuit.

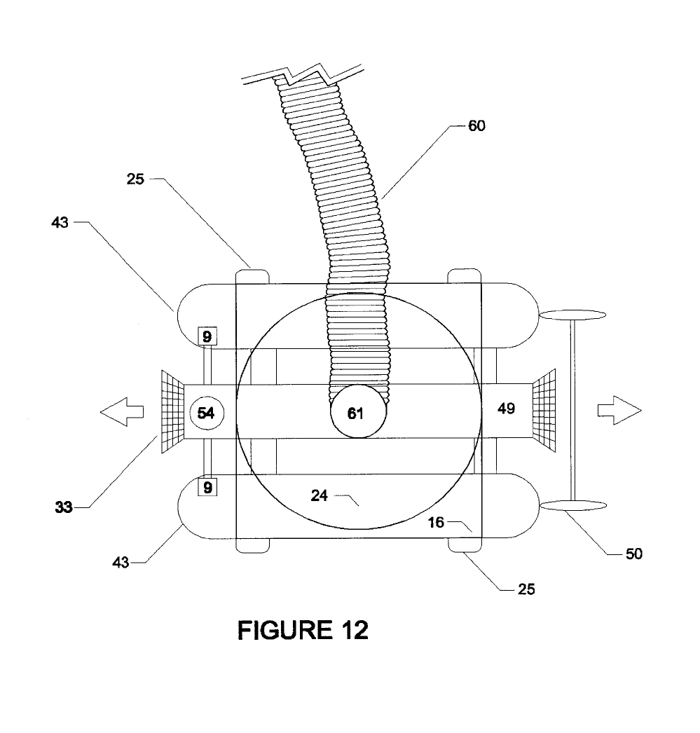

In some embodiments, the fluid escape mechanism (gas or water) of FIG. 11 may be replaced or supplemented with a propeller-based propulsion system, such as the reversible propulsion thruster 49 depicted in FIG. 12 or a conventional bow thruster, which is common on a boat. The propulsion thruster 49 may be connected to the motorized swivel 35 of FIG. 11, so that the swivel may turn the propulsion thruster 360 degrees or through another set range, as desired. Further, the propulsion thruster 49 may provide the same basic function as the apparatus of FIG. 11 from a different source of power, as well as being able to be controlled based on information provided by the hydrovane 401.

In related embodiments, the snorkel 54 and reversible bilge pumps 9 may be fluidly connected to the transport hose 60, so that the transport hose may be evacuated of water. The bilge pumps 9 may be fluidly connected to the bottom of the transport hose 60, so that they may pump out water from the transport hose while the snorkel provides a flow of air. Coupled to microprocessor 11, the transport hose may have buoyancy control, which can be controlled by the microprocessor. The floatation devices 43 of FIG. 11 may also have buoyancy controlled in a similar manner.

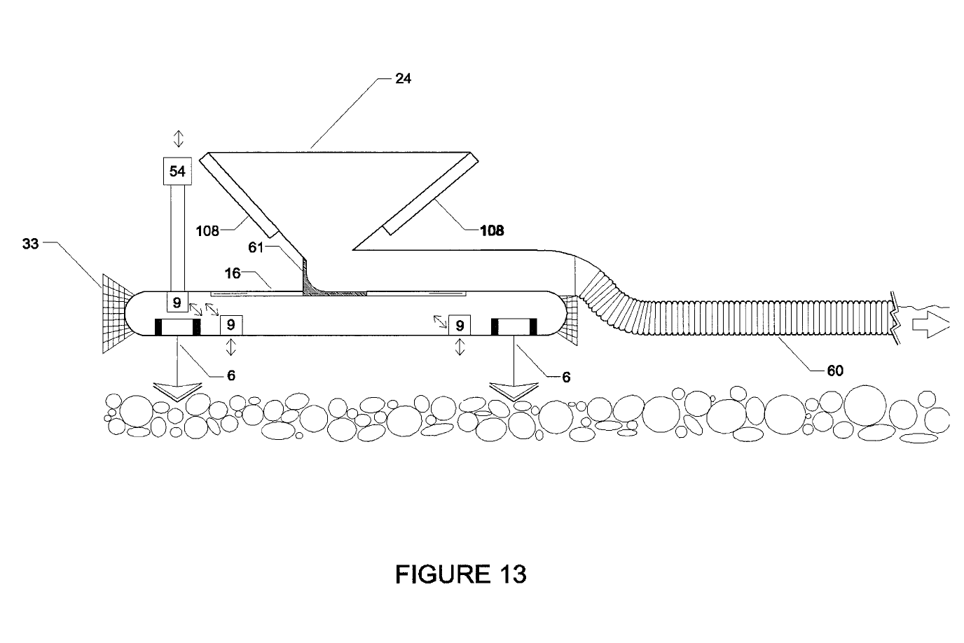

FIG. 12 and FIG. 13 are overhead and side views respectively of a floating funnel craft, where funnel 24 is a large enough funnel to allow surrounding personnel to deposit seaweed into the funnel from all sides of the craft, by use of hand tool such as a pitchfork. The base of the funnel has a gradual 90 degree bend to point horizontal, and is then connected to transport hose 60, which is commonly in the range of 7 to 9 inches in diameter and sometimes several hundred feet in length. Agitator 108 vibrates the funnel to assist with the movement and flow of seaweed into the center. Below the 90 degree bend in the illustrated embodiment is a 360 degree swivel joint 61, which connects to a detachable plate 16, so that the funnel, hose, and plate can be removed from the water craft and placed on a solid surface such as sand or rock.

Handles 25 are located in all four corners of the detachable plate allow ease of movement by personnel. The watercraft is stabilized by two pontoons 43, where the reversible propulsion system 49 is located in the center of the craft, between and parallel to the two pontoons 43. Steering of the vessel is performed with a rudder system 50. Mesh filters 33 may be placed over the intake and exhaust of the propulsion systems to keep windrow and loose seaweed and floatable material out of the propulsion system. Outside of the perimeter of the funnel is a snorkel 54, which connects by tubing to bilge pumps 9 which have the ability to pump air or water in either direction of flow into the air cavities of pontoons 43, thereby raising or lowering the apparatus in the surf. Additional bilge pumps 9 are connected to the bottom outside of the craft and to the inside of the pontoons, so that water or air can be pumped in either direction. An automatic anchoring system 6 may also be deployed to help stabilize the floating funnel in the surf. In some embodiments, bilge pumps 9, anchoring system 6, rudders 50, propulsion system 49, and agitator 108 are controlled by microprocessor control 11.

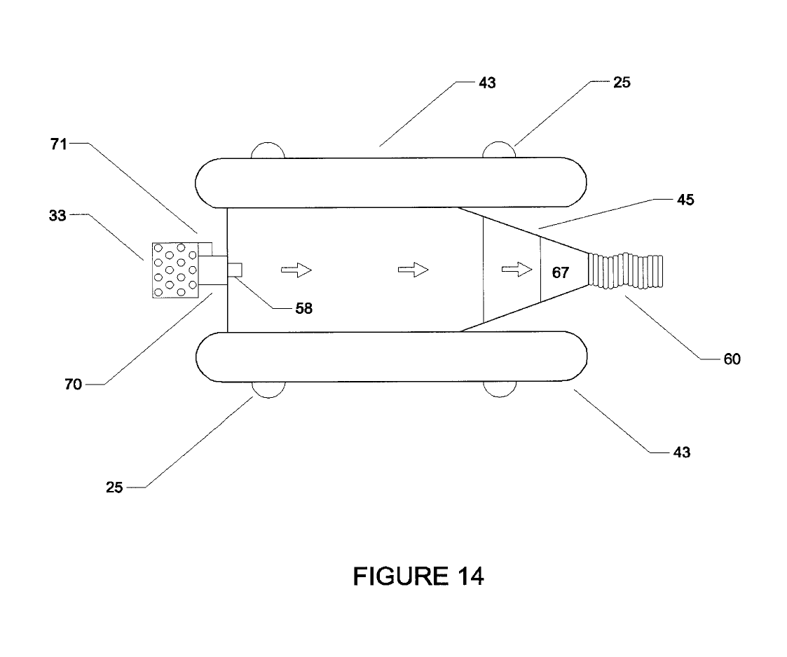

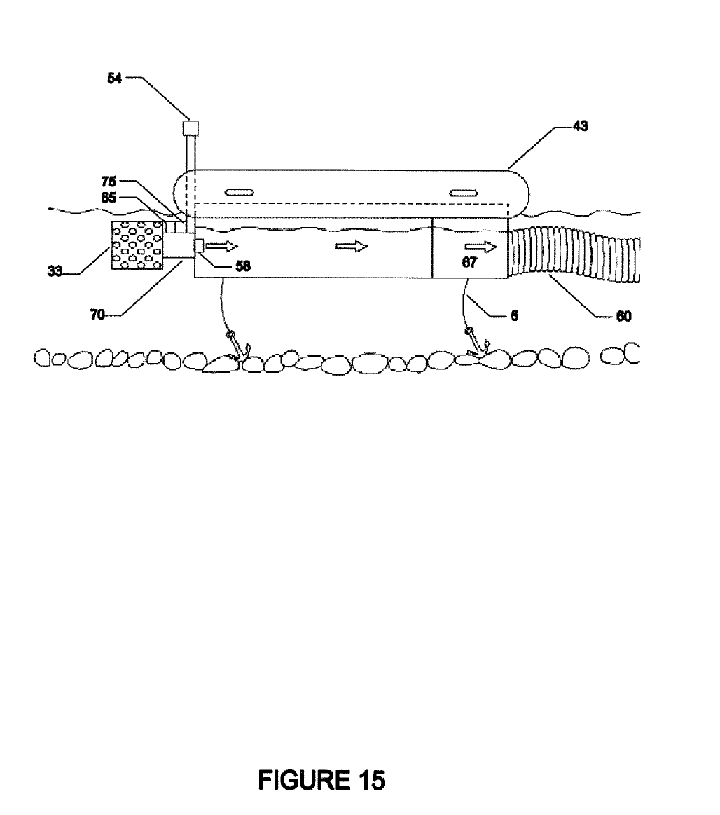

FIG. 14 & FIG. 15 show a floating water based system comprised of pontoons 43, where the floatable-material receiver sits below the water line. Water is drawn through filter screen 33 and through water pump and motor 70. If the motor 70 is an internal combustion engine, the air to be used for combustion is available through snorkel 54, but if it were instead to be an electric motor, no snorkel would be needed, of course. Variable speed controller 75 controls the speed of the water flow, which information is transmitted by, e.g., ultrasonic/radio 2-way transmitter 65 to central microprocessor control 11, which is not shown. In some embodiments, microprocessor 11 controls all motorized components of the apparatus. Automatic anchors 6 serve to hold the unit in place. The flow of water from the output of the water pump 70 is directed into a nozzle 58, which propels seaweed into the removable vegetation shredder 67 and into transport hose 60. The unit can be maneuvered by personnel with handles 25. In some embodiments, there is a manifold of nozzles that spray water parallel to one another, which allows for a wider floatable-material receiver. Funnelling element 45 directs the seaweed/floatable-material into the transport hose 60.

FIG. 16 represents a side view of a floatable-material thruster 62, which design is based on that of a conventional air (pneumatic) conveyor that has been modified to handle high pressure water/air. Flow of high pressure fluid 73 travels through a fluid input and into an outer plenum 41 and through variable flow valves 69, where the fluid passes through nozzles 36 and is injected into the transport hose 60 in the relative direction of floatable material flow through a fluid stream 74, thereby increasing the speed of and the distance the seaweed mass can travel. Every floatable-material thruster 62 may have a floatable-material input to which material enters the thruster and a floatable-material output to which product and fluid exit the thruster. The purpose of the variable flow valves 69 being positioned directly behind nozzles 36 is to ensure the majority of material erosion that will occur in the floatable-material thruster 62, which would be particularly rapid when using high pressure water, would occur mostly on the replaceable nozzles 36 themselves, as plenum 41 would remain pressurized and therefore may be inclined to wear due to a much lower fluid velocity inside the plenum 41. The floatable-material thruster 62 may be composed of aluminum, stainless steel, composite plastic, zinc, or any other suitable material that is sufficiently corrosion and wear resistant. The interior of the floatable-material thruster may have a smaller interior diameter than the connecting transport hose 60 to cause a Venturi effect on the intake.

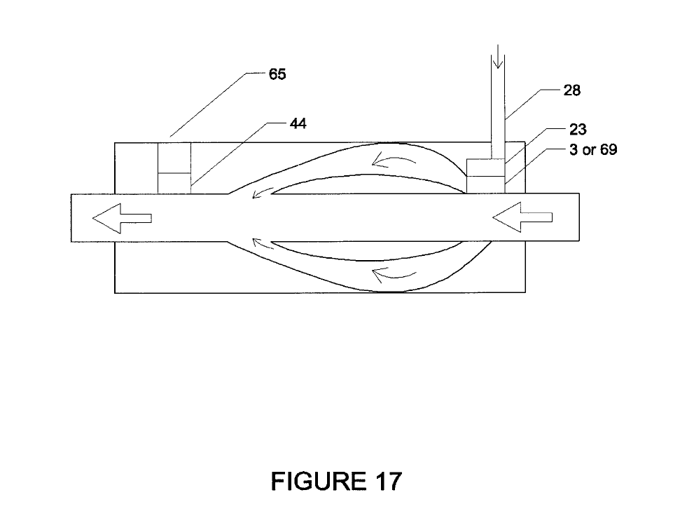

FIG. 17 shows a pear shaped floatable-material thruster 62, where either high pressure water or air flows down high pressure hose 28 and flow meter 23, then through air flow valve 3 or water flow valve 69 and through a fluid input. With this nozzle design, the fluid rapidly expands due to the decrease in pressure in the pear shaped nozzle, and the fluid is thrust into the transport hose 60 at an inward angle. Pressure sensor 44 transmits information through ultrasonic/radio 2-way transmitter 65 to central microprocessor 11 (not shown here).

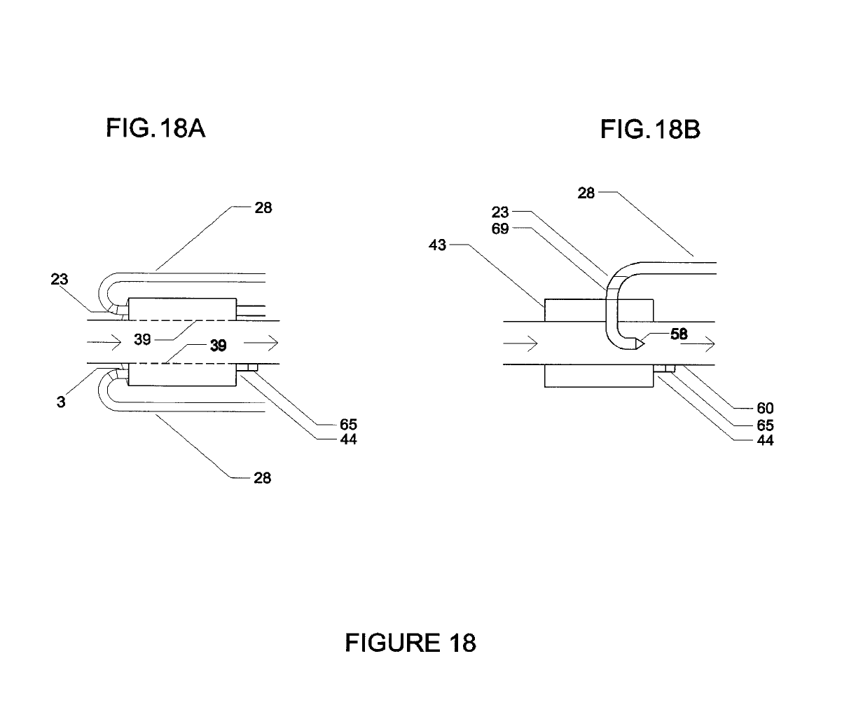

FIG. 18A is an embodiment of a floatable-material thruster that represents the reverse process of a firearm silencer. In this configuration, high pressure air or water enters through high pressure hose 28 and through flow meter 23, then through air flow valve 3 or water flow valve 69 and through a fluid input into the expansion chamber. The fluid then passes through perforated tube opening 39 and is injected into the transport hose 60. FIG. 18B is an embodiment of a central tube thruster, where high pressure water or air flows down high pressure hose 28 and through flow meter 23, and through water flow valve 69 or air flow valve 3, into a fluid input where the fluid passes through a 90 degree bend and is thrust into the center of the flow of seaweed by a spray nozzle 58. Pressure sensor 44 relays pressure and flow information through ultrasonic/radio 2-way transmitter 65 to central microprocessor 11, where the microprocessor 11 controls water flow valve 69 or air flow valve 3.

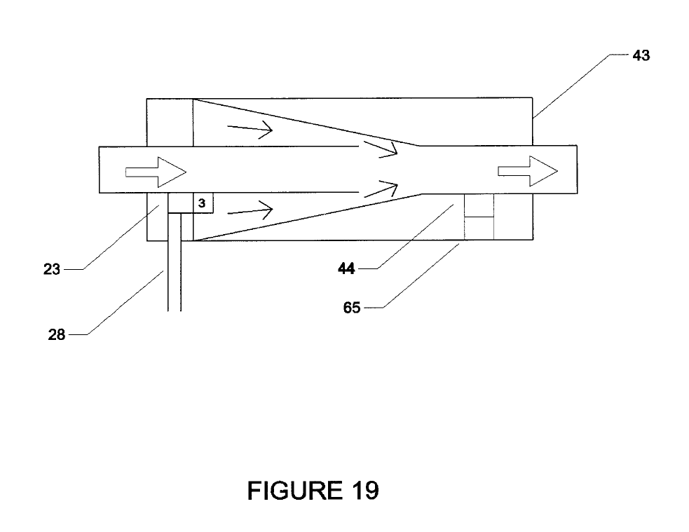

FIG. 19 is a depiction of a cone nozzle within the floatable-material thruster, where high pressure air or water travels down high pressure hose 28 and then through flow meter 23. The water then flows through water flow valve 69 or air flow valve 3, and through a fluid input into the thruster where the fluid rapidly expands due to decrease in pressure into the cone. The expanding fluid is thrust at an inward angle into the flow of the seaweed in transport hose 60. Pressure sensor 44 relays its information along with flow meter 23 to central microprocessor 11, where the microprocessor 11 in turn controls water flow valve 69 or air flow valve 3 through ultrasonic/radio 2-way transmitter 65.

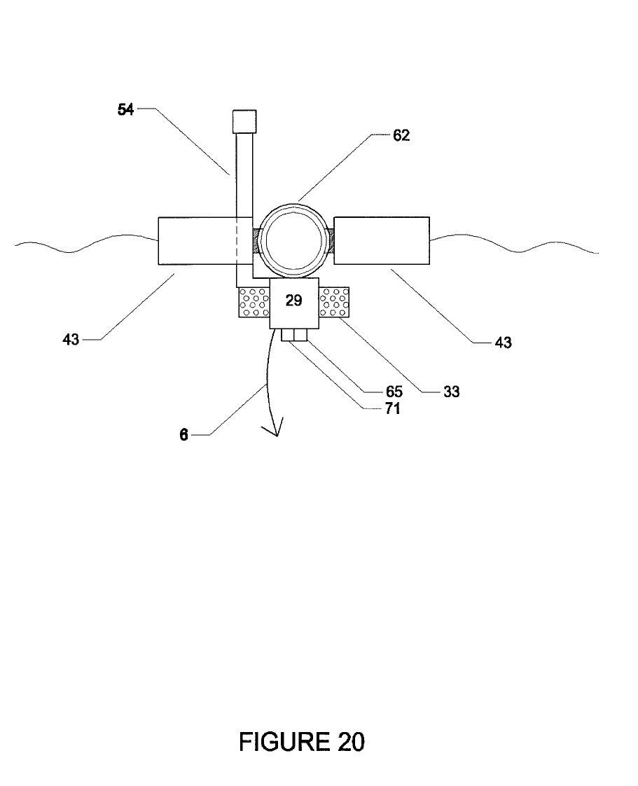

FIG. 20 is a direct view of a floating high pressure water thrust system that replaces the parallel high pressure hose 28, where water passes through filter screen 33 and through high pressure water pump 29. High pressure water pump 29 shown is driven by an internal combustion engine, so the system uses snorkel 54 to provide oxygen for the internal combustion engine, but if an electric motor were instead to be employed, no snorkel would be needed. Through use of the high pressure water pump 29, water is injected into the fluid input of floatable-material thrusters 62 depicted in FIGS. 16,17,18,19. Floatation devices 43 provide support, and automatic anchors 6 provide stability in rough water. In some embodiments, microprocessor 11 controls the speed of the high pressure water pump 29 by transmitting information through wireless transmitter 65 to water speed controller 71, which in turn controls the speed of high pressure water pump 29.

FIG. 21 is an illustration of trommel washer 64, where water is provided by an external pump to water inlet 51. The water then passes either through shut off valve 83 and heat exchanger 26, or through bypass valve 10 and into refrigeration unit 48 where the water's temperature is substantially lowered. Then the water passes through ozone, bromine, chlorine, or sterilizer injector 79 and into the trommel washer 64 through spray valve 58, where the wash water drains through the holes in the trommel and passes through heat exchanger 26, where the waste water returns out back to the body of water through water outlet 80.

FIG. 22 depicts one embodiment of the floatable-material harvester. In brief overview, the harvester includes a vacuum source 66 having an input, a transport hose 60, having an input at one end and an output connected to the vacuum source 66 input, and having at least one air inductor. The at least one air inductor/intake is comprised of a water tight joint 4, an air cavity 1, and a snorkel 54. The transport hose 60 is connected to a floatable-material receiver as shown in FIG. 4. An air inductor may be simply an opening 106 that allows air to enter along the length of the hose. A plurality of air inductors is desirable to keep the overall pressure of the transport hose from dropping too much through resistance, where maintaining an increase in air speed and the pressure from dropping too much allows material to be transferred longer distances in a smaller transport hose than a transport hose with only one or no air inductors.

In some embodiments, the vacuum source 66 is an air-impeller evacuated device, such as that commonly available under the tradename “Hydrovac”. In some embodiments, the vacuum source 66 includes a vacuum chamber evacuated by an air impeller (not shown). In some embodiments, the vacuum source is a large fan connected to a motor. In some embodiments, the vacuum source is a large fan connected to a turbine powered by steam. In some embodiments, the vacuum source 66 is a vacuum excavator system, which combines a Hydrovac vacuum device a high-pressure water pump connected to a high pressure hose and a wand that allows a worker to loosen substrates with the jet so that the Hydrovac vacuum can consume the resulting slurry. In some embodiments, the vacuum source 66 draws the contents of the transport hose into a collection area 12. The vacuum source 66 may be mounted on a transporter. The transporter may include a watercraft. In some embodiments, the watercraft is a boat. In other embodiments, the watercraft is a barge. In still other embodiments, the watercraft is a raft. The watercraft may be a flotation device. The transporter may include a terrestrial vehicle. In some embodiments, the transporter is a motorized wheeled vehicle. In other embodiments the transporter is a trailer. In other embodiments, the transporter is a sledge. The vacuum source 66 may be mounted on skids to permit it to be pulled over sand and debris. The vacuum source 66 may have an on/off switch. The vacuum source 66 may have controls that vary its power. An operator may operate the controls. An “operator,” as used in this document, is a person operating the floatable-material harvester of FIG. 1, FIG. 2, FIG. 22, and FIG. 24. The controls may be operated either locally or remotely. A microprocessor configured to operate the controls may operate the controls.

In some embodiments, the vacuum source 66 includes a canister, defined as a chamber in which the vacuum source collects the seaweed and other floatable materials it receives via the transport hose 60. The canister may be the collection area 12. In some embodiments, the vacuum source may be connected to at least one storage container. The at least one storage container may be refrigerated. The at least one storage container may be detachable from the vacuum source 66 for transport. The vacuum source 66 may have a dump box into which the canister may rapidly be emptied, for instance, by opening a connecting door between the canister and the dump box so that the force of gravity causes the contents of the canister to fall into the dump box. In some embodiments, the vacuum source 66 includes at least one conveyor to move seaweed and other floatable materials from one container to another. The least one conveyor may be a conveyor belt. The least one conveyor may be a conveyor screw. The conveyor may be least one controlled by an operator. The conveyor may be controlled by a microprocessor configured to control the conveyor. In some embodiments, the conveyor is a drainage conveyor; for instance, it may be a conveyor belt made of mesh, which allows water to run out of the materials it is transporting.

As illustrated in FIG. 21, in some embodiments, the vacuum source 66 includes a trommel washer 64 connected to the vacuum chamber, which may be connected by a conveyor belt. The trommel washer 64 includes a washer drum. The washer drum may be substantially cylindrical in form. The washer drum may have perforations in the curved cylinder wall; the perforations may permit water to escape the trommel washer. The washer drum may have a cylindrical wall made of mesh. In some embodiments, the mesh is loose enough to allow non-seaweed matter such as sand and small organisms to wash out through the mesh, while retaining the seaweed. In some embodiments, the washer drum rotates around the vertical axis of its cylindrical form. In some embodiments, the vertical axis of the cylinder making up the washer drum is tilted from the horizontal, causing the seaweed to move from one end to the other of the washer drum as it rotates. In some embodiments such as in FIG. 21, the ocean water that enters the trommel washer 64 is cooled by passing through a refrigeration unit 48. In some embodiments, ozone or another sterilizing agent such as chlorine or bromine is injected into the water from a sterilizer injector 79. In some embodiments, the trommel washer 64 includes a spray nozzle 58 that sprays water on the seaweed as the washer drum rotates. In some embodiments, water is drawn from a water inlet 51 by a pump 70 and provided to the spray nozzle 58.

In some embodiments, the water passes through a heat exchanger 26 prior to being sprayed on the seaweed by the spray nozzle 58 and then again passes through the same heat exchanger as the water exits. In some embodiments, the water that drains from the washer drum is ejected from the trommel washer 64 via a water outlet 80. In some embodiments, the water passes through the heat exchanger 26 prior to being ejected through the water outlet 80. The trommel washer 64 may have controls by means of which its operation may be regulated. An operator may operate the controls. The controls may be operated remotely or locally. A microprocessor configured to operate the controls, as set forth more fully below, may operate the controls.

The suction tube or, more broadly, transport hose 60 of any of the embodiments may be made from any combination of materials that permit the tube to be sufficiently airtight to maintain the pressure differentials with the outside atmosphere that is necessary for suction or pressure thrusting. The transport hose 60 should also be sufficiently watertight to transport wet materials and be capable of withstanding the suction force without collapsing or the thrust pressure force without exploding or rupturing. In some embodiments, the transport hose 60 may be reinforced with a metal mesh to withstand high pressure. In some embodiments, the transport hose/suction tube 60 is a flexible hose or other conduit. For the purposes used herein, an object is “composed at least in part” of a substance if any non-zero proportion of the object is composed of that substance. Of course, an object is “composed at least in part” of a substance if the object is composed entirely of that substance.

In some embodiments, the transport hose 60 is composed at least in part of a polymer material. In some embodiments, the transport hose 60 is composed at least in part of polyvinyl chloride. In other embodiments, the transport hose 60 is composed at least in part of polyurethane. In additional embodiments, the transport hose 60 is composed at least in part of a fluoropolymer also known as Teflon. In additional embodiments, the transport hose 60 is composed at least in part of polyethylene. In still other embodiments, the transport hose 60 is composed at least in part of nylon. The transport hose 60 may be composed at least in part of a natural rubber. In some embodiments, the transport hose 60 is composed at least in part of a synthetic rubber. The transport hose 60 may be composed at least in part of a textile material. The transport hose 60 is composed at least in part of metal. The transport hose 60 may be composed at least in part of a rigid plastic.

In some embodiments, the transport hose 60 is composed of a combination of the above materials. For instance, the transport hose 60 may be composed of a flexible substance reinforced with cross-sectional hoops of a rigid substance. The transport hose 60 may be composed of a polymer substance reinforced with textile material. The transport hose 60 may be composed of cylindrical sections of rigid material such as metal concatenated with cylindrical sections of flexible material, such as flexible polyvinyl chloride. The rigid cylindrical sections may form watertight joints for connecting together two sections of flexible hose. In some embodiments, each hose section connects to the watertight joints via a threaded connection, requiring the hose section to be screwed together with the watertight joint. Some embodiments of the transport hose 60 are composed of a flexible material corrugated to form cross-sectional circular ribs for greater strength. In some embodiments, the inner diameter of transport hose 60 may be between 4 and 17 inches. In some embodiments, the transport hose may be at least 500 feet long. Where the transport hose 60 is a flexible hose, it may be stored on a spool; for instance, it may be wound on a spool attached to the vacuum source 66.

In some embodiments, the transport hose 60 has at least one flotation device 105. In some embodiments the flotation device 105 is a buoy. The buoy may be composed of any combination of materials known in the art to be suitable for manufacturing buoys. The buoy 105 may be composed at least in part of foam. The buoy 105 may be composed least in part of natural polymer foam, such as latex foam. The buoy 105 may be composed least in part of synthetic polymer foam such as polyethylene foam. The foam may be closed-celled. The foam may be open-celled. Open-celled foam may be combined with a waterproof skin to prevent incursion of water and resultant loss of buoyancy.

The high pressure hose 28 may share similar characteristics to the transport hose 60. High pressure hose 28 may have much higher pressure ratings than transport hose 60 and may be comprised of thicker material. High pressure hose 28 may be flexible or rigid in composition. High pressure hose 28 may be reinforced with a mesh designed to withstand very high pressures. High pressure hose 28 may float from its composition or may require an additional floatation device.

In some embodiments, the flotation device 105 is a cylindrical ‘O’ type buoy that is designed to be attached to the transport hose 60, comprised of two C halves connected by hinges. On the opposite end of the hinges there may be locking clamp to secure the buoy 105 to the transport hose 60. The inside diameter of the locked ‘O’ type buoy may be equivalent to the outside diameter of the transport hose 60, so that the buoy firmly grips the transport hose 60.

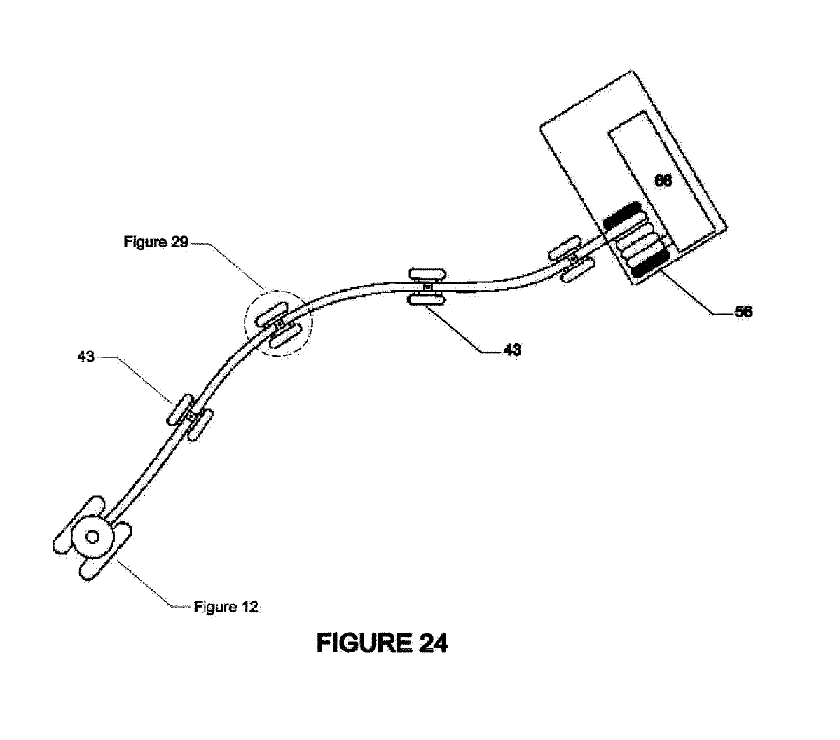

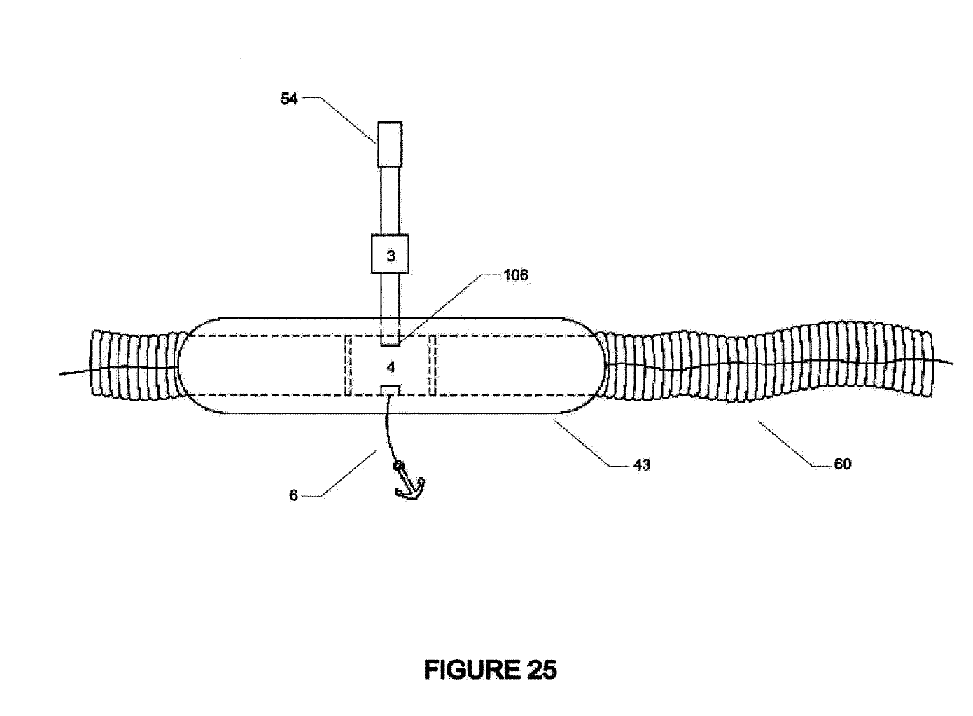

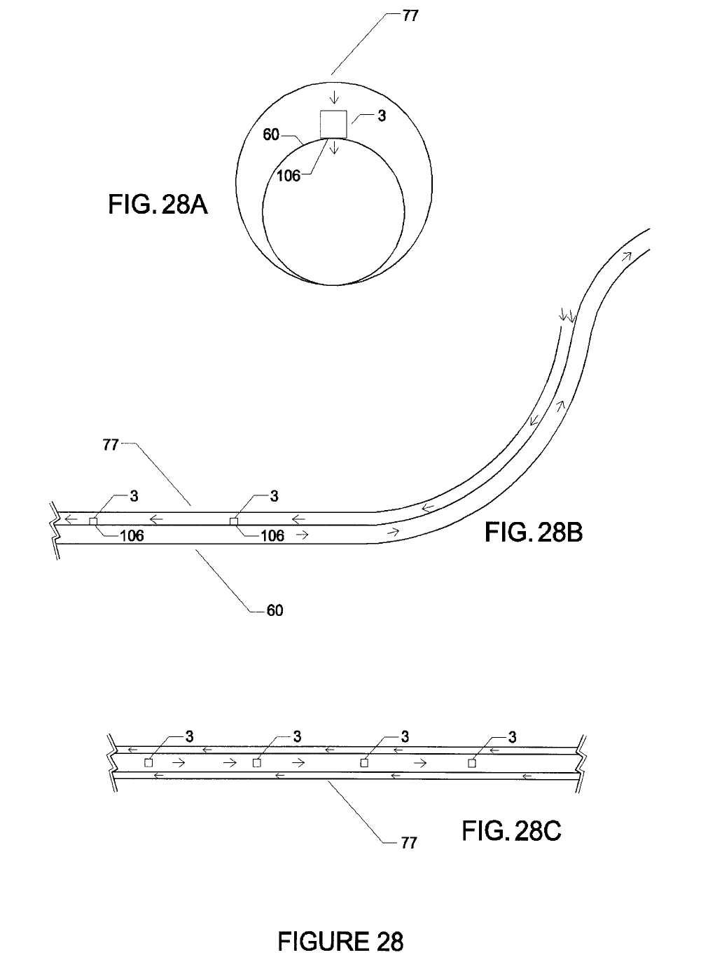

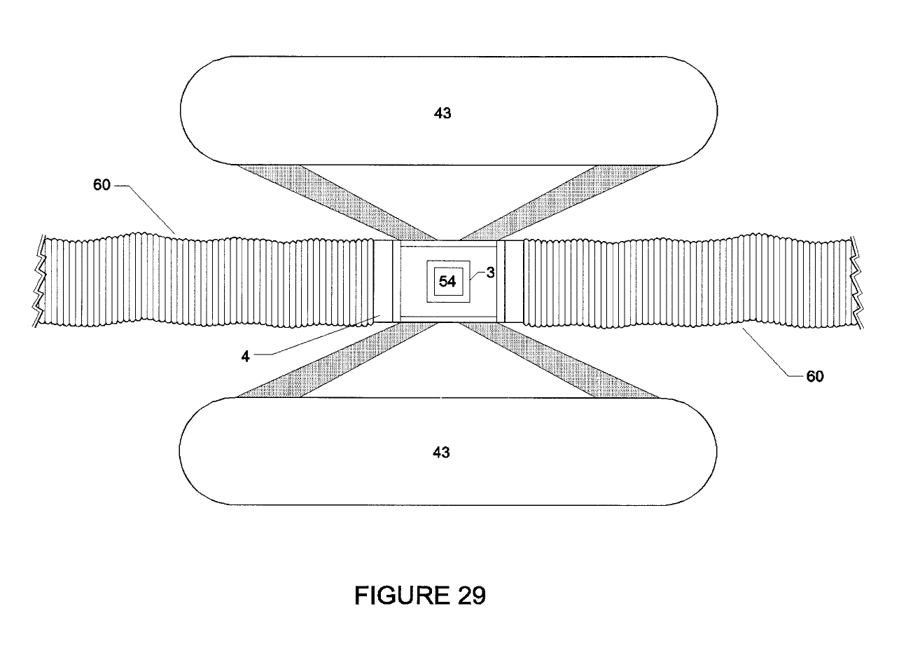

In some embodiments, the flotation device 43 is a part of the air inductor, as set forth below in reference to FIG. 25. The flotation device may be an airtight outer hose 77 section as set forth in more detail below in reference to FIG. 28. In some embodiments, where the transport hose 60 is formed from a series of flexible hose sections concatenated with watertight joints, the flotation device is a set of pontoons 43 affixed to a watertight joint. The flotation device 43 may be detachable. In some embodiments, the transport hose 60 includes at least one anchor 6. Where the transport hose 60 is made up of flexible hose sections concatenated with watertight joints, the anchor may be affixed to a watertight joint. The anchor may be detachable and the anchor may be automatically deployed by a winch. An air inductor may also have an anchor and the anchoring system may be automated.

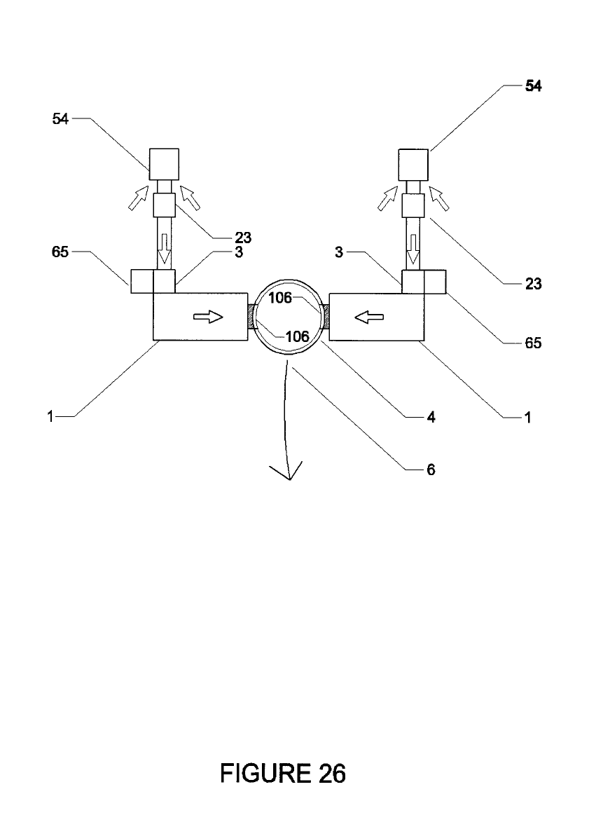

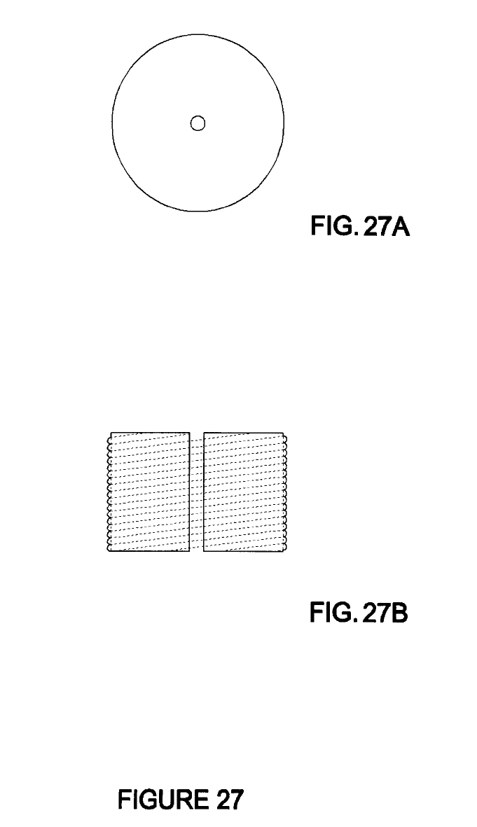

As illustrated by FIG. 26, in some embodiments, the transport hose 60 has at least one air inductor/intake mechanism. In some embodiments, the transport hose 60 has a plurality of air inductors. Air may enter through an opening 106. The at least one air inductor is an element that allows air to enter the interior of the transport hose by, for example, passive induction/intake or negative pressure. The at least one air inductor is a separate element from the input of the transport hose 60. The presence of the at least one air inductor has the effect of accelerating the speed of material, as the air speed increases past each opening, allowing a significant increase in both distance travelled by the material and allowing for a smaller hose diameter to be used. In an embodiment, the air inductor includes an opening 106 in the wall of the transport hose 60; and the inducted air passes through the opening 106 into the interior of the transport hose 60. In some embodiments, the opening opens on an air cavity 1 outside the transport hose 60. The air cavity 1 may act as a local reservoir of air from which the transport hose 60 can draw through the opening 106. The air cavity 1 may also function as a flotation device 43, as described above in reference to FIG. 22.

In some embodiments, the at least one air inductor also includes at least one air control valve 3, regulating the flow of air through the at least one inductor. The air control valve 3 may be located at the opening 106. In embodiments in which the air inductor includes an air cavity 1, the air control valve 3 may regulate the entry of the air into the air cavity 1. In one embodiment, the air control valve 3 is a check valve. For instance, the air control valve 3 could be a check valve with a bias that causes it to close if the pressure within the transport hose 60 interior relative to the source of the air outside the opening 106 falls below a certain threshold. In some embodiments, the air control valve 3 is a ball valve. In some embodiments, the air control valve 3 is a pressure regulator valve. In other embodiments, the air control valve 3 is a globe valve. In still other embodiments, the air control valve 3 is a gate valve. The air control valve 3 may be a butterfly valve. The air control valve 3 may be actuated mechanically. The air control valve 3 may be actuated hydraulically. The air control valve 3 may be actuated pneumatically. The air control valve 3 may be actuated by means of an electrical motor. In some embodiments, any of the air inductors described within this document may function in reverse direction as a gas escape mechanism that may be for a floatable-material thruster, such as is depicted in FIG. 11.

Some embodiments include a microprocessor 11 coupled to the at least one air control valve or water control valve and configured to control the at least one air control valve 3 or water control valve 69. The microprocessor 11 may control the air control valve 3 or water control valve 69 via any actuator controls listed herein or by any conventional means. The microprocessor 11 may be coupled to the air control valve 3 or water control valve 69 with actuator control by a wired connection. The microprocessor 11 may be coupled to the air control valve 3 actuator via a wireless connection 65. The microprocessor 11 may be any processor known in the art. The microprocessor 11 may be a special purpose or a general-purpose processor device. As will be appreciated by persons skilled in the relevant art, the microprocessor 11 may also be a single processor in a multi-core/multiprocessor system, such system operating alone, or in a cluster of computing devices operating in a cluster. The air flow valve 3 and water flow valve 69 may be controlled by an analog circuit coupled to the flow meter

In some embodiments, the at least one air inductor also includes an airflow meter 23. The airflow meter 23 may measure the rate of flow of the air through the air inductor. In some embodiments, the air flow meter is an anemometer. An anemometer may obtain an air flow reading through Doppler laser, sonic, windmill, cup, hot hire, acoustic resonance, ping-pong ball, pressure, plate, tube, and air density. The airflow meter 3 in some embodiments controls the airflow through the air control valve 3 by means of the air control valve 3 actuator, responsive to that measurement. In some embodiments, the airflow meter 23 is coupled to the microprocessor 11. In some embodiments, the microprocessor 11 controls the air control valve 3 in response to a measurement of airflow received from the airflow meter 23. In some embodiments, the air inductor includes an anchor 6. In some embodiments, the anchoring system is automated. In some embodiments, such as an embodiment using a floatable-material thruster, the airflow meter 23 is replaced or supplemented by a flow meter designed to measure the flow of pressurized fluid such as air or water. The flow of water may be measured by turbine, displacement, velocity, compound, electromagnetic, ultrasonic, and impeller.

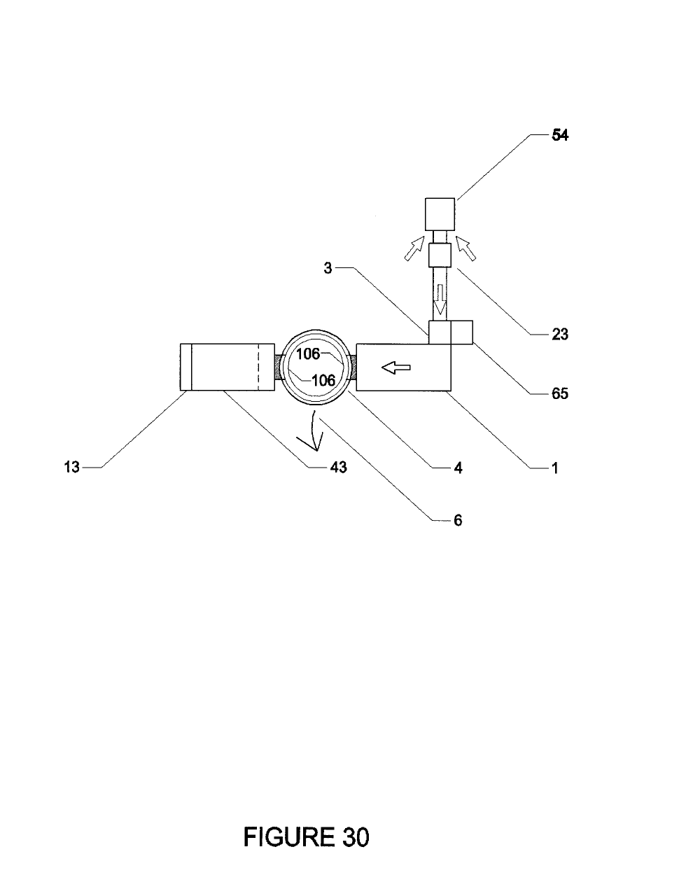

In some embodiments, the at least one air inductor includes a snorkel 54. The air inductor in some embodiments receives air through the snorkel 54. The snorkel may be of sufficient height to prevent or at least minimize entry of water from waves. The air may enter the air inductor via the snorkel by passive induction/negative pressure. In some embodiments, watertight connectors 4 allow the snorkel apparatus to be detached when not in use, so that the transport hose 60 rolls up easily onto a spool 56. In some embodiments, the at least one air inductor includes two snorkels 54. In some embodiments, the air inductor includes a counterweight 13, such as in FIG. 30. For example, in one embodiment, the air inductor has where snorkel 54 with an air control valve 3, air flow meter 23 and air cavity 1 on one side of the transport hose 60, and a watertight connector, with air cavity, and counter balance weight on the opposite side. Returning to FIG. 22, in some embodiments, the air inductors are connected to watertight joints that are combined with sections of flexible hose to form the transport hose 60, as disclosed above.

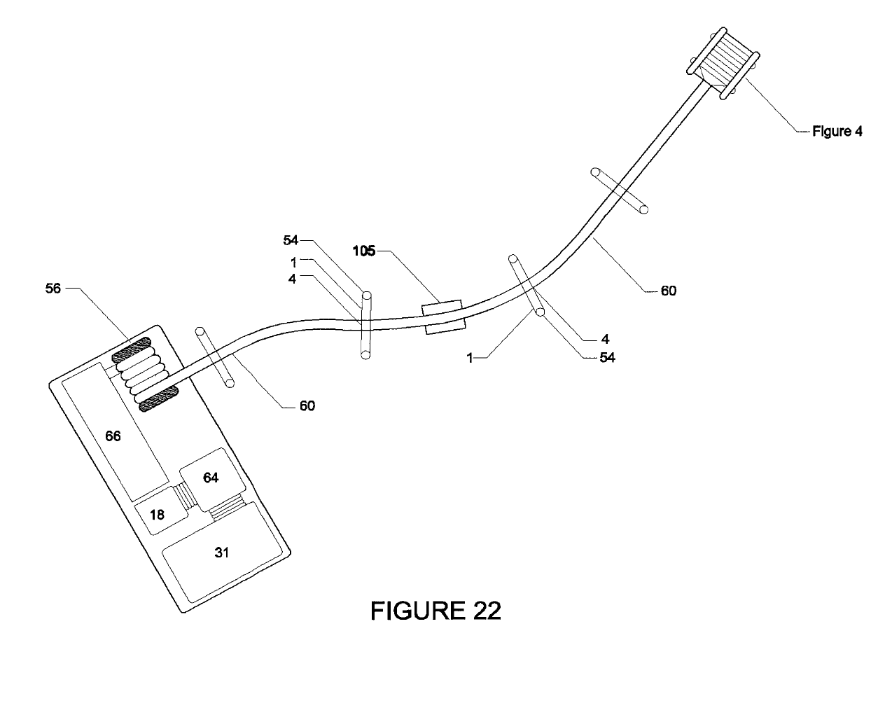

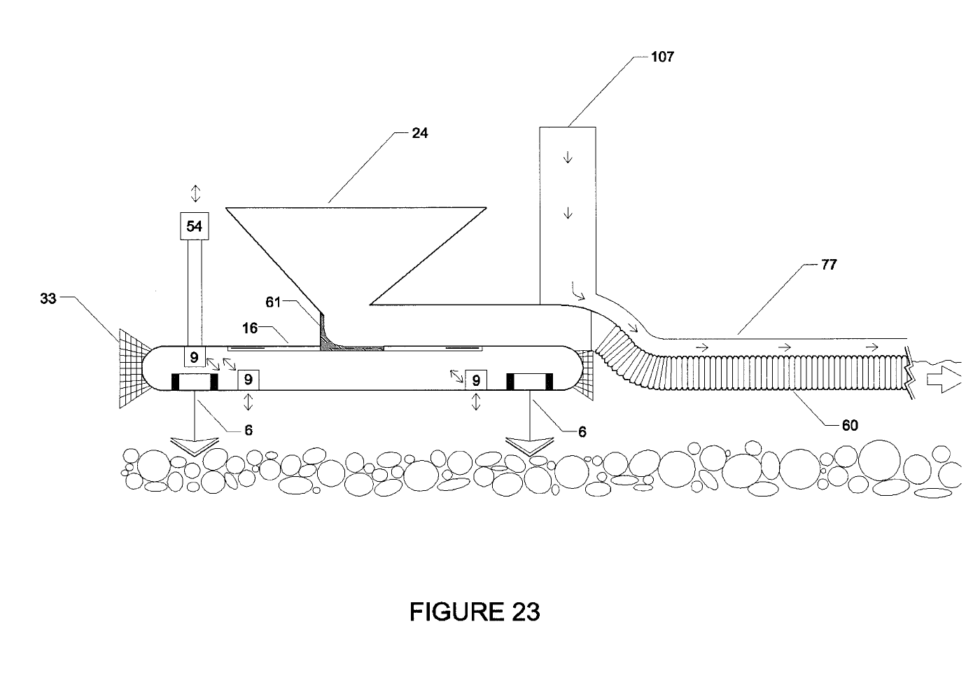

As shown in FIG. 28, some embodiments of the floatable-material harvester include an airtight outer hose section 77 filled with air, through which the transport hose 60 passes. The airtight hose section 77 interior is fluidly connected to the interior of the transport hose 60 by the at least one air inductor. The airtight hose section 77 may cover the entire length of the transport hose 60; for instance, the transport hose may in effect be a double hose. The airtight outer hose section 77 may cover less than the entire length of the transport hose 60. Where the transport hose 60 is composed of lengths of flexible hose concatenated with watertight joints, the airtight outer hose section 77 may cover one flexible hose length. Each flexible hose length may have a separate airtight hose section 77. The hose section 77 may act in a similar capacity to the air cavity 1 described above in reference to FIG. 26. In some embodiments, the hose section 77 functions as source of flotation for the transport hose 60. As shown in FIG. 23, the hose section 77 has an opening 107 at one end to receive air, in some embodiments. The hose section 77 receives air from the outside via a snorkel (not shown) in some embodiments.

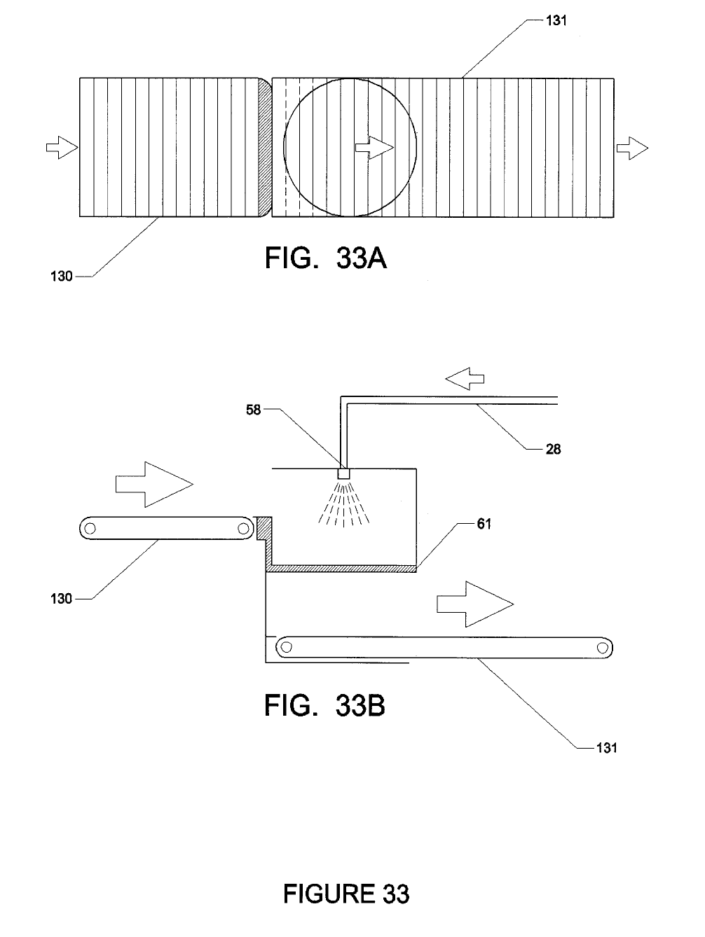

FIG. 33 is an embodiment of a swivel connection in the conveyor system that is configured to transport floatable material through the swivel connection to the floatable-material receiver. The swivel joint 61 is designed to transport floatable material through the swivel joint 61 from one conveyor to another. The swivel 61 in some embodiments may connect directly to the floatable-material receiver. In some embodiments, the swivel connection 61 may connect anywhere down the process chain before the transport hose 60, from the mechanical picks-up device 120 to the floatable-material receiver. In some embodiments, the swivel joint 61 is connected directly to the floatable-material receiver, and the lower feeder mechanism is a feeder mechanism of the floatable-material receiver. In some embodiments, the swivel joint 61 may rotate 360 degrees. In some embodiments, the lower conveyor belt 131 may be replaced or supplemented by a hopper or a funneling device.

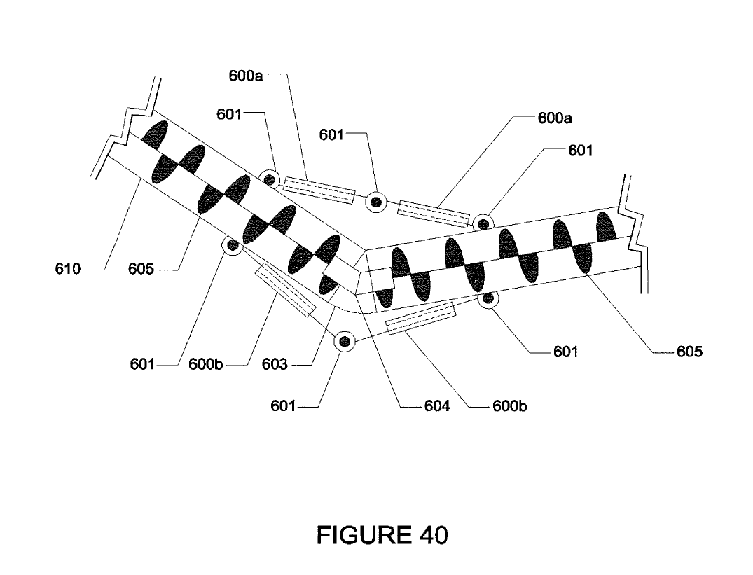

The swivel may allow the vehicle or watercraft carrying the floatable-material receiver to turn while it is collecting floatable material, which may have the advantage of a more maneuverable and efficient apparatus on both the beach and operating in the water. The swivel may allow a watercraft containing the mechanical picks-up device 120 to turn into the surf to collect floatable material, navigate up to or near the beach, and then turn to collect floatable material in an optimal direction. In some embodiments, the double jack apparatus depicted in FIG. 40 may replace or supplement the swivel apparatus discussed.

In this embodiment, top conveyor belt 130 is positioned above the swivel joint 61. As top conveyor belt 130 moves its load forward, the force of gravity causes the floatable material to drop to the lower conveyor belt 131. The swivel 61 ensures that whatever direction a conveyor belt 130 is facing, it is able to transfer its load to the lower conveyor belt 131.

This arrangement may present a flow problem however, where the top conveyor belt may transfer its load faster than gravity may cause the material to fall. This load-rate differential may cause plugging and/or a low rate of flow. This problem can be minimized by further employing a downward pointing spray nozzle 58, which may provide fluid from a high pressure hose 28 or an independent source. The high pressure fluid released from nozzle 58 forces the material in a downward direction much faster rate than what gravity alone can provide, thereby producing a faster rate of transfer from one conveyor to the next.

In some embodiments, screw augers are used to substitute or augment the conveyor belts. In some embodiments, two screw conveyors are positioned to replace conveyor belts 130 and 131, with a nozzle pointed in the direction of flow of the seaweed in the same manner as FIG. 33. This configuration may allow a swivel joint 61 to operate in any direction with the use of screw augers positioned within the swivel joint tube 61, since there is not a reliance on the need for gravity. In some embodiments, the swivel joint tube is comprised of a screw conveyor, so that a total of three conveyors, one perpendicular to the two others, operate simultaneously to transfer material through the swivel connection. The connection may further have means of draining or evacuating the fluid from the nozzle.

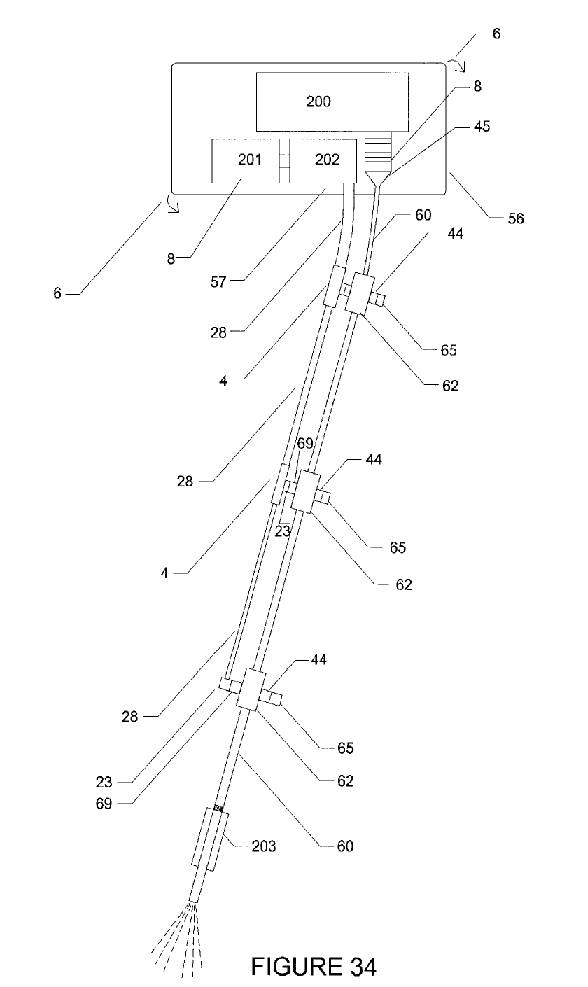

The embodiment of FIG. 34 is of an apparatus that may distribute sorbent material onto a foreshore or body of water. Sorbent material storage container 200 may convey, for example, by a gravity and funnel system, sorbent material to conveyor belt 8, where the conveyor belt is configured to feed that material into the funneling element 45 and into transport hose 60. Water may be drawn from the body of water through a filter by high pressure pump 201, which may charge high pressure tank 202 with high pressure water. In some embodiments, high pressure air can be used with or instead of water. Fluid travels down high pressure hose 28 and through valves 69 and into the floatable-material thrusters 62. In such an instance, the nozzles of the thrusters are configured to direct flow in the opposite direction of a floatable-material harvester. Both the high pressure hose 28 and the transport hose 60 may be staged and/or may have an increasing diameter, to minimize excessive acceleration of the sorbent material. Small craft 203 may point the transport hose output in an upward direction, so as to project the sorbent material onto a foreshore or body of water. Valves 69 may provide a continuous and regulated flow of fluid from the high pressure pump 201, or the valves 69 may provide bursts of high pressure fluid into the transport hose 60, to propel a finite amount of sorbent material a longer distance, similar to that of a gun. The conveyor belt 8 may load the transport hose 60 with sorbent material before the valves 69 provide a burst of fluid.

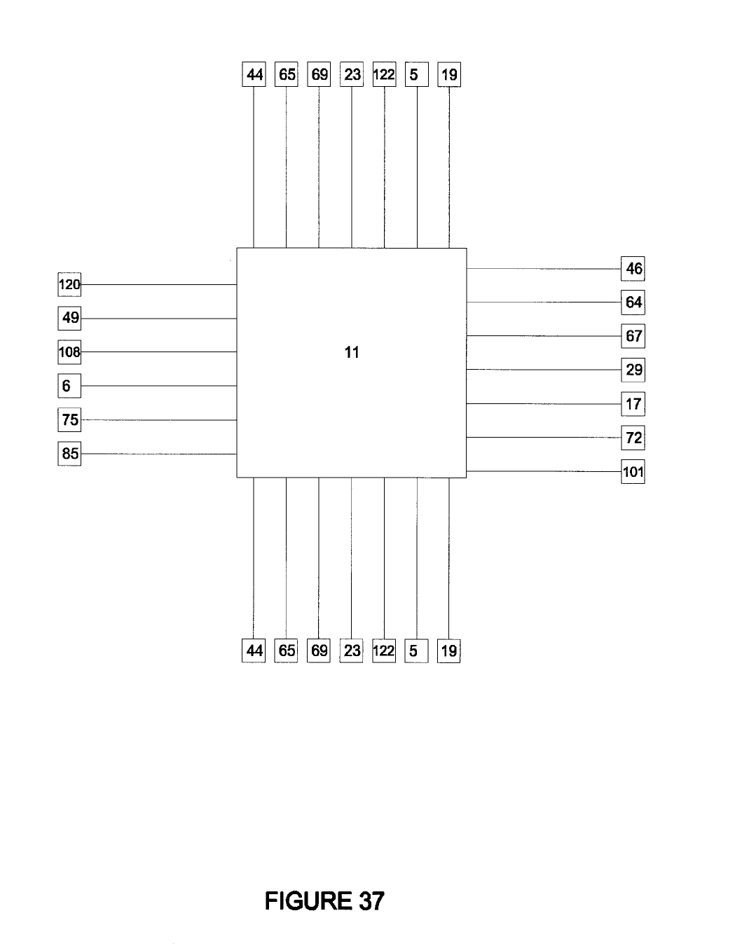

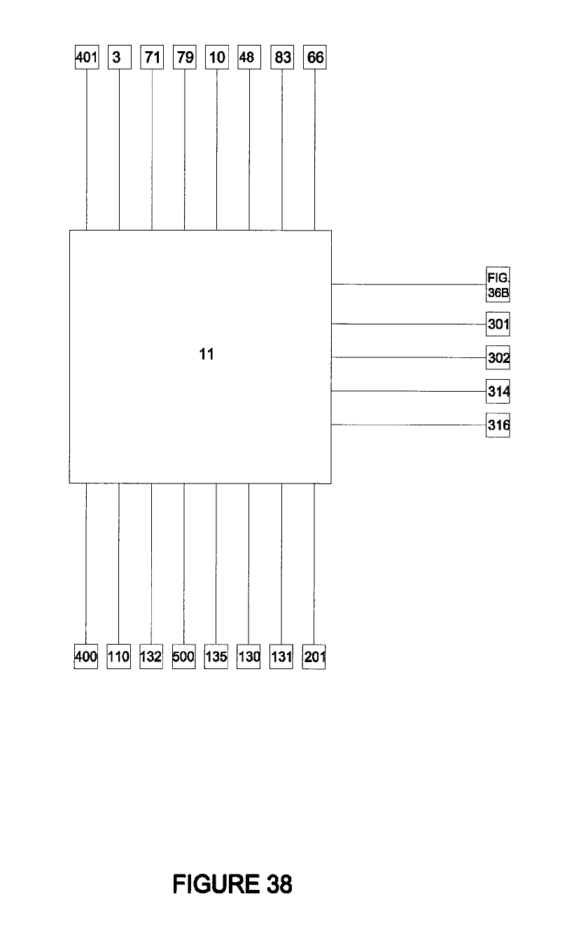

FIG. 37 and FIG. 38 are embodiments of control and/or communications connections between the microprocessor 11 and various devices. In some embodiments, the device may provide information to the microprocessor 11. In some embodiments, the microprocessor 11 may provide information to the device. In some embodiments, the microprocessor 11 may provide power to the various devices, either by steady current or pulsation. In some embodiments, this connection may be hardwired. In some embodiments, this connection may be fiber optics. In some embodiments, this connection may be wireless by means of radio, light, or sound transmission. In some embodiments, the device may provide analog information. In some embodiments, the device may provide digital information. The microprocessor 11 may be programmed to learn how to control the apparatus more effectively by information response from various sensors after applying movements.

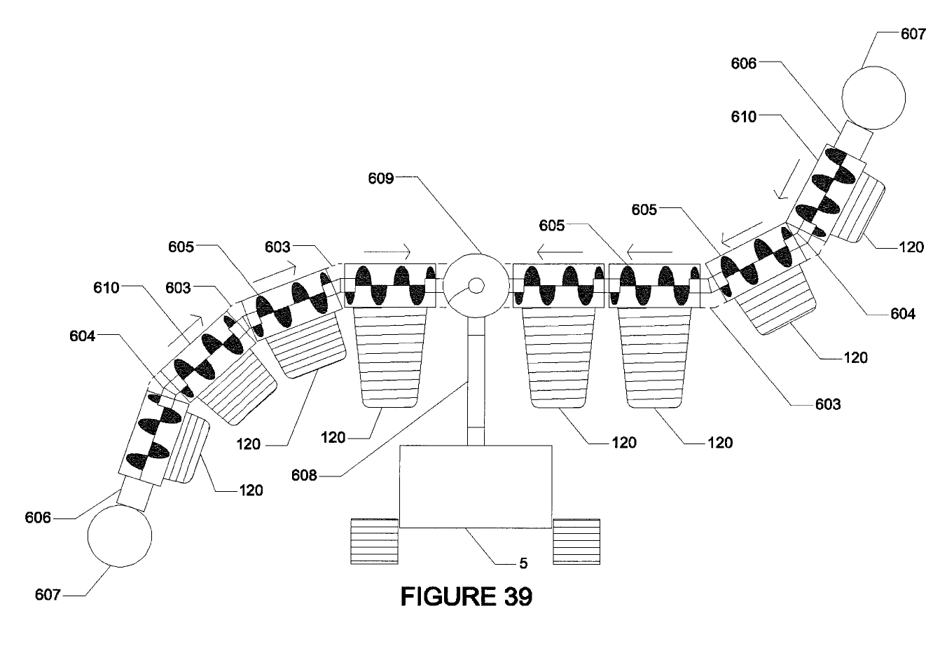

FIG. 39 is a rear view of a depiction of a conveyor pick up mechanism, similar in function to FIG. 32, but with the addition of bendable conveyor connections. Although FIG. 32 may be more suitable for low profile surf harvesting with a flat conveyor belt surface, flexible screw conveyors may allow the invention to perform complex movements over random terrain on the bottom of a body of water, while still receiving and transporting a continuous flow of materials provided by mechanical pick-up devices 120. This mechanical device may provide floatable material through a correctly sized opening into the body of the conveyor 610. The universal joints 604 thereof provide means of bending a connection between each screw conveyor 605, while still providing a continuous flow of materials to the transverse screw conveyor 609. The material is then transferred to the rest of the system, possibly through more bendable connections to the transport hose 60 and/or the swivel connection of FIG. 33. In some embodiments, the screw conveyors 605 are replaced or supplemented by a series of nozzles connected to a pump, providing pressurized fluid that propels floatable material in the same general direction provided by the screw conveyors.

Vertical jack 608 may be employed to provide a vertical lift from an amphibious vehicle 5. Floatation devices 607 may provide weight stability for the apparatus, and relieve unnecessary strain on the universal joints 604. Floatation devices 607 may be connected to a source of compressed air, so that the microprocessor 11 may either flood them with air or water, to adjust the weight on the arm. Motors 606 may provide power for the screw conveyors 605, or the power may be provided by a hydraulic line containing high pressure water turning a paddle or a turbine. This high pressure water may be provided from the body of water in which the apparatus resides. Flexible shields 603 provide covers for the bends, and each may be comprised of one or more layers of curved sheets.

FIG. 40 is a side view of an embodiment of a double-jointed screw conveyor connection that allows for a continuous flow of materials. The universal joint 604 provides the means by which the connection is able to bend, while retractable double screw jacks 600a are able to retract to a relatively short length, as needed. The same jacks can fully extend to a long length, as depicted in the extended-position configuration thereof, shown as extended double jacks 600b. Swivel connections 601 provide the range of motion as they turn/pivot in different positions, ranging from movement within a single plane through a range of planes in an xyz coordinate system. A double screw jack may be comprised of two threads screwing and unscrewing into each other, or it may be comprised of two parallel mechanisms working side by side. Double threading may provide a greater range of motion than a single thread jack. The jack may be as well any other type of jack that is known in the art. A given screw conveyor 605 may transfer its power through a corresponding universal joint 604.

Returning to FIG. 1, FIG. 2, FIG. 22, or FIG. 24, the floatable-material harvester of FIG. 1, FIG. 2, FIG. 22, or FIG. 24 includes a floatable-material receiver. The floatable-material receiver is connected to the input of the transport hose 60. In some embodiments, the floatable-material receiver is a device that aids operators of the floatable-material harvester of FIG. 1, FIG. 2, FIG. 22, or FIG. 24 in placing floatable material into the transport hose 60.

The floatable-material receiver may include a nozzle 58. The nozzle 58 may have handles (not shown), allowing an operator to direct the nozzle at floatable material on a shore or in water. The nozzle may have two or more sections connected by joints, allowing the operator to direct the nozzle opening to various angles relative to the position of the transport hose 60. The nozzle may have a valve that allows the operator to stop airflow or water flow through the nozzle into the transport hose 60. An operator may operate the valve directly or via remote control. A microprocessor 11 may operate the valve.

In some embodiments, as shown in FIG. 5, the floatable-material receiver is a platform-based floatable-material receiver. A platform-based floatable-material receiver is a floatable-material receiver that includes a floor portion on which floatable material may be placed. In some embodiments, the floor portion is substantially planar. In other embodiments, the floor portion is curved. The floor portion may be angled; for example, the floor portion may be angled toward the transport hose 60 so that the action of gravity aids in moving the floatable material toward the transport hose 60. In some embodiments, the floor portion is substantially horizontal. Other components of the floatable-material receiver may be placed on the floor portion; for example a receptacle may be placed upon the floor portion. In some embodiments, the transport hose 60 removes the floatable material directly from the platform.

The platform-based floatable-material receiver may include a conveyor belt 8 or a screw auger 52 to convey the seaweed from the platform to the transport hose 60. As a non-limiting example, the feeder mechanism may be a conveyor belt 8. The conveyor belt 8 may be powered by any conventional means, including the force of the vacuum itself. In some embodiments, the conveyor belt 8 has a variable speed control. In some embodiments, the feeder may have a funneling element 45 that forces floatable material into the hose by narrowing the path the material can follow as the conveyor belt 8 moves forward. The variable speed control may be able to cause the conveyor belt to move faster or slower. The variable speed control 75 may be controlled by an operator. The variable speed control 75 may be controlled by a microprocessor configured to control the variable speed control (not shown). The microprocessor may be a microprocessor 11.

In some embodiments, as shown in FIG. 9, the floatable-material receiver is a receptacle-based floatable-material receiver. A receptacle-based floatable-material receiver may be a floatable-material receiver that includes a receptacle into which the floatable material may be placed, and from which the transport hose 60 removes the floatable material. The transport hose 60 may remove the floatable material directly from the receptacle. The transport hose 60 may receive the floatable material from the receptacle indirectly, via a feeder mechanism. For example, a screw conveyor 52 may remove the floatable material from the receptacle and feed it to the transport hose 60. A conveyor belt may remove floatable material from the receptacle and feed it to the transport hose 60.

In some embodiments, the receptacle-based floatable material receiver includes a funnel 24. In some embodiments, the funnel 24 is angled so that it opens directly into the transport hose 60. In other embodiments, as shown in FIG. 13, the mouth of the funnel 24 is pointed vertically, and the funnel 25 is connected to the transport hose 60 input by a conduit with a gradual 90-degree bend. In some embodiments, as shown in FIG. 9 the receptacle-based floatable-material receiver includes a hopper 84 having an outlet coupled to the input of the transport hose 60.

In one embodiment, the hopper 84 includes an agitator 108. The agitator 108 may be an element that agitates the seaweed or floatable material in the hopper or funnel; this may have the effect of loosening clumps of seaweed/floatable material and may act as a feeder mechanism to the transport hose 60. In some embodiments, the agitator 108 vibrates. In some embodiments, the nozzle 58 may assist or replace a feeder mechanism for the transport hose 60. An operator may operate the agitator 108 directly or via remote control. A microprocessor configured to operate the agitator 108 may operate the agitator. In some embodiments, the floatable-material receiver includes a vegetation shredder 67. An operator may operate the vegetation shredder 67 directly or via remote control. A microprocessor configured to operate the vegetation shredder 67 may operate the vegetation shredder 67. In some embodiments, the floatable-material receiver includes a trommel washer 64. The trommel washer may be a trommel washer 64 as described above in reference to FIG. 21.

Returning to FIG. 1, FIG. 2, FIG. 22, and FIG. 24, in some embodiments, the floatable-material harvester includes a floatable-material receiver transporter supporting the floatable-material receiver. In some embodiments, the floatable-material receiver transporter is a terrestrial vehicle. In some embodiments, the floatable-material receiver transporter is a motorized wheeled vehicle. In other embodiments the floatable-material receiver transporter is a trailer. In other embodiments, the floatable-material receiver transporter is a sledge. In other embodiments, the floatable-material receiver transporter is a beach cleaner, or a vehicle designed to collect seaweed and convey the seaweed into the transport hose 60.

In some embodiments, the floatable-material receiver transporter includes a flotation device 43 supporting the floatable-material receiver. The flotation device may be a raft. The flotation device 43 may be a boat. The flotation device 43 may include at least one pontoon. The flotation device 43 may be constructed using any combination of materials known in the art to produce a buoyant object. In some embodiments, the flotation device 43 is composed at least in part of polymer foam, as described above in reference to FIG. 2 and FIG. 22. In other embodiments, the flotation device 43 is composed at least in part of wood. In still other embodiments, the flotation device 43 includes at least one enclosed cavity filled with air. The material enclosing the at least one cavity may be any material or combination of materials capable of forming an airtight enclosure. The material enclosing the at least one cavity may be metal. The material enclosing the at least one cavity may be a polymer.

As shown in FIG. 13, the flotation device 43 may also include buoyancy control. In some embodiments, buoyancy control is a set of devices that enables the flotation device 43 to increase or decrease its buoyancy. Where the flotation device 43 contains at least one air-filled, enclosed cavity, the buoyancy control may include at least one bilge pump 9. In an embodiment, the at least one bilge pump 9 is capable of pumping water into the cavity. In another embodiment, the at least one bilge pump 9 is capable of pumping water out of the cavity. In an additional embodiment, the at least one bilge pump 9 is capable of both of pumping water into the cavity and of pumping water out of the cavity. In some embodiments, the at least one bilge pump 9 pumps water from the body of water using a water conduit. The water conduit may have an element that filters solid matter out of the water, such as a mesh filter.

In some embodiments, the at least one bilge pump 9 pumps water from the cavity into the body of water through a water conduit. In an embodiment, the at least one bilge pump 9 is capable of pumping air into the cavity. In another embodiment, the at least one bilge pump 9 is capable of pumping air out of the cavity. In an additional embodiment, the at least one bilge pump 9 is capable of both of pumping air into the cavity and of pumping air out of the cavity. In some embodiments, the at least one bilge pump 9 pumps air from the atmosphere using a snorkel 54. In some embodiments, the bilge pump 9 pumps air back into the atmosphere using a snorkel 54. In some embodiments, the at least one bilge pump 9 can pump either air or water in or out of the cavity, as needed to adjust the buoyancy of the flotation device 43. In some embodiments, the buoyancy control is controlled by an operator. In some embodiments, the operator controls the buoyancy control remotely by means of a wired or wireless signal. In some embodiments, the buoyancy control is controlled by a microprocessor configured to control the buoyancy control (not shown). The microprocessor may be a microprocessor 11.

As shown in FIG. 10, in some embodiments, the flotation device further includes a propulsion system 49. The propulsion system 49 includes at least one propeller, in some embodiments. In some embodiments, the propulsion system may use the principal of magneto hydrodynamics. In some embodiments, the propulsion system 49 has reversible thrust. In some embodiments, the propulsion system 49 is controlled by an operator. In some embodiments, the operator controls the propulsion system 49 remotely by means of a wired or wireless signal. In some embodiments, the propulsion system 49 is controlled by a microprocessor configured to control the propulsion system 49 (not shown). The microprocessor may be a microprocessor 11. In some embodiments, the flotation device 43 includes a rudder 50. In some embodiments, the rudder 50 is controlled by an operator. In some embodiments, the operator controls the rudder 50 remotely by means of a wired or wireless signal. In some embodiments, the rudder 50 is controlled by a microprocessor configured to control the rudder 50 (not shown). The microprocessor may be a microprocessor 11. In some embodiments, the flotation system 43 is made up of two pontoons, and the propulsion system 49 is located in between the two pontoons.

In some embodiments, as shown in FIG. 9, the flotation device includes an anchoring system 6. In some embodiments, the anchoring system 6 includes at least one anchor attached to at least one cable. The at least one cable may be wound on at least one winch. In some embodiments, the at least one winch is electric. In some embodiments, the anchoring system 6 is automated; for instance, the anchoring system 6 may have at least one electric winch that is remotely controlled. The winch may be controlled by an operator. The winch may be controlled by a microprocessor configured to control the winch (not shown). The microprocessor may be a microprocessor 11.

In some embodiments, as shown in FIG. 10, the floatable-material receiver is mounted on the flotation device 43 by means of a swivel 61. The swivel 61 may be a horizontal swivel. The swivel 61 may permit the transport hose 60 and the floatable-material receiver to swivel three hundred and sixty (360) degrees with respect to the flotation device 43. The swivel 61 may permit the transport hose 60 and the floatable-material receiver to three hundred and sixty (360) degrees an unlimited number of times in either horizontal direction with respect to the flotation device 43. In some embodiments, the floatable-material receiver is detachable from the flotation device 43; in other words, the floatable-material receiver may be detached from the flotation device 43 and reattached to the floating device 43 an indefinitely large number of times without any noticeable damage to either the flotation device 43 or to the floatable-material receiver. The floatable-material receiver may include one or more handles 25 so that operators can lift and carry it where necessary.

A team of operators provide a floatable-material harvester as described above in reference to FIG. 1, FIG. 2. FIG. 22, or FIG. 24. In some embodiments, the operators assemble the transport hose 60; for instance, where the transport hose is made up of a series of lengths of flexible hose concatenated with watertight joints, the operators may connect together the lengths of hose and the joints to produce the fully assembled transport hose 60. Where the transport hose 60 is wound on a spool, the operators may partially or wholly unwind the transport hose 60. Where the transport hose 60 is not initially attached to the input of the vacuum source 66, the operators may attach the transport hose 60 to the input of the vacuum source 66. In some embodiments of the method, the at least one air inductor is not attached to the transport hose 60 prior to deploying the floatable-material harvester of FIG. 22 or FIG. 24; the operators may attach the at least one air inductor to the transport hose 60 while deploying the floatable-material harvester of FIG. 22 or FIG. 24. The operators may activate the at least one actuator of the at least one valve 3.

In an embodiment, the operators attach the floatable-material receiver to the transport hose 60. In another embodiment, the operators attach the floatable-material receiver to the flotation device 43; for instance, the operators may attach the floatable-material receiver to the flotation device 43 via the swivel 61 as described above. The operators may couple the microprocessor 11 to the at least one valve 3. The operators may couple the microprocessor to the propulsion system 49. The operators may couple the microprocessor to the buoyancy control. The operators may couple the microprocessor to the automated anchoring system 6. The operators may couple the microprocessor to the conveyor belt 8. The operators may couple the microprocessor to the agitator 108. The operators may couple the microprocessor to the vacuum source 66. The operators may couple the microprocessor to the air flow meters 23. In some embodiments, the floatable-material receiver is comprised of a floatable-material thruster 62 such as depicted in FIG. 31.

In some embodiments, for instance when the floatable-material receiver is platform-based or receptacle-based as described above in reference to FIG. 4 and FIG. 9, the operators may pitch seaweed into or onto the floatable-material receiver, for instance with a shovel or pitchfork 82. Where the floatable-material receiver has a conveyor belt 8, the conveyor belt 8 may transport the seaweed to the input of the transport hose 60. Where the conveyor belt 8 has variable speeds, an operator may cause it to vary its speed. A microprocessor 11 may cause it to vary its speed. Where the floatable-material receiver has a screw conveyor 52, the screw conveyor may transport the seaweed/floatable material to the input of the transport hose 60. Where the floatable-material receiver includes a hopper 84 with an agitator 108, the agitator may agitate the seaweed by vibration, which may provide a more even flow of floatable material into the transport hose 60. Where the harvesting apparatus includes a trommel washer, the trommel washer may wash the seaweed. In embodiments in which the floatable-material receiver includes a vegetation shredder 67, the vegetable shredder may shred the seaweed. Where the floatable-material receiver has a nozzle, the operators may harvest seaweed by directing the nozzle at the seaweed and permitting the suction of the transport hose 60 to further transport the seaweed.

In some embodiments, the transport hose and floatable-material thruster are comprised of a pressure sensor. Pressure sensors can alternatively be called pressure transducers, pressure transmitters, pressure senders, pressure indicators and piezometers, manometers, among other names. Pressure may be measured by piezo resistive strain gauge, capacitive, electromagnetic, piezoelectric, optical, potentiometric, resonant, thermal, and ionization. In another embodiment, a pressure sensor is connected to the high pressure hose and the high pressure tank. The pressure sensor may transmit pressure information to the microprocessor 11. The microprocessor 11 may use such pressure information to control the speed and generated thrust of the high pressure pump, the water pump connected to the transport hose, and the flow valves 69 or 3. In some embodiments, the microprocessor may be replaced or supplemented by an analog circuit, configured to control the valves and the pumps.

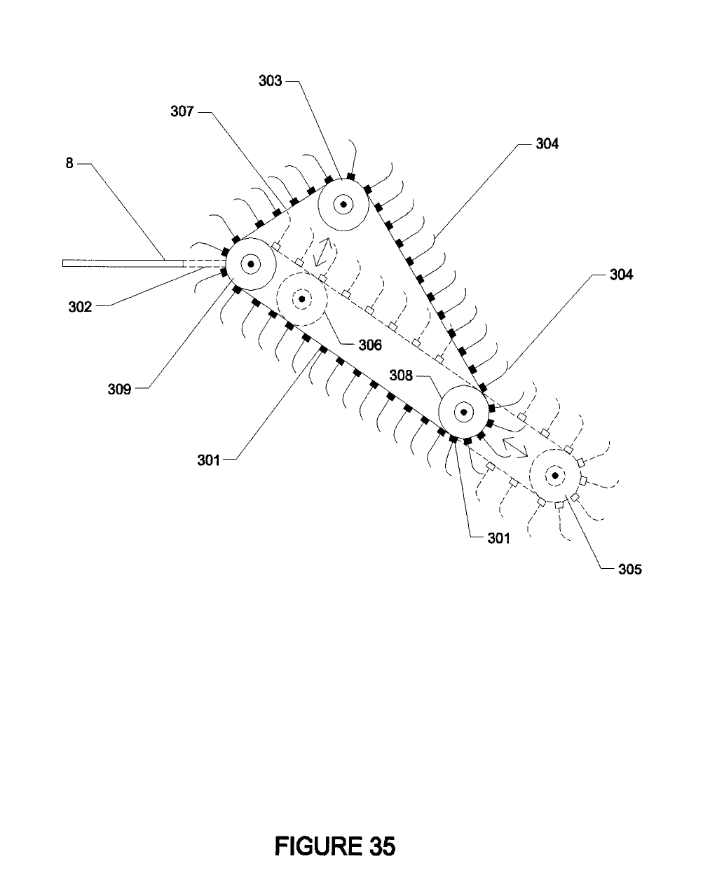

FIG. 35 is a side view of an embodiment of a mechanical pick-up device, depicted in the retracted position with solid lines and in the extended position with dotted lines. A retractable mechanism may allow the device to shorten its overall length and therefore not become stuck on a solid object, such as an embedded rock, while picking up floatable material. The tines 304 are positioned along flexible belt 307, where the flexible belt, in one variation, rotates in a counterclockwise direction by mechanical force provided by a motor connected to drum 309. In some embodiments, each drum may have sprockets. Each or some tines 304 may have pressure sensors 301, which provides information to a microprocessor 11. In some embodiments, each tine is flexible. In another embodiment, the tine 304 may be a hook.

The pressure sensor 301 may be a pressure switch or any of the pressure sensors discussed in this document. When a certain amount of pressure is applied to the tine 304, the microprocessor 11 may control the drum 305 to move, e.g., by a connected hydraulic jack or slider joint (motion shown with arrows but device not specifically shown) to retracted position 308, while drum 306 simultaneously moves to elevated position 303, thereby maintaining the overall length and tension of flexible belt 307, but shortening the length of the mechanical pick-up device. This ability to retract and shorten the overall length of the mechanical pick-up device 120 may allow the invention to operate in a continuous manner, without having to stop and back up.

The entire mechanical picks-up device 120 may rotate on a swivel connection (shown in FIG. 32 as 135), or the mechanical device may rise vertically on an elevator. By being structured in such a manner, a tine 304 receiving pressure by becoming stuck on an obstruction may, through a signal sent from a tine-proximate sensor to the microprocessor 11, cause the mechanical device to retract and lift in an almost simultaneous manner, thereby clearing the obstruction, and then redeploying once clearance is regained. As floatable material is collected on the tines 304, the material is severed from the tine, as the tine 304 passes though gate 302. In this manner, the floatable material is thereby transferred onto the conveyor belt 8, while allowing the tine 304 to return back down to pick up additional floatable material.

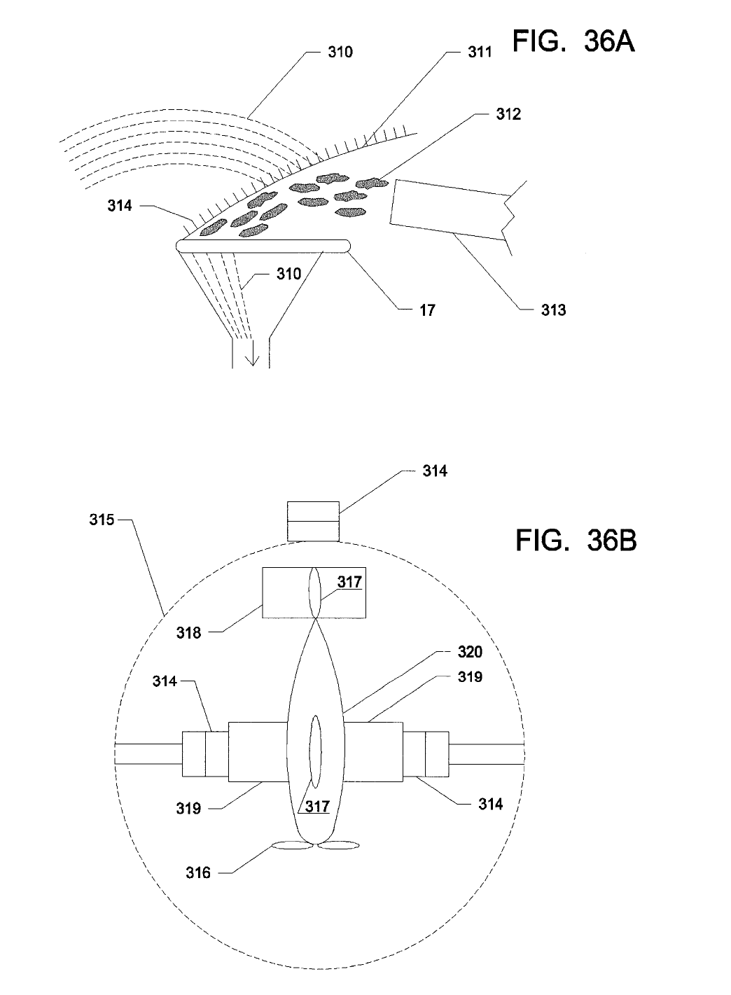

FIG. 36A is a side view of an embodiment of a continuous filter mechanism and a collection area, which may allow a continuous separation of floatable material from the water in the transport hose 60. The water and material exit the transport tube output 313 against the filter screen 311, which may, in one instance, be curved at a downward facing angle to allow for a smooth laminar flow of floatable material down the inside of the filter screen 311 to the draining conveyor belt 17. The draining conveyor belt may further be a mesh conveyor belt, so as to allow water to pass through while retaining floatable material on the surface. The continuous movement of the draining conveyor belt 17 may provide a continuous flow of material from the collection area to a washer, cooler, fermenter, or storage container. The filter screen 311 may, in one variation, be comprised of upward angled plates 314, so that the water 310 is projected up into the air, as to neutralize the large amount of energy that may be within the transport hose 60 and to thereby avoid the undesired propulsion (i.e., undesired, as in being difficult to channel/direct) of the apparatus within a body of water. The water that drains below the draining conveyor 17 may be directed through the directional propulsion thruster 101, as depicted in FIG. 1. Instead of shooting exit water 310 up into the air, that exit water may, alternatively, be directed to a directional propulsion thruster 101. Another water pump between the filter screen 311 and the directional propulsion thruster 101 may assist with the flow of the exit water.

FIG. 36B is a side view of an embodiment of a hydrovane 401. The mesh filter screen globe 315 should, preferably, be made out of suitable gauge thickness and composition of material so as to create as little turbulence as possible. In a related embodiment, the globe can be replaced with an upside down U connector that connects to the three potentiometers 314, so that the body of the hydrovane 320 is open to the elements, but still connected to the remaining components of the instrument so as to function in the same manner as the globe. In this embodiment, globe 315 is connected to three 360-degree potentiometers 314. By being connected in such a manner, the globe may rotate horizontally, and the body of the hydrovane 320 may rotate vertically, thereby providing directional information based on resistance of each potentiometer to the microprocessor 11. The top potentiometer 314 may be connected to the transport hose 60 or anywhere along the length on the apparatus. The propeller 316 may provide water speed information by generating a current or a pulse through a generator or a switch respectively, inside the body of the hydrovane 320. Such information may be transmitted to the microprocessor 11 by a wired or wireless transmission. Horizontal stabilizer tail 318 may stabilize the body of the hydrovane 320 in elevation, while the vertical stabilizer tail 317 may stabilize the direction of the body of the hydrovane 320 while rotating the globe 315, both movements turning the potentiometers 314. A global positioning system may have receivers placed on the transport hose 60 and along the length of the apparatus, with information transmitted to the microprocessor 11, so that the information provided may be used with the hydrovane 401 for more accurate movement control.

A method is disclosed of an additional benefit to the floatable-material harvester, where the floatable-material harvester is used to remove other types of floatable substrate from the body of water that the floatable-material receiver floats on. This substrate can, for example, be material used to absorb chemical spills, such as in a spill of petroleum. These substrates have an affinity for absorbing petroleum over water, such as but not limited to wood chips, peat moss, or sphagnum moss. The substrate may be comprised of nanofibres, to absorb nuclear waste. Nanofibres may be chosen to be of a particular composition/size/shape/etc. so as to have a particular ability to aid in the neutralization of radiation and/or to permanently absorb some heavy metals. Large amounts of the substrate are placed into the body of water or on the beach and are allowed enough time for the chemical to absorb into the substrate, which for the purpose of this document are referred to as sorbent or absorbent material. The spilled chemical and/or radioactive material may be referred to as pollutants. A similar apparatus may be used to deploy the sorbent material to the beach and shore. In some embodiments, the sorbent material deploying apparatus is comprised of a storage area containing absorbent material, which is metered by a conveyor into a floatable-material receiver which, is fluidly connected to a transport hose, the transport hose having at least one floatable-material thruster along its length. The floatable-material thruster is fluidly connected to at least one pump. The apparatus may have a small vessel which directs the output end of the transport hose to deploy absorbent material to the beach and shore.

In some embodiments, seaweed comprised of alginates are harvested, so that the alginate may be converted to ethanol fuel for use in internal combustion engines or provide power in some form. A method and apparatus for ethanol fuel production is disclosed, where the algae, in one variation, may be farmed. High production ethanol fuel from complex carbohydrates such as alginates is now possible through genetically modified microbes, such as yeasts and bacteria. The basic problem with ethanol production is the ability to lower costs to where it is able to compete with gasoline. Trucking corn to a fermenter and distillery is energy inefficient, and corn is a viable food for humans and animals. Seaweed to ethanol has the advantage of not taking feedstock (e.g., corn) from the human and domestic animal food chain, except possibly a small percentage of the seaweed that might go into foodstuffs, as discussed elsewhere in this application. Rather, seaweed grown for ethanol is able to make use of underwater real estate that is currently unused.

Although rope cultures may be used to secure the algae, it may be more cost effective to simply use the natural bottom substrate of ocean near the shore. The apparatus may be further configured to then distribute cuttings or spores of the desired species in order to replenish a harvested portion (e.g., similar to that done with farmland planting). The use of underwater real estate near the shore has an advantage of a higher nitrate level than the open ocean, which may lead to faster overall growth, especially if light levels are sufficient.

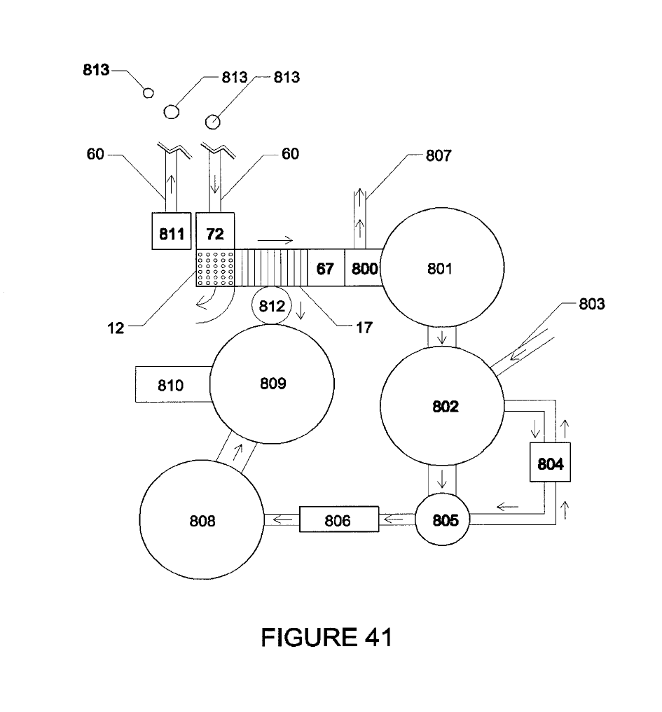

In some embodiments, an artificial substrate such as waste concrete may be dropped to provide means for which the algae to attach itself. In the method disclosed, the apparatus described within this document is used to harvest the algae. Once on board the apparatus deployed on the body of water, the seaweed is metered into a fermenter 801, as depicted in FIG. 41. The seaweed may, in one variation, be sterilized (such as by means previously described) before it is introduced into the fermenter, with ozone exposure possibly being the most economical means of sterilization.

The fermenter 801 may, in one variation, be a stirred tank fermenter. Stirred tank fermenters are a type of bioreactor and are well known in the prior art. The stirred tank fermenter 801 may be provided fresh water by passing ocean water through a reverse osmosis filter. In some embodiments, carbon filtration, microporous filtration, ultrafiltration, ultraviolet oxidation, and/or electrodialysis, and deionization may be used to purify the water drawn from the body of water in which the apparatus floats. In some embodiments, the fresh water purified through the water filter may be used to wash the seaweed before the seaweed enters the fermenter, in order to remove salt and/or debris. Of course, if fresh water seaweed/algae is being grown, the need for desalinization is obviated.

The washing of material however, brings on a new problem of diluting the fermentation mix and washing away mannitol and other water soluble components. This may lower the yield, as well require more energy to distill, since the overall alcohol content within the broth will be more dilute. Centrifuging the material may also have the effect of losing valuable dissolved solids. The solution to this problem may be the use of a semi-permeable membrane 800 depicted in FIG. 41, which is also known as a reverse osmosis filter. The collected seaweed is pulverized into a liquid using a vegetation shredder 67, as described elsewhere in this document. The resulting slurry is then pressurized within a semi-permeable membrane 800, so that water 807 may exit by passing through the semi-permeable membrane 800, but most dissolved solids and suspended solids remain. The waste water exit of a reverse osmosis filter may now be the feed line into a washer. Hydraulic pressure is an efficient manner to transfer energy, and mechanical water separation is a multitude more efficient than evaporative drying. Concentrating the slurry may have the result of a more concentrated alcohol solution within the fermenter 801, thereby lowering the energy required in this distillation stage.

The stirred tank fermenter 801 may be inoculated with a genetically-modified yeast or bacteria to begin fermentation. After a complete fermentation, the stirred tank fermenter 801 may transfer the fermented seaweed broth contents by inline pump or another conveyance mechanism to a distillation apparatus. In some embodiments, a series of stirred tank fermenters 801 in a continuous batch process may be more efficient. In some embodiments, the waste heat 803 from the motors that stir the fermenters and/or from the other motors/drives associated with other portions of the seaweed harvester may be directed into the boiling tank 802 of the distillation apparatus. The distillation apparatus may be comprised of a boiling tank 802 of the broth, where the ethanol/azeotrope vapor may flow to a distillation tower or fractional column 805, and the ethanol distillate may then flow to a collection tank 808, passing through a molecular sieve 806.

A distillation apparatus may, in one embodiment, be comprised of a heat pump 804, where the condenser component of the heat pump is used to heat the fermented broth to a boil in boiling tank 802. The evaporator coils of the heat pump 804 may be used to absorb the energy from the vaporized ethanol and condense the high purity ethanol to drain to a collection tank 808. Heat pumps that utilize a vapor compression cycle are well known and are generally comprised of a condenser, an evaporator, a thermal expansion valve, and a pump/compressor. A carbon dioxide supercritical heat pump may be ideal to provide the 70 C to 100 C temperatures needed to evaporate ethanol, although many different types of refrigerants may be used in a heat pump. The heat pump compressor may, in one variant, be powered by an internal combustion engine that burns ethanol provided by the collection tank 808. Heat pump distillation may also be based on recompression, resorption, absorption, thermo-acoustic, and/or heat-integrated-distillation-column principles.

Alternatively to distillation, a pervaporation module that consists of a molecularly porous membrane permeable for ethanol can be used instead. The pervaporation produces ethanol vapour on the vacuum side of the semi-permeable membrane, which may be subsequently condensed and re-distilled to achieve a 95% ethanol. A heat pump may be used on the pervaporation module as well, configured in a similar manner as the distillation apparatus.

There may be several internal combustion engines on the vessel, which can be used for operating pumps, stirring tank reactors 801, and/or operating the heat pump 804. These engines may, in the embodiment, all operate from ethanol fuel produced by the apparatus. Of course, alternatively, another fuel source could be used, or the engines could be replaced with electric motors, presuming a source of electricity (e.g., solar panels or grid-access) is available. Waste heat 803 from the internal combustion engine's exhaust may be directed into the boiling tank 802, or an air-to-water heat exchanger may be positioned in the boiling tank 802 with the exhaust going to outside, so as to maximize thermal efficiency of the heat pump distillation apparatus. In some embodiments, water from the body of water in which the vessel floats may be used to cool the ethanol vapor and condense the ethanol into a liquid. The evaporator coils of the heat pump 804 may be positioned in the water stream exit, to recover heat energy absorbed by the water from the ethanol vapor. The ethanol azeotrope may be passed through a molecular sieve 806 such as a dessicant, to absorb the roughly 4% water that is expected from distillation. An alternate vessel may transfer the high purity ethanol to its own holding tank by a pump, where the alternate vessel transports fuel to a port or dock. The fuel vessel may provide fuel directly to other watercraft.

The ability to employ localized fermentation may lower or eliminate the transportation costs of the raw materials, and because only high-purity ethanol is transported any significant distance, the method has the basics of the most energy efficient means of converting seaweed to high-purity ethanol delivered to a consumer. The use of a heat pump distillation setup to recycle the thermal energy within the distillation apparatus may be more energy efficient than a conventional distillation apparatus. Transporting the high-purity ethanol fuel by barge instead of truck may be six times more energy efficient than trucking the fuel. Eliminating the transportation costs of the raw seaweed material to a fermenter and/or distillery may allow seaweed to ethanol to be price competitive with gasoline and presents a distinct advantage over corn.

The apparatus may further be comprised of an incinerator 809. The incinerator may rapidly consume the ethanol on board in the event of an emergency, rather than spill the ethanol fuel into the body of water. The incinerator 809 may project the flame up into the air, as to avoid a fire risk to surrounding inhabitants. Alternatively, the heat/energy of that combustion could be used/directed to power any of the various elements of the system such as a gas turbine 810, thereby limiting the amount going to waste energy. In the event the apparatus is deployed to pick up absorbent material, the material may be metered directly from draining conveyor belt 17 into a centrifuge 812 to separate and recover petroleum. Afterwards, the material then metered into the incinerator 809.

The elongated disbursement apparatus 20 depicted in FIG. 1 may be used to disburse spores or cuttings of algae, so that the harvested algae is immediately replanted. The disbursement apparatus 20 may be connected to another transport hose 60 that is fluidly connected to the vessel and a storage tank 811, so that the floating vessel may provide a steady flow of water containing cutting slips or spores. Alternatively, the storage tank 811 may also contain natural predators 813 that protect seaweed by consuming the pest. The cutting slips may be weighted, as to allow the slips to have a better chance of taking root to the substrate. Cuttings may be produced through tissue culture or spore germination.

Alternatively, a secondary submersible may distribute cuttings/sprouts/spores behind the conveyor apparatus. In some embodiments, the disbursement apparatus 20 may disburse cuttings/sprouts/spores of a carrageenan-type seaweed. In some embodiments, a side-to-side oscillating tube may distribute cuttings, spores, or seedlings behind the apparatus.

Kelp forest configurations may be the most efficient type and manner of seaweed to be grown over other forms of seaweed cultivation. However, kelp forests may be consumed by out of control sea urchin populations. Sea urchins thrive unchecked in kelp forests as a result of the sea otter being driven to near extinction. In the method, a sea otter breeding program may be implemented, where the program may take place upon the vessel on which the seaweed is harvested, and/or the vessel may provide dock/safe-haven areas for the sea otters, such as in storage area 811. The sea otters may be released within the cultivated kelp forests, especially in areas where high urchin population has been observed, as to keep the urchin population in check and to allow the kelp forests to thrive.

Alternatively, a breeding and introduction program may be implemented for star fish, wolf eels, triggerfish, crabs, and/or any other known natural predator 813 of the sea urchins or other pests. The program involves breeding and introducing a natural predator of the sea urchin or other pest. This predator, such as starfish, may be provided down the suction hose 60 with the cuttings from storage area 811 to the elongated disbursement apparatus 20, as to provide biological protection from the cuttings being consumed by a pest. Carnivorous starfish may be specifically bred and distributed over omnivorous starfish, as to ensure they do not consume the algae cuttings or spores that were provided in the method. In some embodiments, fresh water algae may be grown in a lake or inland body of water instead of kelp. The higher nitrate levels inland may provide faster growth of biomass than in the ocean. The pest to which the natural predator 813 consumes may be an animal, plant, fungi, or bacteria.

For a global seaweed industry to function, there may only be certain times of year that certain areas are suitable for seaweed cultivation. This would likely be due to a storm season. Storms and disease/pests are perhaps the biggest destroyers of seaweed crops. Seaweed rope structures may, in one variation, be left unused during storm season, as planting of crops may be pointless during such times. The fleet of vessels that produce ethanol may transit between the northern and southern hemisphere to better be utilized during seasons that are suitable for algae growth. The movement of the fleet by ethanol power has an essentially zero-carbon footprint and is relatively efficient.

The floatable-material receiver depicted in FIG. 5 and FIG. 6 uses a small conveyor belt 110 submerged at an angle close to 45 degrees into the body of water on which the floatable-material receiver floats in order to retrieve the substrate or floatable-material. In some embodiments, the small submerged conveyor belt 110 may have spikes, hooks, or prongs that protrude from the surface of the belt, making it easier for material to be picked up and carried by the conveyor belt 110 and deposited onto the platform conveyor belt 8. In one embodiment, the conveyor belt 8 may be replaced with a screw auger. The horizontally level conveyors that feed the transport tube are non-limiting examples of feeder mechanisms that provide floatable material to the transport tube 60. The floatable-material receiver uses propulsion and steering to maneuver itself through the body of water. The floating funneling element 111 functions in the same manner as the smaller funneling element 45, with the difference being that the floating funneling element 111 is located on the sides of the conveyor belt 110, while the smaller funneling element 45 lays on top of conveyor belt 8. Apparatus is maneuvered around the body of water and used to collect the substrate. The floatable-material receiver and conveyor belt 8 provide enough draining to ensure that mostly solid substrate is removed and water is drained. Once the collection area is full, the collection area is emptied and its contents, for example, may be transported away, stored, or incinerated.

Essentially, the same features that facilitate the collection of seaweed are generally able to be employed for collection of chemical/radioactive-spill absorption substrate, whether the absorption substrate is organic or inorganic in nature. That is, while many of the elements are described in relation to “floating-organics” harvesting, those same elements could, within the scope of the present device, also be used to collect floating sorbents (both organic and inorganic varieties). That said, certain features may not necessarily be employed with the clean up of the absorption substrate, such as the cleaning/oxygenating/refrigeration system and/or the vegetation shredder. Also, the water displacement apparatus and the trommel washer may be excluded from the apparatus. In the method of harvesting material used to absorb a chemical/radioactive spill, a floatable-material thruster may be referred to as a material thruster or vise-versa, and an organics receiver may be referred to as a floatable-material receiver or vise-versa, since the material used to absorb the chemical spill may be inorganic or synthetic in composition.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An apparatus configured for at least one of picking up and collecting material, the apparatus comprising:
a collection area having a collection area input, the collection area configured for collecting at least a portion of material that enters the collection area input;
at least one of a transport hose, a mechanical pick-up device, and a material receiver, wherein:
the transport hose having an input at one end thereof and an output at another end thereof, the output of the transport hose being connected to the collection area input, the transport hose input being configured to receive material;
the material receiver configured to receive material and provide a flow of material to at least one of the transport hose input and the collection area input; and
the mechanical pick-up device configured to pick up material and provide a flow of material to at least one of the material receiver, the transport hose input, and the collection area input;
at least one of a vacuum source and a pump, the vacuum source and the pump configured to promote the flow of fluid and material from at least one of the mechanical pick-up device, the transport hose, and the material receiver into the collection area input;
at least one of a propulsion thruster, a water directing device fluidly connected to the collection area a fluid escape mechanism connected to the transport hose, a buoyancy control device, and a nozzle that is fluidly connected to a pump, the given nozzle, the given water directing device, the given fluid escape mechanism, the given buoyancy control device, and the given propulsion thruster being configured to propel at least a portion of the apparatus in a particular direction, the water directing device being further configured for directing water exiting the collection area and providing thrust, the fluid escape mechanism being further configured for directing a fluid exiting therethrough and providing thrust;
at least one of a wave sensor, a flow characterization sensor, and an external-object sensor device, the given external-object sensor device being an electronic sensor device, wherein the given flow characterization sensor being a device configured to measure at least one of speed and direction of water flow, and the external-object sensor device configured to measure relative proximity from at least one of an energy emitting object and an energy reflecting object positioned exterior to the apparatus;
wherein at least one of the wave sensor is configured to provide wave information, the flow characterization sensor configured to provide flow information, and the external-object sensor device configured to provide proximity information in relation to at least one of the energy emitting object and the energy reflecting object; and
wherein at least one of the release of fluid from at least one of the nozzle and the fluid escape mechanism, at least one of the speed and direction of the propulsion thruster, a buoyancy of the buoyancy control device and at least one of the direction and thrust of water exiting the water directing device is based, at least in part, on information provided by at least one of the wave sensor, the flow characterization sensor, and the external-object sensor device.

2. The apparatus according to claim 1, wherein at least one of the nozzle, the propulsion thruster, the water directing device, and the fluid escape mechanism are downward facing.

3. The apparatus according to claim 1, further comprising:
a mechanical pick-up device configured to pick up material;
a material receiver configured to receiver material from the mechanical pick up device, the material receiver connected to the transport hose input and further configured to direct received material into the transport hose; and
wherein at least one of the height and the length of the mechanical pick-up device is controlled by information provided by at least one electronic device that receives and interprets energy from an object comprised of at least one of a sonar system, an electronic camera, a radar system, a Geiger counter, and a laser.

4. An apparatus configured for at least one of picking up and collecting material, the apparatus comprising:
a collection area having a collection area input, the collection area configured for collecting at least a portion of material that enters the collection area input;
at least one of a transport hose, a mechanical pick-up device, and a material receiver, wherein:
the transport hose having an input at one end thereof and an output at another end thereof, the output of the transport hose being connected to the collection area input, the transport hose input being configured to receive material;
the material receiver configured to receive material and provide a flow of material to at least one of the transport hose input and the collection area input; and
the mechanical pick-up device configured to pick up material and provide a flow of material to at least one of the material receiver, the transport hose input, and the collection area input;
at least one of a vacuum source and a pump, the vacuum source and the pump configured to promote the flow of fluid and material from at least one of the mechanical pick-up device, the transport hose, and the material receiver into the collection area input;
at least one of a propulsion thruster, a water directing device fluidly connected to the collection area, a fluid escape mechanism connected to the transport hose, a buoyancy control device, and a nozzle that is fluidly connected to a pump, the given nozzle, the given water directing device, the given fluid escape mechanism, the given buoyancy control device, and the given propulsion thruster being configured to propel at least a portion of the apparatus in a particular direction, the water directing device being further configured for directing water exiting the collection area and providing thrust, the fluid escape mechanism being further configured for directing a fluid exiting therethrough and providing thrust; and
wherein at least one of the release of fluid from at least one of the nozzle and the fluid escape mechanism, at least one of the speed and direction of the propulsion thruster a buoyancy of the buoyancy control device, and at least one of the direction and thrust of water exiting the water directing device is provided in such a manner as to maintain at least one of a position and a stability of at least a portion of the apparatus, the at least one of the stability and the position maintained by providing at least a thrust, a plurality of counter thrusts, a buoyancy, and the controlled release of fluid in such a manner that a force provided is at least one of near opposite and near equal in relation to another force upon the apparatus from at least one of a wave and a water current.

5. The apparatus according to claim 4, wherein at least one of the position and stability is maintained by applying the near equal and the near opposite force in relation to the force provided upon the apparatus by at least one of a wave and a water current.

6. The apparatus according to claim 4, wherein at least one of the propulsion thruster, the nozzle, the water directing device, and the fluid escape mechanism are downward facing.

7. The apparatus according to claim 4, further comprising:
at least one of a wave sensor, a flow characterization sensor, and an external-object sensor device, the given external-object sensor device being an electronic sensor device, wherein the given flow characterization sensor being a device configured to measure at least one of speed and direction of water flow, and the external-object sensor device configured to measure relative proximity from an energy emitting object positioned exterior to the apparatus;
wherein at least one of the wave sensor is configured to provide wave information, the flow characterization sensor configured to provide flow information; and the external-object sensor device configured to provide proximity information in relation to at least one of an energy emitting object and an energy reflecting object; and
wherein at least one of the release of fluid from at least one of the nozzle and the fluid escape mechanism, at least one of the speed and direction of the propulsion thruster, the buoyancy of the buoyancy control device, and at least one of the direction and thrust of water exiting the water directing device is based, at least in part, on information provided by at least one of the wave sensor, the flow characterization sensor, and the external-object sensor device.

8. The apparatus according to claim 4, further comprising:
a mechanical pick-up device configured to pick up material;
a material receiver configured to receiver material from the mechanical pick up device, the material receiver connected to the transport hose input and further configured to direct received material into the transport hose; and
wherein at least one of the height and the length of the mechanical pick-up device is controlled by information provided by at least one electronic device that receives and interprets energy from an object, the electronic device comprised of at least one of a sonar system, an electronic camera, a radar system, a Geiger counter, and a laser.

9. The apparatus according to claim 1, wherein the water directing device is a directional propulsion thruster, the directional propulsion thruster positioned in a chosen direction.

10. The apparatus according to claim 1, wherein at least one of the release of fluid from at least one of the nozzle and the fluid escape mechanism, at least one of the speed and direction of the propulsion thruster, the buoyancy of the buoyancy control device, and at least one of the direction and thrust of water exiting the water directing device is based, at least in part, on the measurements made based on the given corresponding information provided from the wave sensor and the flow characterization sensor.

11. The apparatus according to claim 1, wherein at least one of the release of fluid from at least one of the nozzle and the fluid escape mechanism, at least one of the speed and direction of the propulsion thruster, and at least one of the direction and thrust of water exiting the water directing device is based, at least in part, on the measurements made based on the given corresponding information provided from the wave sensor and the external-object detection device.

12. The apparatus according to claim 1, wherein at least one of the release of fluid from at least one of the nozzle and the fluid escape mechanism, at least one of the speed and direction of the propulsion thruster, and at least one of the direction and thrust of water exiting the water directing device is based, at least in part, on the measurements made based on the given corresponding information provided from the flow characterization sensor and the external object detection device.

13. The apparatus according to claim 1, wherein the information from at least one of the flow characterization sensor, the water motion sensor, and the external-object sensor device is provided to a microprocessor, wherein at least one of the release of fluid from at least one of the nozzle and the fluid escape mechanism, at least one of the speed and direction of the propulsion thruster, and at least one of the direction and thrust of water exiting the water directing device is controlled, at least in part, by the microprocessor.

14. An apparatus and configured for at least one of picking up and collecting material, the apparatus comprising:
a collection area having a collection area input, the collection area configured for collecting at least a portion of material that enters the collection area input;
a transport hose having an input at one end thereof and an output at another end thereof, the output of the transport hose being connected to the collection area input, the transport hose input being configured to receive material;
at least one of a vacuum source and a pump, the vacuum source being fluidly connected with the collection area and the pump fluidly connected to the transport hose, the at least one of the vacuum source and the pump being configured in such a manner as to promote the flow of fluid and material through the transport hose towards the collection area; and
the apparatus further comprised of at least one of:
a water directing device fluidly connected to the collection area, the water directing device configured for directing water exiting from the collection area in a chosen manner, the water directing device providing thrust for at least a portion of the apparatus in a particular direction;
at least one of a downward facing nozzle and an upward facing nozzle fluidly connected to a pump, wherein the stability of at least a portion of the apparatus is provided by the release of fluid from at least one of the nozzles; and
the transport hose provided with at least one fluid escape mechanism, the fluid escape mechanism being configured for directing a fluid exiting therethrough in a chosen manner so as to propel the transport hose in a particular direction within a body of water in which the transport hose resides.

15. The apparatus according to claim 14, wherein at least one of the flow of water through the at least one of the downward facing nozzle and the upward facing nozzle, at least one of the direction and thrust of water exiting the water directing device, and the flow of fluid exiting the fluid escape mechanism is controlled, at least in part, by a microprocessor.

16. The apparatus according to claim 14, further comprising;
a mechanical pick-up device configured to pick up material;
a material receiver configured to receiver material from the mechanical pick up device, the material receiver connected to the transport hose input and further configured to direct received material into the transport hose; and
wherein at least one of the height and the length of the mechanical pick-up device is controlled by information provided by at least one electronic device that receives and interprets energy from an object comprised of at least one of a sonar system, an electronic camera, a radar system, a Geiger counter, and a laser.

17. The apparatus according to claim 14, device is supported by the amphibi wherein the downward facing nozzle and the upward facing nozzle are structurally associated with at least one of a material receiver and a mechanical pick-up device, the mechanical pick-up device configured to pick up material and provide the material to the material receiver, the material receiver connected to the transport hose input, the material receiver configured to direct material into the transport hose.

18. The apparatus according to claim 14, wherein apparatus is comprised of the water directing device and at least one of the downward facing nozzle and the upward facing nozzle.

19. The apparatus according to claim 14, wherein the apparatus is comprised of the water directing device and the fluid escape mechanism.

20-47. (canceled)
